(19) United States
(12) Patent Application Publication
(10) Pub. No.: US 2012/0282889 A1
(43) Pub. Date: Nov. 8, 2012

(54) BASE STATION DEVICE

(75) Inventors: Yoshizo Tanaka, Osaka-shi (JP); Takashi Yamamoto, Osaka-shi (JP); Yoji Okada, Osaka-shi (JP); Eiji Mochida, Osaka-shi (JP)

(73) Assignee: SUMITOMO ELECTRIC INDUSTRIES, LTD, Osaka-shi (JP)

(21) Appl. No.: 13/520,890

(22) PCT Filed: Jan. 6, 2011
(86) PCT No.: PCT/JP2011/050104

§ 371 Date: Jul. 6, 2012

(30) Foreign Application Priority Data
Jan. 12, 2010 (JP) 2010-004237
Jan. 12, 2010 (JP) 2010-004253
Jan. 19, 2010 (JP) 2010-009136
Jan. 22, 2010 (JP) 2010-012522
Feb. 4, 2010 (JP) 2010-023337
Feb. 9, 2010 (JP) 2010-026646

(51) Int. Cl. H04B 15/00; H04W 72/08; H04W 24/00

(52) U.S. Cl. 455/405; 455/452.1

(57) ABSTRACT

A base station device is provided with a control information obtaining unit (23) that obtains allocation information indicating an allocation status, for each resource block, of a radio resource allocated to another terminal device that communicates with another base station device, and an output control unit (20) that controls a transmission power of a downlink signal of the base station device and/or a transmission power of an uplink signal of a terminal device connected to the base station device, for each resource block, based on the allocation information. Therefore, the base station device is capable of suppressing interference more effectively depending on various situations.

### TECHNICAL FIELD

The present invention relates to a base station device that performs wireless communication with terminal devices.

### BACKGROUND ART

Conventionally, a wireless communication system including base station devices and movable terminal devices wirelessly connected to the base station devices has been known. A base station device forms a communication area (cell) in which the base station device is communicable with terminal devices. Each terminal device located in the cell is allowed to perform wireless communication with the base station device that forms the cell (refer to Patent Literature 1, for example).

In the above-mentioned wireless communication system, if communication areas (cells) formed by a plurality of base station devices overlap each other, a signal transmitted from a certain base station device may reach a terminal device located in a cell of another base station device located near the base station device, and serve as an interference signal to the terminal device.

In order to suppress such interference, some measures are considered, such as giving directionality to the signal by beam forming, and reducing the transmission power of the base station device that causes interference.

That is, it is well known that the interference as mentioned above can be suppressed by beam forming. That is, by performing beam forming such that a beam is directed to a terminal device (hereinafter also referred to as “own terminal device”) located in the cell of the base station device, whereas a null beam is directed to a terminal device (hereinafter also referred to as “another terminal device”) located in a cell of another base station device, a signal (interference signal) from the base station device becomes less likely to reach the another terminal device, thereby suppressing interference (refer to Non-Patent Literature 1 for the beam forming).

### CITATION LIST

### Patent Literature

[PTL 1] Japanese Laid-Open Patent Publication No. 2009-177532 [NON PATENT LITERATURE]
[NPL 1] “Adaptive Signal Processing Using Array Antennas”, written by Nobuyoshi KIKUMA, published by Kagaku Gijutsu Shuppan, Nov. 25, 1998

### SUMMARY OF THE INVENTION

### Problems to be Solved by the Invention

By the way, the above-mentioned wireless communication system may include, as base station devices, a macro base station device that forms a cell (macro cell) having a size of several kilometers, and a femto base station device that is located in the macro cell and forms, in the macro cell, a relatively small cell (femto cell) having a size of several tens of meters.

In this wireless communication system, since the femto cell formed by the femto base station device is located in the macro cell, almost the entire area of the femto cell overlaps with the macro cell. Therefore, the femto base station device and the macro base station device are likely to interfere with each other.

Further, since the femto base station device is installed in an arbitrary position in the macro cell by a user, a downlink signal from the femto base station device may interfere with a terminal device connected to the macro base station device, or an uplink signal transmitted from a terminal device connected to the femto base station device may interfere with the macro base station device. Moreover, a plurality of femto base station devices that form neighboring femto cells and a plurality of terminal devices connected to the femto base station devices may interfere with each other. Thus, various cases in which interference occurs are considered.

Given this situation, even if a base station device adopts the above-mentioned beam forming, it may be difficult to successfully suppress interference in the above-mentioned various situations.

In view of the above problems, an object of the present invention is to provide a base station device that can suppress interference more effectively depending on various situations.

(1) The present invention is a base station device that performs allocation of a radio resource to a terminal device to be connected to the base station device, for each fundamental unit area for the radio resource allocation, and performs communication with the terminal device, the base station device comprising: an obtainment unit that obtains information indicating an allocation status, for each fundamental unit area, of a radio resource allocated to another terminal device that communicates with another base station device; and a control unit that controls a transmission power of a downlink signal of the base station device and/or a transmission power of an uplink signal of a terminal device connected to the base station device, for each fundamental unit area, based on the information.

According to the base station device of the above configuration, the control unit controls, for each fundamental unit area, the transmission powers of the base station device and/or the terminal device connected to the base station device, based on the information indicating the allocation status in each fundamental unit area of the radio resource allocated to the another terminal device that communicates with another base station device. Therefore, the control unit can control the transmission power so as to individually suppress interference for only the transmission power of a desired fundamental unit area by, for example, relatively reducing the transmission power of the fundamental unit area allocated to the another terminal device. That is, by individually controlling only the transmission power of the desired fundamental unit area, the control unit can perform interference control for individually suppressing interference to the another terminal device and/or the another base station device. As a result, effective interference suppression is achieved in accordance with various situations.

(2) Preferably, the control unit specifies, based on the information, a fundamental unit area allocated to the another terminal device, and controls a transmission power of the specified fundamental unit area, with a first upper limit value being set for the transmission power.

In this case, the control unit can specify a fundamental unit area that is likely to cause interference between the base station device and the another base station device and/or the another terminal device, and further, can set the first upper limit value of the transmission power of the specified fundamental unit area so that the transmission power does not cause such interference. Thus, effective interference suppression is achieved.

(3) Preferably, the control unit sets a second upper limit value greater than the first upper limit value, for a transmission power of a fundamental unit area other than the specified fundamental unit area.

In this case, the transmission powers of the base station device and/or the terminal device connected to the base station device in the fundamental unit area (specified fundamental unit area) allocated to the another terminal device are adjusted within the range of the first upper limit value smaller than the second upper limit value, and therefore, are set to be relatively smaller than the transmission power of the fundamental unit area other than the specified fundamental unit area. As a result, as for the fundamental unit area that is not allocated to the another terminal device and therefore is less likely to cause interference, a relatively high transmission power is maintained to maintain its communication quality. On the other hand, as for the fundamental unit area allocated to the another terminal device, the transmission power thereof is reduced to suppress interference.

(4) The control unit may set a first upper limit value of the transmission power of the downlink signal of the base station device, in accordance with an amount of interference that the downlink signal of the base station device causes in the another terminal device. In this case, the control unit can set the first upper limit value within a range in which the downlink signal of the base station device does not interfere with the another terminal device. Thereby, it is possible to suppress interference that the downlink signal of the base station device causes in the another terminal device.

(5) When the another base station device is a base station device that forms a femto cell, the control unit can estimate an amount of interference that the downlink signal of the base station device causes in the another terminal device, based on a path-loss value between the base station device and the another base station device.

In this case, since the another base station device is a base station device that forms a femto cell, the another terminal device connected to the another base station device exists in the relatively narrow femto cell formed by the another base station device. Therefore, as viewed from the base station device, the another base station device and the another terminal device are regarded to exist in approximately the same position. Thereby, the path-loss value between the base station device and the another base station device can be regarded as the path-loss value between the base station device and the another terminal device, and the control unit can estimate, base on the path-loss value, an amount of interference that the downlink signal of the base station device causes in the another terminal device.

(6) If the distance between the base station device and the another terminal device and the distance between the terminal device connected to the base station device, and the another base station device are sufficiently ensured, the possibility of causing interference is low in each case. However, if the distance is relatively short, the possibility of causing interference increases. That is, the possibility of causing interference increases with reduction in the distance between the interfering device and the interfered device. Therefore, if the control unit grasps the distance between the base station device and the another terminal device based on positional information relating to the position of the another terminal device, the control unit can estimate an amount of interference that the downlink signal of the base station device causes in the another terminal device.

(7) Further, the control unit may set a first upper limit value of the transmission power of the uplink signal of the terminal device connected to the base station device, in accordance with an amount of interference that the uplink signal of the terminal device connecting to the base station device causes in the another terminal device. In this case, the control unit can set the first upper limit value within a range in which the uplink signal of the terminal device connected to the base station device does not interfere with the another base station device. Thereby, it is possible to suppress interference that the uplink signal of the terminal device connected to the base station device causes in the another terminal device.

(8) When the base station device is a base station device that forms a femto cell, the control unit can estimate an amount of interference that the uplink signal of the terminal device connected to the base station device causes in the another terminal device, based on a path-loss value between the base station device and the another base station device.

In this case, since the base station device forms a femto cell, the terminal device connected to the base station device exists in the relatively narrow femto cell formed by the base station device. Therefore, as viewed from the another base station device, the base station device and the terminal device connected to the base station device are regarded to exist in approximately the same position. Thereby, the path-loss value between the base station device and the another base station device can be regarded as the path-loss value between the terminal device connected to the base station device and the another terminal device, and the control unit can estimate, based on the path-loss value, an amount of interference that the uplink signal of the terminal device connected to the base station device causes in the another terminal device.

(9) Further, as described above, the possibility of causing interference increases with reduction in the distance between the interfering device and the interfered device. Therefore, if the control unit grasps the distance between the another base station device and the terminal device connected to the base station device, based on positional information of the base station device, the another base station device, and the terminal device connected to the base station device, the control unit can estimate an amount of interference that the uplink signal of the terminal device connecting to the base station device causes in the another terminal device.

(10) In order to obtain the path-loss value between the base station device and the another base station device, it is necessary to receive a known signal from the another base station device. Therefore, preferably, the base station device further includes a reception unit that receives a downlink signal from the another base station device, and a path-loss value obtaining unit that obtains the path-loss value between the base station device and the another base station device, by using the known signal included in the received downlink signal.

In this case, the downlink signal is received by the reception unit, and the path-loss value can be obtained by the known signal included in the downlink signal.

(11), (12) Further, as described above, if the distance between the base station device and the another terminal device and the distance between the terminal device connected to the base station device, and the another base station device are is relatively short, the possibility of causing interference increases. Therefore, the control unit may set the first upper limit value, based on the distance between the base station device and the another terminal device and/or the distance between the terminal device connected to the base station device, and the another base station device. More specifically, the control unit may set the first upper limit value to be smaller as the distance between the base station device and the another terminal device and/or the distance between the terminal device connected to the base station device and the another base station device are shorter.

In this case, if the possibility of causing interference is high because the above-mentioned distance is short, the first upper limit value is set to be small, thereby realizing more effective interference suppression.

(13) Generally, a base station device that forms a femto cell is set to perform its own communication, after communications of a base station device that forms a broad macro cell and a terminal device connected thereto.

Accordingly, when the base station device is a base station device that forms a femto cell, the base station device may further include a determination unit that determines whether the another base station device is a base station device that forms a femto cell. Thereby, the control unit can set the first upper limit value in accordance with a result of the determination by the determination unit. In this case, the control unit can appropriately set the first upper limit value in accordance with whether the another base station device is a base station device that forms a femto cell.

(14) More specifically, the control unit sets the first upper limit value to be larger in the case where the determination unit determines that the another base station device is a base station device that forms a femto cell, than in the case where the determination unit determines that the another base station device is not a base station device that forms a femto cell, thereby controlling the transmission power.

In this case, if it is determined by the determination unit that the another base station device is not a base station device that forms a femto cell and thereby it is recognized that the another base station device is a base station device that forms a macro cell, the control unit sets the first upper limit value to be relatively small. As a result, the effect of suppressing interference that the signals from the base station device and the terminal device connected thereto cause in the another base station device forming a macro cell and the terminal device connected thereto can be set to be relatively greater than the effect of suppressing interference that these signals cause in the another base station device forming a femto cell and the terminal device connected thereto. Thereby, the priorities given to communications of the another base station device forming a macro cell and the terminal device connected thereto are increased.

(15) Reducing the transmission power is one effective method to suppress interference. However, if the transmission power is unnecessarily reduced, such reduction might cause a problem that the communication quality of wireless communication performed by the base station device is degraded.

The present invention from the above viewpoint is a base station device wirelessly connecting to a terminal device, comprising: a downlink signal reception unit that receives a downlink signal from another base station device; a path-loss value obtaining unit that obtains a path-loss value of the downlink signal from the another base station device to the base station device; and a control unit that performs power control for controlling a transmission power of an uplink signal of the terminal device connected to the base station device, based on the path-loss value obtained by the path-loss value obtaining unit.

In the base station device of the above configuration, for example, if a communication area formed by the base station device is relatively narrow, the base station device and the terminal device connected to the base station device are regarded to exist in approximately the same position, as viewed from the another base station device. Thereby, the path-loss value between the base station device and the another base station device can be regarded as the path-loss value between the terminal device connected to the base station device and the another terminal device. Further, since the path-loss value is a propagation loss depending on the distance between the devices, the interfering device can estimate, from its current transmission power, the magnitude of the power with which an interference wave reaches the interfered device.

Therefore, according to the present invention, by performing power control based on the path-loss value obtained by the path-loss value obtaining unit, the control unit can appropriately adjust the transmission power of the uplink signal of the terminal device connected to the base station device within a range of a maximum transmission power in which the uplink signal of the terminal device is less likely to cause interference in the another base station device. That is, by controlling the power of the uplink signal based on the path-loss value, the control unit can perform control for suppressing interference to the another base station device. As a result, effective interference suppression is achieved without unnecessarily reducing the transmission power.

(16) Accordingly, it is preferable that the base station device forms a femto cell as a communication area for establishing wireless connection with the terminal device. In this case, since the communication area formed by the base station device is the narrow femto cell, the base station device and the terminal device connected to the base station device can be regarded to exist in approximately the same position, as viewed from the another base station device.

(17) Further, the present invention is a base station device wirelessly connecting to a terminal device, comprising: a downlink signal reception unit that receives a downlink signal from another base station device; a path-loss value obtaining unit that obtains a path-loss value of the downlink signal from the another base station device to the base station device; and a control unit that performs power control for controlling a transmission power of a downlink signal of the base station device, based on the path-loss value obtained by the path-loss value obtaining unit.

For example, when the distance between the another base station device and another terminal device connected to the another base station device is sufficiently short, the another base station device and the another terminal device are regarded to exist in approximately the same position, as viewed from the base station device. Therefore, the path-loss value of the downlink signal from the another base station device to the base station device can be regarded as the path-loss value between the base station device and the another terminal device.

Therefore, according to the present invention, by performing power control based on the path-loss value obtained by the path-loss value obtaining unit, the control unit can appropriately adjust the transmission power of the downlink signal of the base station device within a range of a maximum transmission power in which the downlink signal is less likely to cause interference in the another base station device. That is, by controlling the power of the downlink signal based on the path-loss value, the control unit can perform control for suppressing interference to the another base station device. As a result, effective interference suppression is achieved without unnecessarily reducing the transmission power.

(18) Accordingly, it is preferable that the another base station device forms a femto cell as a communication area for establishing wireless connection with another terminal device to be connected to the another base station device. In this case, since the communication area formed by the another base station device is the narrow femto cell, the distance between the another base station device and the another terminal device is sufficiently short, and therefore, these devices can be regarded to exist in approximately the same position.

(19) The base station device may further include a positional information obtaining unit that obtains positional information of the another base station device and positional information of the another terminal device. The control unit may obtain, from the respective pieces of positional information, a distance between the another base station device and the another terminal device, and perform power control for controlling the transmission power of the downlink signal of the base station device, based on the distance and the path-loss value obtained by the path-loss value obtaining unit.

In this case, if the above-mentioned distance is sufficiently short and thereby the another base station device and the another terminal device are regarded to exist in approximately the same position, the path-loss value of the down link signal from the another base station device to the base station device can be regarded as the path-loss value between the base station device and the another terminal device. Accordingly, like in the above case, effective interference suppression is achieved without unnecessarily reducing the transmission power.

(20) Preferably, the control unit sets, based on the path-loss value, an upper limit value of the transmission power of the uplink signal of the terminal device connected to the base station device, or the downlink signal of the base station device, thereby performing the power control.

In this case, the control unit can set the upper limit value to a maximum transmission power with which the uplink signal of the terminal device connected to the base station device or the downlink signal of the base station device does not interfere with the another base station device or the another terminal device, resulting in more effective interference suppression.

(21) Generally, a base station device that forms a narrow communication area such as a femto cell is set to perform its communication after communications of a base station device that forms a broad communication area such as a macro cell and a terminal device connected thereto.

Accordingly, the base station device of the present invention further includes a determination unit that determines the type of the another base station device, which depends on the size of the communication area. Thereby, the control unit can set the upper limit value to different values in accordance with a result of the determination by the determination unit. In this case, the control unit can appropriately set the upper limit value according to whether the another base station device is a base station device forming a femto cell.

(22) More specifically, the control unit sets the upper limit value to be smaller in the case where the determination unit determines that the type of the another base station device is one that forms a communication area broader than the communication area of the base station device, than in the case where the result of the determination is other than above, thereby controlling the transmission power.

In this case, as for the interference suppression effect that is caused to appears in the signals of the base station device and the terminal device connected thereto by the control of the control unit, this effect can be made greater for the another base station device that forms a communication area broader than the communication area of the base station device, and the terminal device connected thereto, than for the another base station device that forms a communication area smaller than the communication area of the base station device, and the terminal device connected thereto. Thus, the priorities given to communications of the another base station device forming the broad communication area and the terminal device connected thereto can be increased.

(23), (24) Preferably, the determination unit determines the type of the another base station device, based on control information that is contained in the downlink signal from the another base station device and is informed from the another base station device to the another terminal device. More specifically, the control information is at least one of information indicating the type of the another base station device, and information indicating the transmission power of the downlink signal of the another base station device.

In this case, the determination unit can accurately determine the type of the another base station device, based on the information indicating the type of the another base station device.

Further, since the size of the communication area of the another base station device can be grasped from the transmission power of the downlink signal of the another base station device, the determination unit can accurately determine the type of the another base station device, based on the information indicating the transmission power of the downlink signal of the another base station device.

(25), (26) Preferably, the path-loss value obtaining unit obtains the path-loss value by using a known signal contained in the downlink signal from the another base station device. More specifically, the path-loss value obtaining unit obtains a gain of the known signal, based on a reception power of the known signal, and the information indicating the transmission power of the downlink signal of the another base station device, the information being contained in the downlink signal of the another base station device, and uses this gain as the path-loss value.

In this case, the path-loss value obtaining unit can accurately obtain the path-loss value, based on the information indicating the transmission power of the downlink signal, and the reception power of the known signal.

(27) Adjusting the transmission power is one effective method to suppress interference. However, if it is not appropriately grasped whether interference occurs, the transmission power might be unnecessarily reduced, and such reduction might cause a problem that the communication quality of wireless communication performed by the base station device is reduced.

The present invention from the above viewpoint is a base station device wirelessly connecting to a terminal device, comprising: an obtainment unit that obtains downlink signal reception quality information relating to a reception quality of a downlink signal received by the terminal device; and a control unit that controls a transmission power of a downlink signal of the base station device, based on the downlink signal reception quality information obtained by the obtainment unit.

In the base station device of the above configuration, if a radio resource allocated to the terminal device connected to the base station device overlaps a radio resource allocated to another terminal device and thereby the terminal device suffers interference from a downlink signal from the another base station device, the reception quality of the downlink signal indicated by the downlink signal reception quality information obtained by the obtainment unit is degraded, and the downlink signal from the base station device is likely to interfere with the another terminal device. That is, it is possible to determined, based on the reception quality, whether the downlink signal of the base station device is likely to interfere with the another terminal device.

According to the base station device of the present invention, the control unit controls the transmission power of the downlink signal of the base station device, based on the downlink signal reception quality information. Therefore, for example, if it is determined, based on the reception quality of the downlink signal indicated by the downlink signal reception quality information, that the terminal device connected to the base station device suffers interference from the downlink signal from the another base station device and therefore the downlink signal of the base station device is likely to interfere with the another terminal device, the control unit adjusts the transmission power of the downlink signal of the base station device to prevent the downlink signal of the base station signal from interfering with the another terminal device connected to the another base station device. That is, by performing power control for the downlink signal of the base station device based on the reception quality thereof, the control unit can perform interference control for suppressing interference to the another terminal device.

As described above, according to the base station device of the present invention, effective interference suppression is achieved by appropriately grasping the possibility of causing interference.

(28) More specifically, the control unit can estimate an interference power in the downlink signal received by the terminal device, based on the downlink signal reception quality information, and control the transmission power of the downlink signal of the base station device, based on the estimated interference power.

In this case, if the estimated interference power is relatively great, it is determined that the terminal device connected to the base station device suffers interference from the downlink signal from the another base station device. Accordingly, by adjusting the transmission power of the downlink signal of the base station device in accordance with the interference power, the control unit can prevent the downlink signal from interfering with the another terminal device.

(29) That is, when the terminal device connected to the base station device suffers interference from the downlink signal from the another base station device, the radio resource allocated to the another terminal device overlaps the radio resource allocated to the terminal device. Therefore, if the transmission power of the downlink signal of the base station device is increased, the downlink signal is likely to interfere with the another terminal device connected to the another base station device.

In the base station device of the present invention, when the interference power is greater than a predetermined threshold value, the control unit can control the transmission power of the downlink signal of the base station device, with a predetermined upper limit value being set for the transmission power.

In this case, the threshold value is set to a value that allows determination as to whether the interference power is caused by interference of the downlink signal from the another base station device. Thereby, the control unit can determine whether the terminal device connected to the base station device suffers interference from the downlink signal from the another base station device. Further, when the interference power is equal to or greater than the threshold value, it is determined that the terminal device connected to the base station device suffers interference from the downlink signal from the another base station device. In this case, by setting the upper limit value so as to determine a range of power in which interference to the another terminal device is suppressed, the control unit can control the transmission power within a range of power that does not cause interference in the another terminal device.

(30) When the interference power is smaller than the threshold value, it is determined that the terminal device connected to the base station device does not suffer interference from the downlink signal from the another base station device. In this case, the control unit may control the transmission power of the downlink signal of the base station device, without setting an upper limit value of the transmission power.

(31) When it is determined, based on the interference power, that the terminal device connected to the base station device suffers interference from the downlink signal from the another base station device, and then if the interference power is relatively great, this situation allows determination that the another terminal device is located close to the base station device and therefore these devices are highly likely to interfere with each other, and that the downlink signal of the base station device is highly likely to interfere with the another terminal device. Therefore, preferably, the control unit sets the upper limit value based on the interference power.

(32) In the base station device, preferably, the control unit sets a lower limit value of the transmission power of the downlink signal of the base station device, the lower limit value being required for ensuring communication with the terminal device connected to the base station device. When it is determined that the lower limit value is smaller than the upper limit value, the control unit controls the transmission power of the downlink signal of the base station device, within a range from the upper limit value to the lower limit value.

In this case, based on the obtained upper and lower limit values, the control unit can control the transmission power of the downlink signal of the base station device within a range of power in which communication with the terminal device connected to the base station device is ensured while suppressing interference to the another terminal device.

(33) In the base station device, the control unit sets a lower limit value of the transmission power of the downlink signal of the base station device, the lower limit value being required for ensuring communication with the terminal device connected to the base station device. When it is determined that the lower limit value is equal to or larger than the upper limit value, it is difficult to control the transmission power of the downlink signal of the base station device so as to ensure communication with the terminal device connected to the base station device while suppressing interference to the another terminal device. Therefore, preferably, the control unit allocates, to the terminal device, a radio resource other than the radio resource being allocated to the terminal device.

Thereby, the radio resource that is not allocated to the another terminal device is allocated to the terminal device connected to the base station device, and thus communication with the terminal device is ensured without interfering with the another terminal device.

(34) The control unit may set the lower limit value, based on a path-loss value between the base station device and the terminal device connected to the base station device and/or the interference power.

In this case, the control unit can appropriately set the lower limit value that is the minimum transmission power required for ensuring communication with the terminal device connected to the base station device.

(35) Preferably, the downlink signal reception quality information includes at least one of a CINR obtained when the base station device receives the downlink signal received by the terminal device connected to the base station device, and a ratio of an acknowledgement to a negative acknowledgement which are transmitted from the terminal device when the base station device transmits predetermined data to the terminal device. In this case, the control unit can accurately grasp the reception quality of the downlink signal of the terminal device connected to the base station device.

(36) Furthermore, the present invention is a base station device wirelessly connecting to a terminal device, comprising: an obtainment unit that obtains downlink signal reception quality information relating to a reception quality of a downlink signal received by the terminal device; and a determination unit that determines, based on the downlink signal reception quality information obtained by the obtainment unit, whether a downlink signal from the base station device is likely to cause interference in another terminal device connected to another base station device.

According to the base station device of the above configuration, the determination unit appropriately grasps the possibility of causing interference, thereby realizing effective interference suppression.

(37) Further, the present invention is a base station device wirelessly connecting to a terminal device, comprising: an obtainment unit that obtains uplink signal reception quality information relating to a reception quality of an uplink signal from the terminal device; and a control unit that controls, based on the uplink signal reception quality information obtained by the obtainment unit, a transmission power of the uplink signal of the terminal device connected to the base station device.

According to the base station device of the above configuration, the control unit controls the transmission power of the uplink signal of the terminal device connected to the base station device, based on the uplink signal reception quality information. Therefore, if it is determined, based on the reception quality of the uplink signal indicated by the uplink signal reception quality information obtained by the obtainment unit, that the base station device suffers interference from the uplink signal from the another terminal device and therefore there is a possibility that the uplink signal of the terminal device connected to the base station device is likely to interfere with the another base station device, the control unit can adjust the transmission power of the uplink signal of the terminal device connected to the base station device to prevent the uplink signal from interfering with the another base station device. That is, by performing power control based on the reception quality of the uplink signal of the terminal device connected to the base station device, the control unit can perform interference control to prevent interference to the another base station device.

In this way, according to the base station device of the present invention, effective interference suppression is achieved by appropriately grasping the possibility of causing interference.

(38) The control unit can estimate, based on the uplink signal reception quality information, an interference power in the uplink signal, and controls, based on the estimated interference power, the transmission power of the uplink signal of the terminal device connected to the base station device.

In this case, if the estimated interference power is relatively great, the control unit can determine that the base station device suffers interference from the uplink signal from the another terminal device. Accordingly, by adjusting the transmission power of the uplink signal of the terminal device connected to the base station device in accordance with the interference power, the control unit can prevent the uplink signal from interfering with the another base station device.

(39) In the base station device, when the interference power is equal to or larger than a predetermined threshold value, the control unit may control the transmission power of the uplink signal of the terminal device connected to the base station device, with a predetermined upper limit value being set for the transmission power.

In this case, the threshold value is set to a value that allows determination as to whether the interference power is caused by interference from the uplink signal of the another terminal. Thereby, the control unit can determine whether the base station device suffers interference from the uplink signal from the another terminal device. Further, when the interference power is equal to or greater than the threshold value, the control unit can determine that the base station device suffers interference from the uplink signal from the another terminal device. In this case, by setting the upper limit value so as to determine a range of power in which interference to the another terminal device is suppressed, the control unit can control the transmission power within a range of power that does not cause interference in the another base station device. Thus, effective interference suppression is achieved.

(40) When the interference power is smaller than the threshold value, it is determined that the base station device does not suffer interference from the uplink signal from the another terminal device. In this case, the control unit may control the transmission power of the downlink signal of the base station device without setting an upper limit value for the transmission power.

(41) When it is determined, based on the interference power, that the base station device suffers interference from the uplink signal from the another terminal device, and then if the interference power is relatively great, this situation allows determination that these devices are highly likely to interfere with each other and therefore the uplink signal of the terminal device connected to the base station device is also highly likely to interfere with the another base station device. Therefore, preferably, the control unit sets the upper limit value based on the interference power.

(42) Preferably, the uplink signal reception quality information includes at least one of a CINR of a known signal contained in the uplink signal transmitted from the terminal device connected to the base station device and received by the base station device, and a BER of the uplink signal. In this case, the control unit can accurately grasp the reception quality of the uplink signal of the terminal device connected to the base station device.

(43) Further, the present invention is a base station device wirelessly connecting to a terminal device, comprising: an obtainment unit that obtains uplink signal reception quality information relating to reception quality of an uplink signal from the terminal device; and a determination unit that determines, based on the uplink signal reception quality information obtained by the obtainment unit, whether the uplink signal of the terminal device connected to the base station device is likely to cause interference in another base station device.

According to the base station device of the above configuration, the determination unit appropriately grasps the possibility of causing interference, resulting in effective interference suppression.

(44) In a base station device that is likely to cause interference, such as a femto base station device, in order to suppress such interference, it is considered to avoid use of a radio resource that is used for uplink or downlink communication of another base station device (particularly, macro base station device), or to reduce the transmission power in the radio resource.

However, the radio resource used by the another base station device is not fixed, but varies depending on scheduling of the radio resource.

Accordingly, it is desired to adjust the manner of controlling interference suppression in accordance with the usage status of the radio resource in the another base station device.

The present invention from the above viewpoint is a base station device comprising: a control unit that performs control to suppress interference to another base station device and/or a terminal device communicating with the another base station device; and an analysis unit that obtains usage status data indicating a usage status of each radio resource in the another base station device, and tallies up the usage status data for each predetermined time period to obtain a statistical value in each predetermined time period. The control unit adjusts a manner of interference suppression control, based on a statistical value in a time period corresponding to a point in time to perform interference suppression control, among the statistical values.

According to the above invention, it is possible to obtain a statistical value, for each predetermined time period (time zone, day, or the like), of the usage status of a radio resource in another base station device. This statistical value indicates the past record of use of the radio resource in another cell in each predetermined time period. Therefore, when performing interference suppression control, it is possible to estimate, from the statistical value in the time period (same time zone, same day, or the like) corresponding to the point in time to perform the interference suppression control, the usage status of the radio resource in the another cell at the point in time. Utilizing this, in the present invention, the manner of interference suppression control is adjusted based on the statistical value in the time period corresponding to the point in time to perform the interference suppression control, among the statistical values. Therefore, it is possible to vary the manner of interference suppression control in accordance with variation in the usage status of the radio resource in the another base station device.

(45) Preferably, the adjustment of the manner of interference suppression control includes adjustment of the transmission power in each radio resource and/or adjustment of a manner of radio resource allocation. In this case, the control unit can adjust the manner of interference suppression control by reducing the transmission power of a radio resource that is likely to cause interference, or by avoiding use of such radio resource.

(46) Preferably, the usage status data is a reception power when the base station device receives a signal of each radio resource and/or data based on the reception power. If the reception power of a signal from another cell is great, this situation indicates that the corresponding radio resource is allocated in another base station device. Thus, the control unit can appropriately grasp the usage status of the radio resource in the another cell.

(47) Preferably, the base station device further includes an input unit that receives, from the outside of the base station device, an input of a specific time period in which the manner of interference suppression control is to be adjusted. When the point in time to perform interference suppression control is within the specific time period, the control unit performs interference suppression control that is set for the specific time period. In this case, the specific time period can be externally set, and the control unit can perform interference suppression control in the set specific time period.

(48) Preferably, the analysis unit is configured to obtain and tally up usage status data indicating a usage status of each radio resource in another cell in the specific time period, and obtain a statistical value in the specific time period. When the point in time to perform interference suppression control is within the specific time period, the control unit adjusts the manner of interference suppression control, based on the statistical value in the specific time period. In this case, the control unit, provided with the statistical values in the specific time period, can perform appropriate interference suppression control in the specific time period, based on the statistical values.

(49) Preferably, the analysis unit is configured to reset all or part of the accumulated statistical values when software possessed by the another base station device is updated in the another base station device, and recreate statistical values. If the software possessed by the another base station device is updated, the reliability of the statistical values is degraded. Therefore, such reset allows the control unit to obtain new appropriate statistical values in a relatively short time.

(50) Further, in order to suppress the above-mentioned interference, a base station device that is likely to cause interference, such as a femto base station device, may grasp the status of radio resource allocation performed by another base station device (particularly, macro base station device).

That is, if the base station device grasps a radio resource used in an uplink or a downlink of another base station device, the base station device can avoid to use the radio resource. Such interference can also be suppressed by reducing the transmission power.

It is not always easy to completely grasp in real time radio resource allocation in another base station device. For example, in the case where temporal variation in the radio resource allocation is significant, when the control unit intends to perform interference suppression in accordance with the radio resource allocation status in the another base station device, another resource allocation might be performed at the point in time.

On the other hand, in the case where radio resource allocation in another base station device is localized allocation in which the same radio resource (frequency) is allocated to the same user continuously in time, after the control unit has grasped the radio resource allocation in the another base station device, the allocation status continues for a while. Therefore, the control unit can efficiently perform interference suppression control in accordance with the radio resource allocation in the another base station device.

The inventors of the present invention have come up with an idea that it would be better to vary the manner of interference suppression control between the case where temporal variation in the status of radio resource allocation to a terminal device from another base station device is significant, and the case the temporal variation is small. For example, when temporal variation in radio resource allocation by the another base station device is small, it is easy to grasp an unused radio resource that the another base station device does not use for transmission/reception. Therefore, if the unused radio resource is used, it is less likely to cause interference to another cell even if the transmission power is somewhat increased. On the other hand, when temporal variation in radio resource allocation by the another base station device is significant, it is difficult to grasp an unused radio resource that the another base station device does not use for transmission/reception. In this case, in order to suppress interference to another cell, control to reduce the transmission power is preferred to use of the unused radio resource.

The present invention is based on the above-mentioned idea. That is, the present invention is a base station device comprising: a control unit that performs control to suppress interference to another base station device and/or a terminal device communicating with the another base station device; and a determination unit that performs determination of temporal variation in radio resource allocation to the terminal device by the another base station device. The control unit performs control to adjust a manner of the interference suppression, based on a result of the determination by the determination unit.

According to the present invention, since the determination unit determines temporal variation in the status of radio resource allocation to the terminal device from the another base station device, the control unit can appropriately adjust the manner of interference suppression in accordance with the temporal variation.

(51) Preferably, the control unit adjusts the magnitude of a transmission power of the base station device and/or the magnitude of a transmission power of a terminal device communicating with the base station device, thereby performing the control to suppress interference. In this case, appropriate interference control is achieved by adjusting the magnitude of the transmission power.

(52) Preferably, the determination unit determines whether the radio resource allocation to the terminal device by the another base station device is localized allocation in which the temporal variation is relatively small or distributed allocation in which the temporal variation is relatively great. In this case, the control unit can adjust the manner of interference suppression control, based on whether the radio resource allocation is localized allocation or distributed allocation.

(53) Preferably, when it is determined that the radio resource allocation to the terminal device by the another base station device is the localized allocation, the control unit performs control such that a radio resource other than a radio resource allocated to the terminal device by the another base station device is allocated to a terminal device that communicates with the base station device, thereby performing the control to suppress interference. In this case, since the radio resource not used in the another base station device is used, interference suppression can be achieved.

(54) Preferably, after the control unit has allocated the radio resource other than the radio resource allocated to the terminal device by the another base station device, to the terminal device that communicates with the base station device, the control unit performs control to reduce, with time, the magnitude of the transmission power of the base station device and/or the magnitude of the transmission power of the terminal device communicating with the base station device. In this case, even if the adequacy of resource allocation is degraded with time, since the transmission power is decreased, the possibility of causing interference can be reduced.

(55) Preferably, when it is determined that the radio resource allocation to the terminal device by the another base station device is the distributed allocation, the control unit adjusts the magnitude of the transmission power of the base station device and/or the magnitude of the transmission power of the terminal device communicating with the base station device, thereby performing the control to suppress interference. In this case, it is possible to suppress interference by reducing the magnitude of the transmission power, regardless of the radio resource allocation in the another base station device.

(56) After the control unit has adjusted the magnitude of the transmission power of the base station device and/or the magnitude of the transmission power of the ten final device communicating with the base station device upon the determination that the radio resource allocation is the distributed allocation, the control unit may perform control to decrease, with time, the magnitude of the transmission power of the base station device and/or the magnitude of the transmission power of the terminal device communicating with the base station device. In this case, even if the adequacy of the adjusted transmission power is degraded with time, since the transmission power is decreased, interference suppression is achieved.

(57) Preferably, the control unit is configured to perform power reduction control to reduce, with time, the magnitude of the transmission power of the base station device and/or the magnitude of the transmission power of the terminal device communicating with the base station device, after performing the control to adjust the manner of interference suppression, based on a result of the determination as to whether the radio resource allocation is localized allocation or distributed allocation. Further, preferably, the amount of power reduction in the power reduction control is set to be greater in the case where the radio resource allocation is determined to be the distributed allocation than in the case where the radio resource allocation is determined to be the localized allocation. Since the reduction with time in the adequacy of the interference suppression manner is greater in the case of distributed allocation than in the case of localized allocation, it is possible to suppress interference by increasing the amount of power reduction in the power reduction control when the radio resource allocation is determined to be distributed allocation.

(58) Preferably, the base station device further includes an obtainment unit that obtains available information for performing the determination of temporal variation, from among information contained in a radio frame transmitted from the another base station device to the terminal device communicating with the another base station device, and the determination unit performs the determination of temporal variation, based on the information obtained by the obtainment unit. In this case, the determination can be performed based on the information contained in the radio frame in another cell.

(59) Preferably, the base station device further includes an obtainment unit that obtains available information for performing the determination of temporal variation, via a backbone network to which the another base station device and the base station device are connected, and the determination unit performs the determination of temporal variation, based on the information obtained by the obtainment unit. In this case, the determination can be performed based on the information obtained via the backbone network.

(60) Preferably, the available information for performing the determination of temporal variation, which is obtained by the obtainment unit, is information indicating whether the radio resource allocation method is localized FDMA or distributed FDMA.

(61) Preferably, the available information for performing the determination of temporal variation, which is obtained by the obtainment unit, is information indicating the type of scheduling algorithm for radio resource allocation.

(62) Preferably, the available information for performing the determination of the temporal variation, which is obtained by the obtainment unit, is information indicating an application type of data transmitted or received by the another base station device.

(63) Preferably, the base station device further includes a measurement unit that periodically measures a communication signal of communication performed between the another base station device and the terminal device, and the determination unit performs the determination of temporal variation, based on the communication signal periodically measured by the measurement unit. In this case, the determination can be performed based on the measured transmission signal in another cell.

(64) Preferably, the determination unit calculates temporal variation in the reception power of the communication signal periodically measured by the measurement unit, thereby to determine temporal variation in radio resource allocation to the terminal device by the another base station device. In this case, the determination can be performed based on the temporal variation in the reception power in another cell.

(65) Preferably, the measurement unit adjusts the cycle of measuring the communication signal, in accordance with a result of the determination by the determination unit. In this case, the measurement cycle can be adjusted in accordance with the temporal variation in radio resource allocation.

(66) As a method for suppressing interference, adjusting the transmission power, or adjusting the radio resource allocation is considered. For example, when attention is focused on one base station device, the larger the number of terminal devices connected to another base station device located in the neighborhood of a cell of the base station device, the higher the possibility that the base station device and a terminal device connected to the base station device interfere with the terminal devices connected to the another base station device. On the other hand, if terminal devices connected to the another base station device are not located in the neighborhood of the base station device, the possibility that the base station device interferes with these terminals devices is significantly low. In this way, the possibility of causing interference varies depending on the presence of terminal devices connected to the another base station device. If uniform interference suppression is attempted regardless of such situation, undesired reduction in throughput might occur in the communication of the base station device.

The present invention from the above viewpoint is a base station device wirelessly connecting and communicating with a terminal device, comprising: an obtainment unit that obtains presence information indicating presence statuses of terminal devices located in the neighborhood of the base station device; and a control unit that performs control to suppress interference to another base station device and/or another terminal device connected to the another base station device. The control unit performs control to adjust a manner of interference suppression, in accordance with the presence information obtained by the obtainment unit.

According to the base station device of the above configuration, since the control unit adjusts the manner of interference suppression in accordance with the presence information indicating the presence statuses of terminal devices located in the neighborhood of the base station device, effective interference suppression is achieved in accordance with the presence status of terminal devices.

(67), (68) When terminal devices intend to wirelessly access a base station device, each terminal device transmits a connection request to the base station device. Accordingly, by obtaining the connection requests transmitted from the terminal devices, the base station device can recognize that the terminal devices exist in a region where the connection requests are receivable. Therefore, the obtainment unit obtains the connection requests transmitted from the terminal devices, and obtains the presence information based on the connection requests.

Preferably, the connection requests are transmitted by terminal devices other than the terminal device connected to the base station device.

Examples of terminal devices other than the terminal device connected to the base station device include: another terminal device connected to another base station device, and a terminal device that has not yet been wirelessly connected to any base station device because it intends to start communication with any base station device.

(69), (70) Since the terminal devices that intend to access the another base station device transmit the connection requests based on control information notified by the another base station device, preferably, the obtainment unit obtains, from a transmission signal transmitted by the another base station device, control information required for transmission of connection requests to the another base station device, and performs, based on the control information, reception control for obtaining connection requests that are transmitted to the another base station device from the terminal devices other than the terminal device connected to the base station device.

More specifically, the control information is a radio area allocated in a radio frame by the another base station device to receive the connection requests. In this case, the obtainment unit can grasp the radio area allocated by the another base station device to transmit the connection requests, and therefore, can reliably sniff the connection requests transmitted from the terminal devices to the another base station device.

(71), (72) Further, the obtainment unit may perform reception control for obtaining connection requests transmitted from terminal devices that intend to access the base station device, based on control information required for the transmission of the connection requests to the base station device from the terminal devices that intend to access the base station device. More specifically, the control information is a radio area that is allocated in a radio frame by the base station device to receive the connection requests transmitted from the terminal devices that intend to access the base station device.

In this case, the obtainment unit can grasp the radio area allocated by the base station device to transmit the connection requests, and therefore, can reliably obtain the connection requests transmitted from the terminal devices to the base station device.

(73) Further, preferably, the obtainment unit identifies whether the obtained connection requests have been transmitted by terminal devices that are permitted to access the base station device, and obtains the presence information, based on only the connection requests transmitted by terminal devices that are not permitted to access the base station device.

In this case, the obtainment unit can obtain only the presence information of terminal devices that are likely to suffer interference.

(74) In the base station device, preferably, the obtainment unit obtains, based on the connection requests, as the presence information, the number of terminal devices that are transmission sources of the connection requests obtained within a predetermined time period.

In this case, by counting the connection requests received within a predetermined time period, the obtainment unit can grasp the number of terminal devices that are located in a neighboring region where the base station device can receive the connection requests, and obtain the number as presence information.

(75) Further, the obtainment unit may determine, based on the obtained connection requests, distance information indicating distances between the base station device and the terminal devices that have transmitted the obtained connection requests, and obtain the distance information as the presence information.

In this case, since the obtainment unit obtains the distance information as presence information, the obtainment unit can grasp the presence status of terminal devices located in the neighborhood of the base station device, more reliably.

(76) More specifically, the distance information is offsets (Timing advances) of reception timings of the connection requests obtained by the obtainment unit.

(77) Further, in the base station device, the obtainment unit may obtain positional information relating to terminal devices other than the terminal device connected to the base station device, via a backbone network to which the another base station device and the base station device are connected, and obtain the presence information based on the positional information.

In this case, the obtainment unit can accurately know the positions of the terminal devices, and therefore, can accurately obtain the distances to the terminal devices to grasp the presence statuses of the terminal devices.

(78) In the base station device, preferably, the control unit adjusts, based on the presence information, the magnitude of the transmission power of the base station device and/or the magnitude of the transmission power of the terminal device connected to the base station device, thereby adjusting the manner of interference suppression. In this case, by adjusting the magnitude of the transmission power, the control unit can perform control to appropriately adjust the manner of interference suppression in accordance with the presence statues of terminal devices.

(79) The control unit may adjust, based on the presence information, the amount of radio resources to be allocated to the terminal device connected to the base station device, thereby adjusting the manner of suppressing interference. Also in this case, by adjusting the amount of radio resources to be allocated to the terminal device connected to the base station device, the control unit can appropriately perform interference suppression control in accordance with the presence statues of terminal devices.

(80) More specifically, the control unit adjusts the amount per radio frame of radio resources to be allocated to the terminal device connected to the base station device. In this case, if interference suppression is not necessary, it is possible to increase the amount per radio frame of radio resources to be allocated to the terminal device connected to the base station device. On the other hand, if interference suppression is necessary, the amount of radio resources to be allocated is decreased, and thereby it is possible to reduce the possibility that the radio resources allocated to the terminal device connected to the base station device overlap the radio resources allocated to a terminal device other than the terminal device connected to the base station device, although the throughput is reduced. Thus, the control unit can perform control to select an appropriate manner for interference suppression, in accordance with the presence statues of terminal devices.

(81) Further, the control unit may selectively transmit and receive data between the base station device and the terminal device connected to the base station device, in accordance with the type of application of the data, thereby adjusting the manner of suppressing interference.

In this case, if interference suppression is necessary, the amount of data can be reduced by selectively transmitting/receiving only higher-priority data in accordance with the type of application, and thereby the amount per radio frame of radio resources allocated to the terminal device connected to the base station device can be reduced. Thus, the control unit can appropriately adjust the manner of interference suppression.

(82) Further, the base station device may further include a suspension processing unit that performs a suspension process of suspending communication of the base station device, and the control unit may cause the suspension processing unit to perform the suspension process based on the presence information. In this case, if the control unit determines based on the presence statues of other terminal devices that it is difficult to maintain communication of the base station device while suppressing interference, the control unit suspends the communication of the base station device to perform interference suppression.

### BRIEF DESCRIPTION OF THE DRAWINGS

FIG. 1 is a schematic diagram showing a configuration of a wireless communication system including a base station device according to a first embodiment of the present invention.

FIG. 2 is a diagram showing configurations of uplink and downlink radio frames for LTE.

FIG. 3 is a diagram showing the configuration of the DL frame in detail.

FIG. 4 is a diagram showing the configuration of the UL frame in detail.

FIG. 5 is a block diagram showing a configuration of a femto BS shown in FIG. 1.

FIG. 6 is a block diagram showing a configuration of an output control unit.

FIG. 7 is a block diagram showing a configuration of an MS 2 shown in FIG. 1.

FIG. 8 is a flowchart showing a process of controlling the transmission power of a downlink transmission signal, which is performed by the output control unit.

FIG. 9 is a diagram showing interferences in communication between a macro BS and a macro MS, and in communication between a femto BS and a femto MS, in FIG. 1.

FIG. 10(a) is a diagram showing an example of a radio resource allocation status in a part of a downlink radio frame of a macro BS, and an example of setting of upper limit values of a transmission signal in a downlink radio frame (in the same part as above) of a femto BS, and FIG. 10(b) is a diagram showing a manner of setting upper limit values of the transmission power in the frequency direction at time T1 in FIG. 10(a).

FIG. 11 is a diagram showing interferences in communication between a femto BS (FBS#1) and a femto MS (FMS#1), and in communication between a femto BS (FBS#2) as another BS and a femto MS (FMS#2) as another MS, in FIG. 1.

FIG. 12 is a diagram showing an example of a manner of setting upper limit values of the transmission power in the frequency direction.

FIG. 13 is a flowchart showing a process of controlling the transmission power of an uplink transmission signal of a femto MS 2b, which is performed by an output control unit 20.

FIG. 14 is a diagram showing an example of, when another BS is a macro BS, an allocation status of a radio resource allocated to a macro MS, in an uplink radio frame between the macro BS and the macro MS, and an example of setting of upper limit values of a transmission signal in an uplink radio frame between a femto BS and a femto MS in the same area as the above uplink frame.

FIG. 15 is a block diagram showing a configuration of an output control unit of a femto BS according to a second embodiment of the present invention.

FIG. 16 is a flowchart showing steps of a process to be performed by the output control unit of the second embodiment after determination that another BS is a macro BS in step S103 in FIG. 8.

FIG. 17 is a diagram for explaining the positional relationships among a femto BS, a macro MS, and a macro BS.

FIG. 18 is a block diagram of a femto BS according to a third embodiment of the present invention.

FIG. 19 is a diagram showing an example of average power values of the respective resource blocks, which are obtained by a measurement processing unit.

FIG. 20 is a block diagram showing a configuration of an output control unit 20.

FIG. 21 is a block diagram showing another example of an output control unit.

FIG. 22 is a block diagram showing another example of a femto BS.

FIG. 23 is a diagram for explaining the positional relationships among a FBS#1, a FBS#2, and a FMS#2.

FIG. 24 is a diagram for explaining the positional relationships among a femto BS (FBS#1), a femto MS (FMS#1), and a macro BS (FBS#2), in each of FIG. 9 and FIG. 11.

FIG. 25 is a schematic diagram showing a configuration of a wireless communication system including a base station device according to a first embodiment in Chapter 2.

FIG. 26 is a block diagram showing a configuration of a femto BS according to the first embodiment in Chapter 2.

FIG. 27 is a block diagram showing a configuration of an output control unit.

FIG. 28 is a block diagram showing a configuration of an MS.

FIG. 29 is a flowchart showing a process of controlling the transmission power of a downlink transmission signal (uplink transmission signal), which is performed by the output control unit.

FIG. 30 is a diagram showing interferences in communication between a macro BS and a macro MS, and in communication between a femto BS and a femto MS.

FIG. 31 is a flowchart showing a process of controlling the transmission power of a downlink transmission signal (uplink transmission signal), which is performed by an output control unit of a femto BS according to a second embodiment in Chapter 2.

FIG. 32 is a block diagram of a femto BS according to a third embodiment in Chapter 2.

FIG. 33 is a block diagram showing a configuration of a femto BS according to an embodiment in Chapter 3.

FIG. 34 is a block diagram showing an analysis unit and a control unit.

FIG. 35 is a histogram showing statistical values.

FIG. 36 is a flowchart showing process steps of interference suppression control based on the statistical values.

FIG. 37 is a block diagram showing a configuration of a femto BS according to an embodiment in Chapter 4.

FIG. 38 is a diagram showing an allocation status according to SPS.

FIG. 39 is a flowchart showing a process of localized/distributed determination (first example).

FIG. 40 is a diagram showing an example of varying the upper limit values of the transmission power with time.

FIG. 41 is a flowchart showing a process of scheduling algorism determination (second example).

FIG. 42 is a flowchart showing a process of application determination (third example).

FIG. 43 is a diagram showing examples of localized allocation and distributed allocation.

FIG. 44 is a flowchart showing a process of determination (fourth example) based on measurement of power variation amount.

FIG. 45 is a block diagram showing a configuration of a femto BS according to an embodiment in Chapter 5.

FIG. 46 is a flowchart showing a first example of process steps of interference suppression control performed by a femto BS.

FIG. 47 is a diagram showing an example in which a first PRACH and a second PRACH are arranged on an UL frame.

FIG. 48 is a graph showing the relationship between a control value and a set value of the transmission power of a downlink signal of the own base station device, which is set by the control unit.

FIG. 49 is a flowchart showing a second example of process steps of interference suppression control performed by the femto BS.

FIG. 50 is a diagram for explaining a Timing advance TA in reception timing.

FIG. 51 is a flowchart showing a third example of process steps of interference suppression control performed by the femto BS.

### DESCRIPTION OF EMBODIMENTS

Preferred embodiments of the present invention will be described below with reference to the accompanying drawings.

[Chapter 1: Estimation of Amount of Interference Based on Path-Loss Value]

### 1.1 First Embodiment

[1.1.1 Configuration of Communication System]

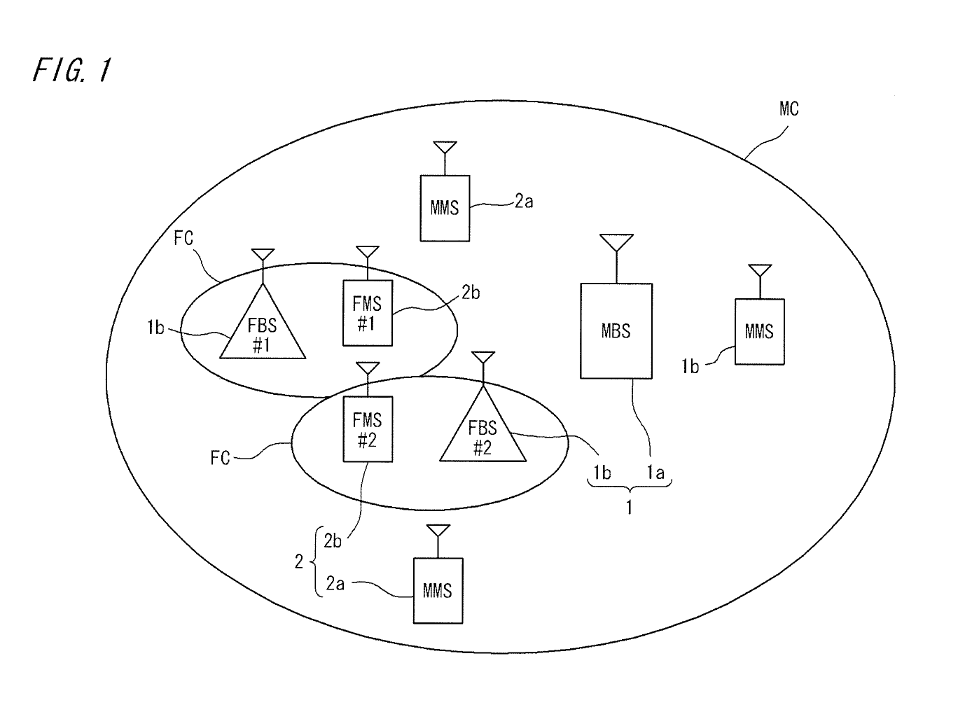

FIG. 1 is a schematic diagram showing a configuration of a wireless communication system including a base station device according to a first embodiment of the present invention.

This wireless communication system includes a plurality of base station devices 1, and a plurality of terminal devices 2 (mobile stations) that are allowed to perform wireless communication with the base station devices 1.

The plurality of base station devices 1 include: a plurality of macro base stations 1a each forming a communication area (macro cell) MC having a size of several kilometers; and a plurality of femto base stations 1b each forming a relatively small femto cell FC having a size of several tens of meters, and being located in the macro cells MC.

A macro base station device 1a (hereinafter, also referred to as “macro BS 1a”) is allowed to perform wireless communication with a terminal device 2 existing in its own macro cell MC.

On the other hand, a femto base station device 1b (hereinafter, also referred to as “femto BS 1b”) is installed in a place where a radio wave from a macro BS 1a is difficult to be received, such as indoors, and forms a femto cell FC. The femto BS 1b is allowed to perform wireless communication with a terminal device 2 (hereinafter, also referred to as “MS 2”) existing in its own femto cell FC. In this system, a femto BS 1b which forms a relatively small femto cell FC is installed in a place where a radio wave from a macro BS 1a is difficult to be received, thereby enabling provision of service with a sufficient throughput to the MS 2.

Note that, in the following description, an MS 2 connected to a femto BS 1b is sometimes referred to as a femto MS 2b, and an MS 2 connected to a macro BS 1a is sometimes referred to as a macro MS 2a.

The wireless communication system of the present embodiment is, for example, a mobile phone system to which LTE (Long Term Evolution) is applied, and communication based on LTE is performed between each base station device and each terminal device. In LTE, frequency division duplex (FDD) can be adopted. The present embodiment will be described on assumption that the communication system adopts FDD. Note that the communication system is not limited to those based on LTE. Further, the scheme adopted by LTE is not limited to FDD. For example, TDD (Time Division Duplex) may be adopted.

[1.1.2 Frame Structure for LTE]

In FDD that can be adopted by LTE on which the communication system of the present embodiment is based, uplink communication and downlink communication are simultaneously performed by allocating different operating frequencies to an uplink signal (a transmission signal from a terminal device to a base station device) and a downlink signal (a transmission signal from the base station device to the terminal device).

Further, in the present embodiment, OFDM (Orthogonal Frequency Division Multiplexing) is adopted for downlink wireless communication, and SC-FDMA (Single Carrier-Frequency Division Multiple Access) is adopted for uplink wireless communication.

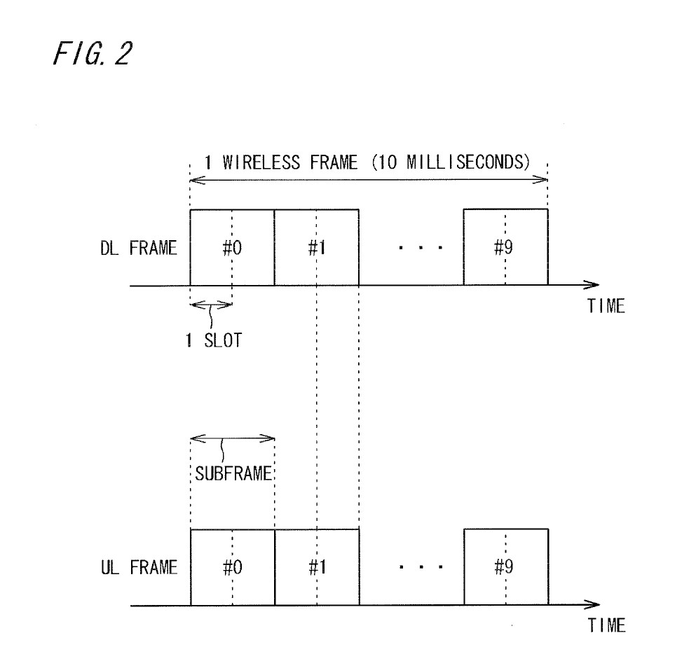

FIG. 2 is a diagram showing the structures of uplink and downlink communication frames for LTE. Each of a downlink radio frame (DL frame) and an uplink radio frame (UL frame), which are the essential frames for LTE, has a time length of 10 milliseconds per radio frame, and consists of 10 subframes #0 to #9. The DL frames and the UL frames are arranged in the time axis direction with the frame timings coinciding with each other.

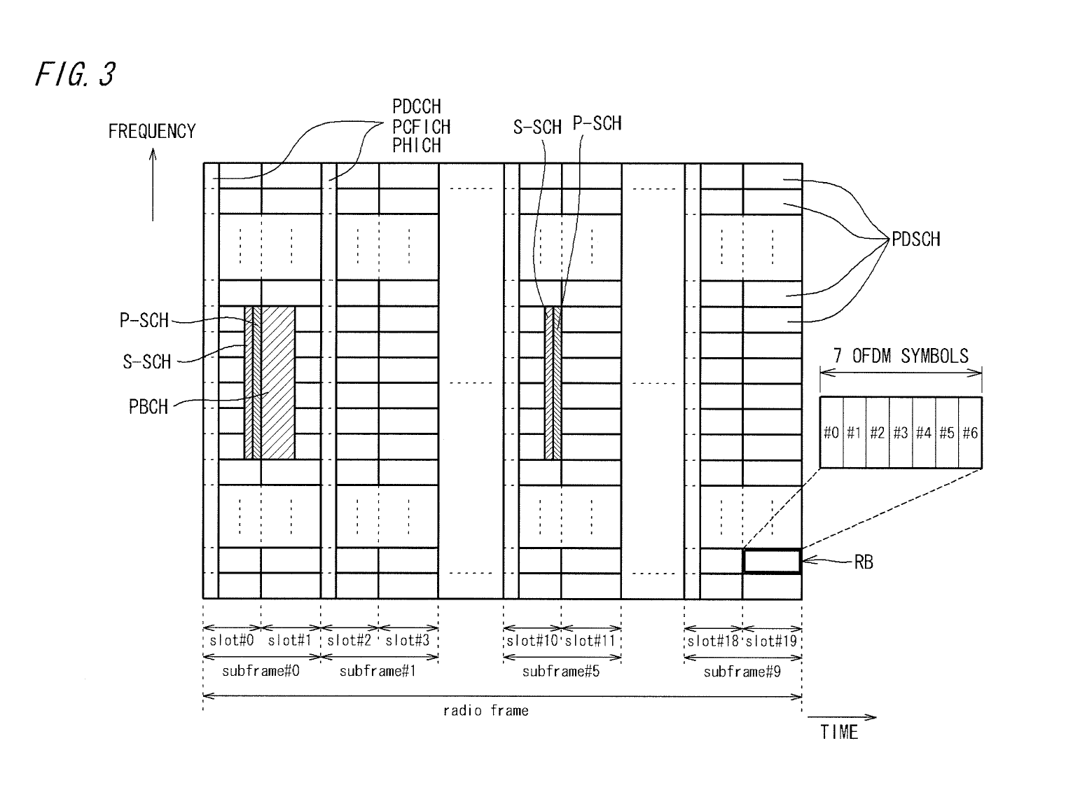

FIG. 3 is a diagram showing the structure of a DL frame in detail. In FIG. 3, the vertical axis direction indicates the frequency, and the horizontal axis direction indicates the time.

Each of subframes that form the DL frame consists of 2 slots (e.g., slots #0 and #1). One slot consists of 7 (#0 to #6) OFDM symbols (in the case of Normal Cyclic Prefix).

Further, in FIG. 3, a resource block (RB) which is a fundamental unit area (a minimum unit of user allocation) for data transmission is defined by 12 subcarriers in the frequency axis direction and 7 OFDM symbols (1 slot) in the time axis direction. Accordingly, when the frequency band width of the DL frame is set at, for example, 5 MHz, 300 subcarriers are arranged, and 25 resource blocks are arranged in the frequency axis direction.

As shown in FIG. 3, a transmission area for allocating a control channel required for downlink transmission to a terminal device by a base station device is secured at the beginning of each subframe. This transmission area corresponds to symbols #0 to #2 (three symbols at maximum) in the front-side slot in each subframe. Allocated to the transmission area are: a physical downlink control channel (PDCCH) including such as allocation information of a physical downlink shared channel (PDSCH, described later) and a physical uplink shared channel (PUSCH, described later) in which user data is stored; a physical control format indicator channel (PCHCH) for notifying information relating to the PDCCH; and a physical hybrid-ARQ indicator channel for transmitting an acknowledgement (ACK) and a negative acknowledgement (NACK) in response to a hybrid automatic repeat request (HARQ) to the PUSCH.

The PDCCH includes, in addition to the allocation information, uplink transmission power control information, and information relating to such as an instruction for notification of a downlink CQI (Channel Quality Indicator), which are described later.

Further, in the DL frame, a physical broadcast channel (PBCH) for notifying, by broadcasting, terminal devices of the frequency band width or the like of the system is allocated to the first subframe #0. The PBCH is arranged, in the time axis direction, in the position corresponding to symbols #0 to #3 in the rear-side slot in the first subframe #0 so as to have a width corresponding to 4 symbols, and arranged, in the frequency axis direction, in the center of the band width of the DL frame so as to have a width corresponding to 6 resource blocks (72 subcarriers). The PBCH is configured to be updated every 40 milliseconds by transmitting the same information over four frames.

The PBCH has, stored therein, major system information such as the communication band width, the number of transmission antennas, and the structure of control information.

Further, the PBCH has, stored therein, information (resource block allocation information) relating to the allocation position of a system information block (SIB) 1 that is stored in the PDSCH and to be transmitted (notified) to an MS connected to a BS, and a master information block (MIB) including a radio frame number required for demodulation of the corresponding PDSCH.

Further, among the 10 subframes that form the DL frame, the 1st (#0) and 6th (#5) subframes are each allocated a primary synchronization channel (P-SCH) and a secondary synchronization channel (S-SCH) which are signals for identifying a base station device or a cell.

The P-SCH is arranged, in the time axis direction, in the position corresponding to symbol #6 that is the last OFDM symbol in the front-side slot in each of subframes #0 and #5 so as to have a width corresponding to one symbol, and arranged, in the frequency axis direction, in the center of the band width of the DL frame so as to have a width corresponding to 6 resource blocks (72 subcarriers). The P-SCH is information by which a terminal device identifies each of a plurality of (three) sectors into which a cell of a base station device is divided, and 3 patterns are defined.

The S-SCH is arranged, in the time axis direction, in the position corresponding to symbol #5 that is the second last OFDM symbol in the front-side slot in each of subframes #0 and #5 so as to have a width corresponding to one symbol, and arranged, in the frequency axis direction, in the center of the band width of the DL frame so as to have a width corresponding to 6 resource blocks (72 subcarriers). The S-SCH is information by which a terminal device identifies each of the communication areas (cells) of a plurality of base station devices, and 168 patterns are defined.

By combining the primary synchronization channel and the secondary synchronization channel, 504 (163×3) types of patterns are defined. When a terminal device obtains a P-SCH and a S-SCH transmitted from a base station device, the terminal device can recognize in which sector of which base station device the terminal device exists.

A plurality of patterns that the P-SCH and the S-SCH can take (by being combined with each other) are defined in advance in the communication standards, and are known by each base station device and each terminal device. That is, each of the P-SCH and the S-SCH is a known signal that can take a plurality of patterns.

The P-SCH and the S-SCH are used as signals not only for synchronization between a terminal device and a base station device but also for inter-base-station synchronization in which communication timings and/or frequencies are synchronized among base station devices.

The resource blocks in a region to which the above-mentioned channels are not allocated are used as the above-mentioned physical downlink shared channel (PDSCH) in which user data and the like are stored. The PDSCH is an area shared by a plurality of terminal devices, and control information and the like for each individual terminal device is stored therein in addition to the user data.

The control information to be stored includes the above-mentioned SIB1. The SIB1 includes information relating to the allocation positions of information such as SIB2 that is a flag indicating whether a currently connected BS 1 is a macro BS or a femto BS, and SIB9 indicating the downlink transmission power of the BS 1 (or information relating to uplink).

Allocation of the user data stored in the PDSCH is notified to terminal devices by downlink allocation information relating to downlink radio resource allocation, which is stored in the PDCCH allocated to the beginning of each subframe. The downlink allocation information is information indicating radio resource allocation for each PDSCH, and allows each terminal device to determine whether data directed to the terminal device is stored in the subframe.

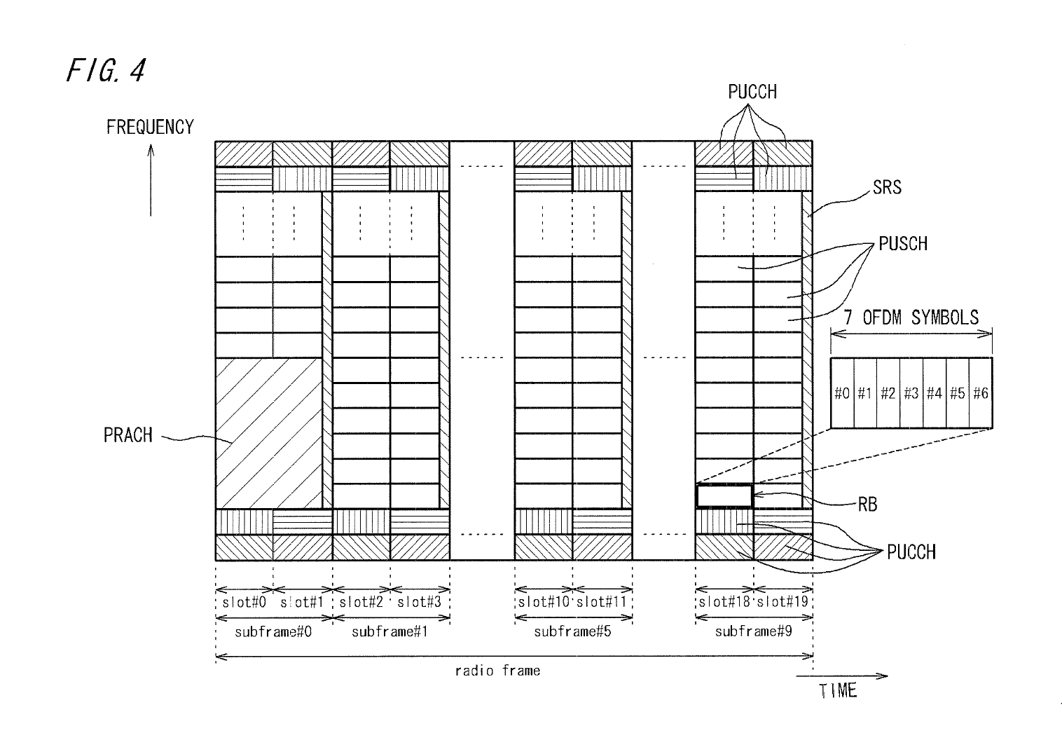

FIG. 4 is a diagram showing the structure of the UL frame in detail. In FIG. 4, the vertical axis direction indicates the frequency, and the horizontal axis direction indicates the time.

The structure of the UL frame is fundamentally equal to that of the DL frame. Each of subframes consists of 2 slots (e.g., slots #0 and #1), and one slot consists of 7 (#0 to #6) OFDM symbols.

Likewise, a resource block (RB) as a fundamental unit area for data transmission is defined by 12 subcarriers in the frequency axis direction and 7 OFDM symbols (1 slot) in the time axis direction.

A physical random access channel (PRACH) used for communication by a terminal device to firstly access a base station device in advance of establishing connection with the base station device, is allocated to the UL frame. The PRACH has a frequency band width corresponding to 6 resource blocks (72 subcarriers), and the allocation thereof is notified to the terminal device by the PBCH (Physical Broadcast Channel) in the DL frame.

A physical uplink control channel (PUCCH) is allocated to each of both ends of each subframe in the frequency axis direction. The PUCCH is used for transmission of information relating to an ACK and a NACK in response to an HARQ to the PDSCH, information relating to a downlink CQI, and the like. Allocation of the PUCCH is notified to the terminal device by the PBCH in the DL frame.

Further, a sounding reference signal (SRS) used for measuring a CQI of an uplink signal of a terminal device is allocated to the last symbol of each subframe.

The resource blocks in a region where the above-mentioned respective channels are not allocated are used as the above-mentioned physical uplink shared channel (PUSCH) for storing user data and the like. The PUSCH is an area shared by a plurality of terminal devices, and control information and the like is stored in the PUSCH in addition to the user data.

Allocation of the user data to the PUSCH is notified to the terminal device by uplink allocation information relating to uplink radio resource allocation, which is stored in the PUCCH in the DL frame. The uplink allocation information is information indicating radio resource allocation for each PUSCH, and allows the terminal device to recognize the PUSCH to be used for transmission.

[1.1.3 Configuration of Base Station Device]

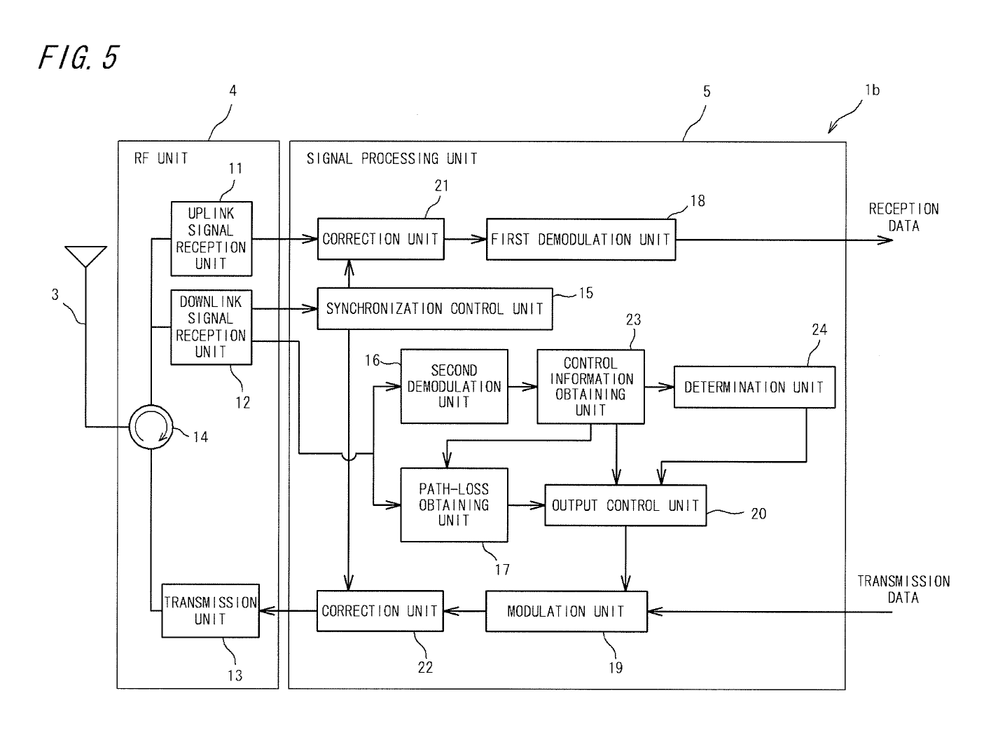

FIG. 5 is a block diagram showing the configuration of a femto BS 1b shown in FIG. 1. While the configuration of the femto BS 1b will be described hereinafter, the configuration of a macro BS 1a is substantially the same as the femto BS 1b.

The femto BS 1b includes an antenna 3, a transmission/reception unit (RF unit) 4 to which the antenna 3 is connected, and a signal processing unit 5 that performs signal processing on signals transmitted to and received from the RF unit 4, and a process of suppressing interference to another base station device or the like.

[1.1.3.1 RF Unit]

The RF unit 4 includes an uplink signal reception unit 11, a downlink signal reception unit 12, and a transmission unit 13. The uplink signal reception unit 11 receives an uplink signal from an MS 2, and the downlink signal reception unit 12 receives a downlink signal from another macro BS 1a or another femto BS 1b. The transmission unit 13 transmits a downlink signal to an MS 2.

The RF unit 4 further includes a circulator 14. The circulator 14 provides a reception signal from the antenna 3 to the uplink signal reception unit 11 and to the downlink signal reception unit 12, and provides a transmission signal outputted from the transmission unit 13 to the antenna 3. The circulator 14 and a filter included in the transmission unit 13 prevent the reception signal from the antenna 3 from being transmitted to the transmission unit 13.

Further, the circulator 14 and a filter included in the uplink signal reception unit 11 prevent the transmission signal outputted from the transmission unit 13 from being transmitted to the uplink signal reception unit 11. Furthermore, the circulator 14 and a filter included in the uplink signal reception unit 12 prevent the transmission signal outputted from the transmission unit 13 from being transmitted to the uplink signal reception unit 12.

The uplink signal reception unit 11 includes a filter that allows only the frequency band of the uplink signal to pass therethrough, an amplifier, an A/D converter, and the like. The uplink signal reception unit 11 obtains the uplink signal of the MS 2 from the reception signal received by the antenna 3, amplifies the uplink signal, converts the amplified signal into a digital signal, and outputs the digital signal to the signal processing unit 5. Thus, the uplink signal reception unit 11 is a reception unit configured to comply with reception of an uplink signal from an MS 2, and is a reception unit that a base station device essentially requires.

The transmission unit 13 includes a D/A converter, a filter, an amplifier, and the like. The transmission unit 13 receives a transmission signal outputted as a digital signal from the signal processing unit 5, converts the digital signal into an analog signal, amplifies the analog signal, and outputs the amplified signal as a downlink signal from the antenna 3.

While the uplink signal reception unit 11 and the transmission unit 13 are functions necessary for performing essential communication with an MS 2, the femto BS 1b of the present embodiment further includes the downlink signal reception unit 12. The downlink signal reception unit 12 receives a downlink signal transmitted from another BS 1 (another base station device) than the femto BS 1b.

In the present embodiment, the downlink signal from the another BS 1 received by the downlink signal reception unit 12 is used for an inter-base-station synchronization process, obtainment of allocation information, and the like.

Since the frequency band of a downlink signal transmitted from another BS 1 is different from the frequency band of an uplink signal, a general base station device having only the uplink signal processing unit 11 cannot receive the downlink signal transmitted from the another base station device.

That is, in FDD, in contrast to TDD, an uplink signal and a downlink signal, having different frequency bands, simultaneously exist on a transmission path. Therefore, the uplink signal reception unit 11 is designed so as to allow only a signal of uplink signal frequency band to pass through, and block a signal of downlink signal frequency band. Therefore, the uplink signal reception unit 11 cannot receive signals (particularly downlink signals) of other frequencies.

So, the RF unit 4 of the present embodiment includes, in addition to the uplink signal reception unit 11, the downlink signal reception unit 12 for receiving a downlink signal transmitted from another BS 1.

The downlink signal reception unit 12 includes a filter that allows only the frequency band of a downlink signal from another BS 1 to pass therethrough, an amplifier, an A/D converter, and the like. The downlink signal reception unit 12 obtains the downlink reception signal from the another BS 1 from the reception signal received by the antenna 3, amplifies the reception signal, converts the amplified signal into a digital signal, and outputs the digital signal.

The downlink reception signal outputted from the downlink signal reception unit 12 is provided to a synchronization control unit 15, a second demodulation unit 16, and a path-loss value obtaining unit 17, which are included in the signal processing unit 5.

[1.1.3.2 Signal Processing Unit]

The signal processing unit 5 has a function for performing signal processing on transmission/reception signals to be exchanged between the upper layer of the signal processing unit 5 and the RF unit 4. The signal processing unit 5 includes a first demodulation unit 18 that demodulates an uplink signal provided from the uplink signal reception unit 11, as uplink reception data, and outputs the uplink reception data to the upper layer, and a modulation unit 19 that modulates various kinds of transmission data provided from the upper layer.

The modulation unit 19 subjects the transmission data provided from the upper layer to a predetermined modulation scheme, for each predetermined data unit, based on an instruction such as a scheduler (not shown), and allocates the modulated data to the DL frame in units of resource blocks, thereby generating a downlink transmission signal of the femto BS 1b (own downlink transmission signal).

Further, when generating the own downlink transmission signal, the modulation unit 19 stores, in the PDCCH of the own downlink transmission signal, uplink transmission power control information for causing a terminal device connected to the femto BS 1b to adjust the transmission power of its uplink transmission signal, and transmits the own downlink transmission signal to the terminal device, thereby adjusting the transmission power of the terminal device.

Moreover, the modulation unit 19 sets, for each resource block, the transmission power of the own downlink transmission signal and the transmission power of the uplink transmission signal of the terminal device connected to the femto BS 1b, and adjusts, for each resource block, the transmission power of the own downlink transmission signal, based on downlink transmission power control information outputted from an output control unit 20 described later. Likewise, the modulation unit 19 causes the terminal device to adjust, for each resource block, the transmission power of the uplink transmission signal of the terminal device, based on the uplink transmission power control information transmitted to the terminal device.

A correction unit 21 is provided between the first demodulation unit 18 and the uplink signal reception unit 11, and a correction unit 22 is provided between the modulation unit 19 and the transmission unit 13. The correction unit 21 adjusts the frame timing and the subcarrier frequency of the radio frame of the uplink reception signal received by the uplink signal reception unit 11, and the correction unit 21 adjusts the frame timing and the subcarrier frequency of the radio frame of the own downlink transmission signal. The correction units 21 and 22 are controlled by the synchronization control unit 15.

The synchronization control unit 15 obtains the downlink reception signal outputted from the downlink signal reception unit 12, and performs a synchronization process (over-the-air synchronization) of synchronizing the radio frame of femto BS 1b with the radio frame of another BS 1.

Specifically, the synchronization control unit 15 can determine a timing error of its own frame timing relative to the frame timing of the another BS 1, and a frequency error of the frequency of its own subcarrier relative to the frequency of the subcarrier of the another BS 1, by using a P-SCH and a S-SCH included in the downlink reception signal from the another BS 1. Furthermore, the synchronization control unit 15 can perform a synchronization process of controlling the correction units 21 and 22 so that the frame timings and the subcarrier frequencies of the own downlink transmission signal and the uplink reception signal received by the uplink signal reception unit 11 coincide with those of the another BS 1, based on the above-mentioned errors.

The another BS 1 serving as a synchronization source may achieve over-the-air synchronization with still another BS 1, or may determine the frame timing by any other method than over-the-air synchronization, such as autonomously determining the frame timing by using a GPS signal.

However, a macro BS 1a can select another macro BS 1a as a synchronization source, but cannot select a femto BS 1b as a synchronization source. A femto BS 1b can select, as a synchronization source, both a macro BS 1a and another femto BS 1b.

The signal processing unit 5 further includes a second demodulation unit 16, a path-loss value obtaining unit 17, a control information obtaining unit 23, and a determination unit 24.

The second demodulation unit 16 demodulates the downlink reception signal from the another BS 1, which is provided from the downlink signal reception unit 12, and outputs downlink reception data obtained by the demodulation to the control information obtaining unit 23. The second demodulation unit 16 is provided with the reception signal that has been subjected to the synchronization process by the synchronization control unit 15. Thus, the second demodulation unit 16 is provided with the signal synchronized with its own operation timing, and therefore, can perform the demodulation process.

The control information obtaining unit 23 obtains necessary control information from among various pieces of information contained in the downlink reception data, and outputs the control information to the path-loss value obtaining unit 17, the determination unit 24, and the output control unit 20.

The control information obtaining unit 23 decodes the PDCCH of the downlink reception data provided from the second demodulation unit 16 to obtain, as control information to be given to the output control unit 20, downlink allocation information and uplink allocation information which are stored in the PDCCH and are to be notified from the another BS 1 to an MS 2 (hereinafter, also referred to as another MS 2) connected to the another BS 1. Then, the control information obtaining unit 23 outputs, to the output control unit 20, the downlink allocation information and the uplink allocation information as information indicating the allocation status of the radio resource that the another BS 1 allocates to the another MS 2.

The path-loss value obtaining unit 17 determines a path-loss value of the downlink reception signal, based on the control information provided from the control information obtaining unit 23, and the downlink reception signal provided from the downlink signal reception unit 12.

Based on the control information provided from the control information obtaining unit 23, the determination unit 24 determines whether (the type of) the another BS 1 as a transmission source of the downlink reception signal is a femto BS or a macro BS (which forms a communication area broader than the communication area of the femto BS 1b), and outputs the result of the determination to the output control unit 20.

Based on the downlink allocation information and the uplink allocation information provided from the control information obtaining unit 23, the path-loss value of the downlink signal from the another BS 1, and the determination result of the determination unit 24, the output control unit 20 generates transmission power control information for adjusting the transmission power of the own downlink transmission signal and the transmission power of the uplink transmission signal from the MS 2 (hereinafter, also referred to as own MS 2) connected to the femto BS 1b, and outputs the transmission power control information to the modulation unit 19.

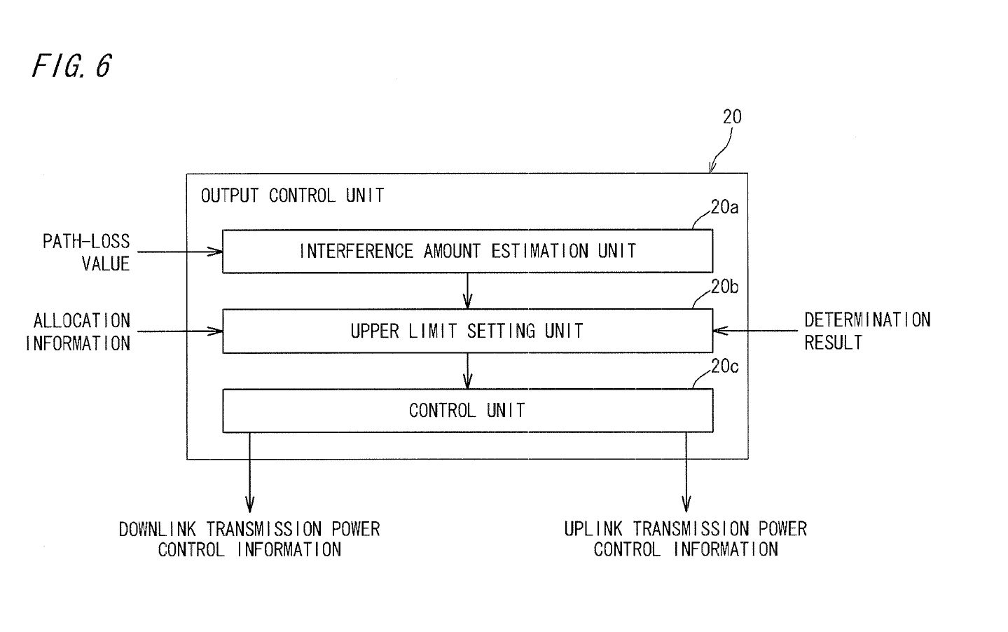

FIG. 6 is a block diagram showing the configuration of the output control unit 20. As shown in FIG. 6, the output control unit 20 includes: an interference amount estimation unit 20a that estimates, from the path-loss value, an amount of interference that the own MS 2 is likely to cause in the another BS 1; an upper limit setting unit 20b that sets the upper limit values of the transmission powers of the own downlink transmission signal and the uplink transmission signal of the own MS 2, based on the estimated amount of interference, the downlink allocation information, the uplink allocation information, and the determination result of the determination unit 24; and a control unit 20c that causes the modulation unit 19 to perform a process relating adjustment of the transmission powers of the both transmission signals within the ranges of the set upper limit values.

[1.1.4 Configuration of Terminal Device]

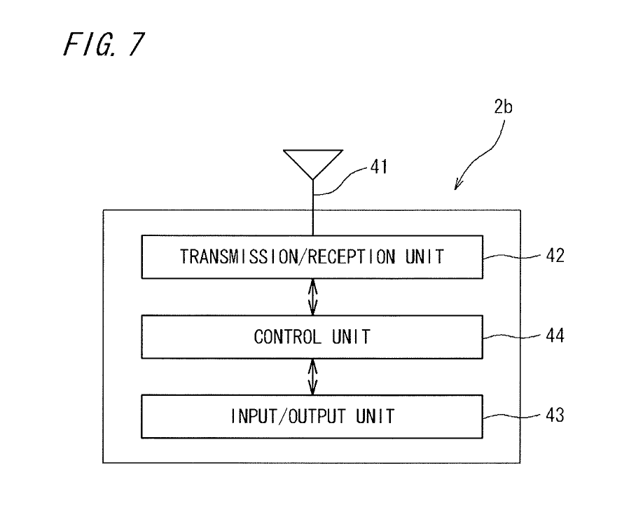

FIG. 7 is a block diagram showing the configuration of an MS 2 shown in FIG. 1. Note that a macro MS 2a and a femto MS 2b have the same configuration, except that their destinations are a macro BS 1a and a femto BS 1b, respectively.

The MS 2 includes: an antenna 41; a transmission/reception unit 42 to which the antenna 41 is connected, and which performs reception of a downlink signal from a BS 1 and transmission of an uplink signal to be transmitted; an input/output unit 43 that is implemented by a keyboard, a monitor, and the like, and performs input/output of reception/transmission data; and a control unit 44 that controls the transmission/reception unit 42 and the input/output unit 43, and performs processes required for communication with a BS 1, such as modulation, demodulation, and the like.

The control unit 44 receives various kinds of control information included in a downlink signal from a BS 1 connected to the MS 2, and performs communication with the BS 1 in accordance with the control information. The various kinds of control information provided from the BS 1 may include: uplink allocation information indicating a frequency band allocated to an uplink signal of the MS 2; information relating to the transmission power; and information relating to the modulation scheme.

That is, the BS 1 transmits the various kinds of control information to the MS 2 connected thereto to perform control relating to the uplink signal of the MS 2.

In the above-mentioned wireless communication system, after installation of a macro BS 1a, a femto BS 1b is installed in a macro cell MC formed by the macro BS 1a, and then forms a femto cell FC in the macro cell MC. Therefore, a downlink signal transmitted from the femto BS 1b is likely to interfere with a macro MS 2a that communicates with the macro BS 1a. Further, an uplink signal transmitted from a femto MS 2b that communicates with the femto BS 1b is likely to interfere with the macro BS 1a.

Moreover, the downlink signal transmitted from the femto BS 1b is likely to interfere with another femto MS 2b that communicates with another femto BS 1b located in the neighborhood of the femto BS 1b. Furthermore, the uplink signal transmitted from the femto MS 2b that communicates with the femto BS 1b is likely to interfere with another femto BS 1b.

In contrast, the femto BS 1b of the present embodiment has a function of controlling the transmission power of its own downlink transmission signal and/or the transmission power of an uplink transmission signal of a femto MS 2b connected to the femto BS 1b, thereby effectively suppressing such interferences that may occur in many cases as described above. Hereinafter, this function will be described in detail.

[1.1.5 Function to Suppress Interference]

The femto BS 1b according to the present embodiment adopts different methods for interference suppression depending on whether another BS 1 is a femto BS 1b or a macro BS 1a. Accordingly, the femto BS 1b firstly determines whether another BS 1 is a macro BS 1a or a femto BS 1b. Hereinafter, the determination method will be described.

[1.1.5.1 Method of Determining Whether Another BS is a Macro BS or a Femto BS]

As described above, the femto BS 1b has a function of obtaining control information transmitted from another BS 1 to another MS 2, from downlink reception data that has been obtained by demodulating a downlink signal received from the another BS 1 by the downlink signal reception unit 12.

Firstly, the synchronization control unit 15 of the femto BS 1b performs a search (neighboring cell search) as to whether another BS 1 exists in the neighborhood of the femto BS 1b, based on a downlink signal received by the downlink signal reception unit 12. Upon obtaining a downlink signal from another BS 1 as a result of the neighboring cell search, the synchronization control unit 15 performs a synchronization process by using the downlink signal (downlink reception signal) from the another BS 1.

Next, the femto BS 1b again obtains the downlink reception signal of the another BS 1 after the above-mentioned synchronization process, and causes the second demodulation unit 16 to demodulate the downlink reception signal. Downlink reception data obtained by demodulating the downlink reception signal is provided to the control information obtaining unit 23. The control information obtaining unit 23 refers to an MIB included in a PBCH in a frame in the demodulated data, and obtains information relating to the allocation position of an SIB1 stored in a PBSCH. Further, the control information obtaining unit 23 obtains the SIB 1 from the obtained information, and obtains information relating to allocation positions of an SIB2 and an SIB9 included in the SIB1. Thus, the control information obtaining unit 23 obtains the SIB2 and the SIB9 from the demodulated data.

The control information obtaining unit 23 outputs the SIB2 as the obtained control information to the determination unit 24, and outputs the SIB9 as the obtained control information to the path-loss value obtaining unit 17.

The SIB2 is a flag indicating whether a BS 1 is a macro BS or a femto BS, as described above. The determination unit 24 can determine whether the another BS 1 is a macro BS 1a or a femto BS 1b by referring to the SIB2 provided from the control information obtaining unit 23. In this case, the SIB2 as information indicating the type of the another BS 1 allows the determination unit 24 to accurately determine the type of the another BS 1.

The SIB9 is information indicating the transmission power of a downlink signal from a BS 1, as described above. Since the transmission power of a macro BS 1a that forms a broad macro cell MC is set to be greater than that of a femto BS 1b that forms a relatively narrow femto cell FC, the determination unit 24 can perform the above-mentioned determination by referring to the SIB9 obtained from the control information obtaining unit 23. Also in this case, the SIB9 as information indicating the transmission power of the downlink signal from the another BS 1 allows the determination unit 24 to accurately determine the type of the another BS 1.

[1.1.5.2 Method of Obtaining a Path-Loss Value of a Downlink Reception Signal from Another BS]

The path-loss value obtaining unit 17 of the femto BS 1b according to the present embodiment obtains a path-loss value of a downlink signal from another BS 1 to the femto BS 1b, in order to estimate an amount of interference that an uplink transmission signal from a femto MS 2b connected to the femto BS 1b may cause in the another BS 1.

Hereinafter, a description will be given of a method of obtaining, by the path-loss value obtaining unit 17, a path-loss value of a downlink signal received from another BS 1.

As described above, the path-loss value obtaining unit 17 of the femto BS 1b obtains a path-loss value of the downlink reception signal, based on the SIB9 as the control information provided from the control information obtaining unit 23, and the downlink reception signal provided from the downlink signal reception unit 12.

Specifically, the path-loss value obtaining unit 17 obtains, as a path-loss value, a channel gain between the downlink signal transmitted from the another BS and the reception signal that is the downlink signal received by the femto BS 1b.

The path-loss value obtaining unit 17 uses, as the downlink signal transmitted from the another BS, a plurality of reference signals that are known signals arranged (dotted) in predetermined positions, among a plurality of symbols constituting a radio frame.

The channel gain is obtained as follows. The power of the reception signal is expressed by the following equation (1). Note that, in the equation, the unit of each value is “dBm”.

reception signal power Y(n)=H×X(n)+Z(n) (1)

In equation (1), X(n) is the power, at transmission, of the downlink signal (reference signal) transmitted from the another BS 1, Z is thermal noise or interference power from another base station device, and H is the transmission path characteristic, i.e., the channel gain.

Based on equation (1), an average value of |Y(n)×conj(X(n))| is expressed by the following equation (2):

$$\begin{matrix}E [ \vert Y ( n ) \times conj ( X ( n ) ) \vert ] = H \times E [ {\vert X ( n ) \vert}^{2} ] + \\ E [ \vert Z ( n ) \times conj ( X ( n ) ) \vert ] \\ = H \times E [ {\vert X ( n ) \vert}^{2} ]\end{matrix} \qquad ( 2 )$$

Based on equation (2), the transmission path characteristic H is expressed by the following equation (3):

H=E[|Y(n)X(n)^{H}|]/E[|X(n)X(n)^{H}|] (3)

where, X(n)^{H} is the complex conjugate transpose of X(n)

The power Y(n) of the reception signal can be obtained from the downlink reception signal received by the femto BS 1b, and the power X(n), at transmission, of the downlink signal (reference signal) transmitted from the another BS 1 can be obtained from the SIB9 as information indicating the downlink transmission power of the another BS 1.

As described above, the path-loss value obtaining unit 17 obtains the channel gain H to obtain the path-loss value. Thus, the path-loss value obtaining unit 17 can accurately obtain the path-loss value, based on the SIB9 as information indicating the transmission power of the downlink signal, and the reception power of the reception signal.

[1.1.5.3 Suppression of Interference Caused by a Downlink Transmission Signal from a Femto BS]

Hereinafter, a description will be given of a transmission power control process performed by the output control unit 20 to suppress interference that a downlink transmission signal from the femto BS 1b of the present embodiment causes in another MS 2.

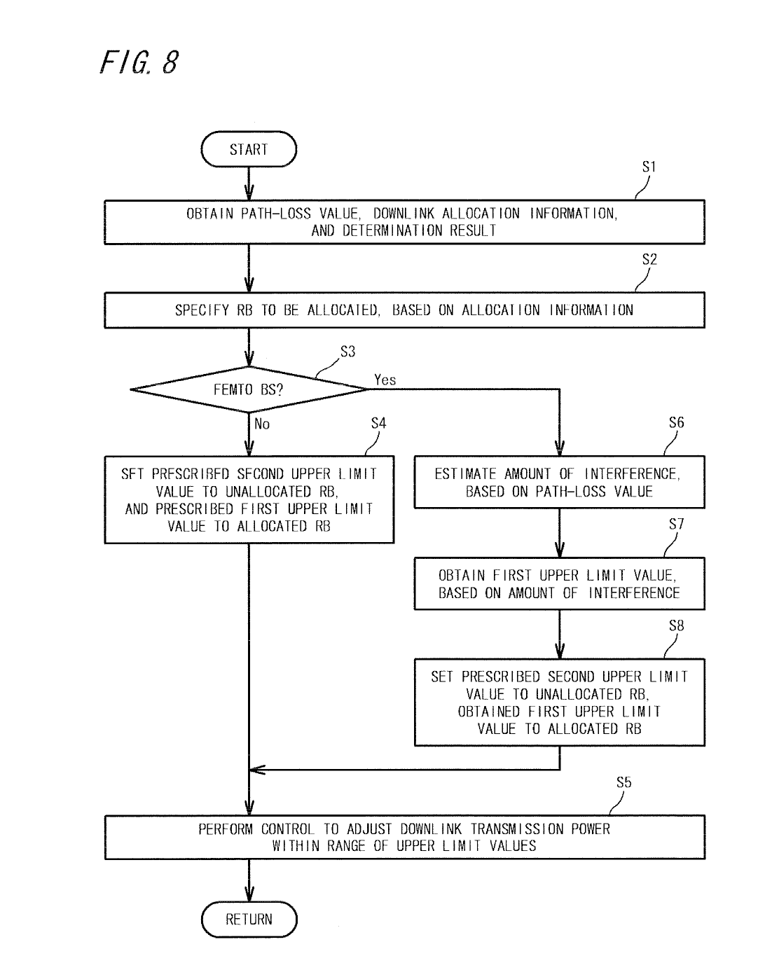

FIG. 8 is a flowchart showing the process of controlling the transmission power of the downlink transmission signal, which is performed by the output control unit 20.

Firstly, the output control unit 20 obtains the path-loss value from the path-loss value obtaining unit 17, the determination result of the determination unit 24, and the downlink allocation information from the control information obtaining unit 23 (step S1), and specifies resource blocks allocated to the another MS 2 in the downlink, with reference to the downlink allocation information (step S2).

Next, based on the determination result, the output control unit 20 determines whether the another BS 1 is a femto BS 1b (step S3).

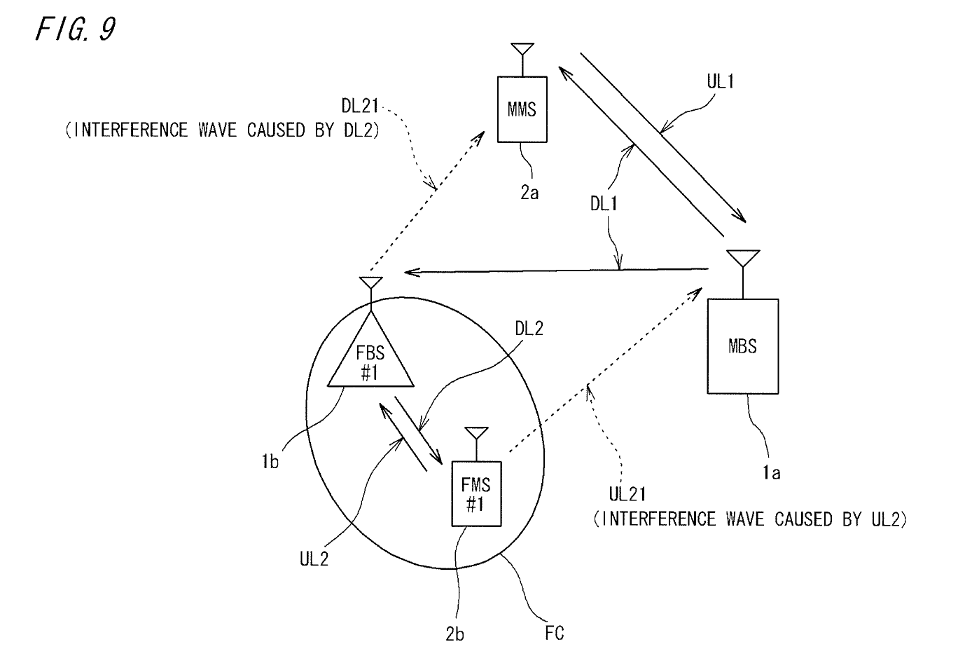

FIG. 9 is a diagram showing interferences in communication between a macro BS 1a and a macro MS 2a, and in communication between a femto BS 1b and a femto MS 2b in FIG. 1. In FIG. 9, the femto BS 1b and the femto MS 2b correspond to the FBS#1 and the FBS#1 connected to the FBS#1 in FIG. 1, respectively.

FIG. 9 shows a case where the femto BS 1b, which has received a downlink signal DL1 from a macro BS 1a, determines in step S3 that the another BS 1 is not a femto BS 1b, that is, the another BS 1 is a macro BS 1a.

In the case of FIG. 9, the femto BS 1b transmits a downlink signal DL2 to the femto MS 2b (own MS 2) connected to the femto BS 1b. The downlink signal DL2 is likely to interfere with the macro MS 2a that is another MS 1 connected to the macro BS 1a as another BS 1. Depending on the position where the macro MS 2a exists, the downlink signal DL2 from the femto BS 1b reaches the macro MS 2a as an interference wave DL21.

The macro MS 2a intends to obtain the information that is stored in the resource blocks allocated to the macro MS 2a, based on the downlink allocation information stored in the downlink signal DL1 from the macro BS 1a. Therefore, the transmission power of the downlink signal DL2 of the femto BS 1b, i.e., the interference wave DL21, is set to a power with which the interference wave DL21 does not reach the macro MS 2a, for only the resource blocks allocated to the macro MS 2a. Thereby, it is possible to suppress interference to the macro MS 2a.

Referring back to FIG. 8, when it is determined in step S3 that the another BS 1 is a macro BS 1a, the upper limit setting unit 20b of the output control unit 20 sets a specified first upper limit value, which has previously been stored, to the transmission power in the resource blocks allocated to the macro MS 2a as the another MS 2, and sets a specified second upper limit value, which has previously been stored, to the transmission power in the resource blocks that are not allocated to the macro MS 2a (step S4).

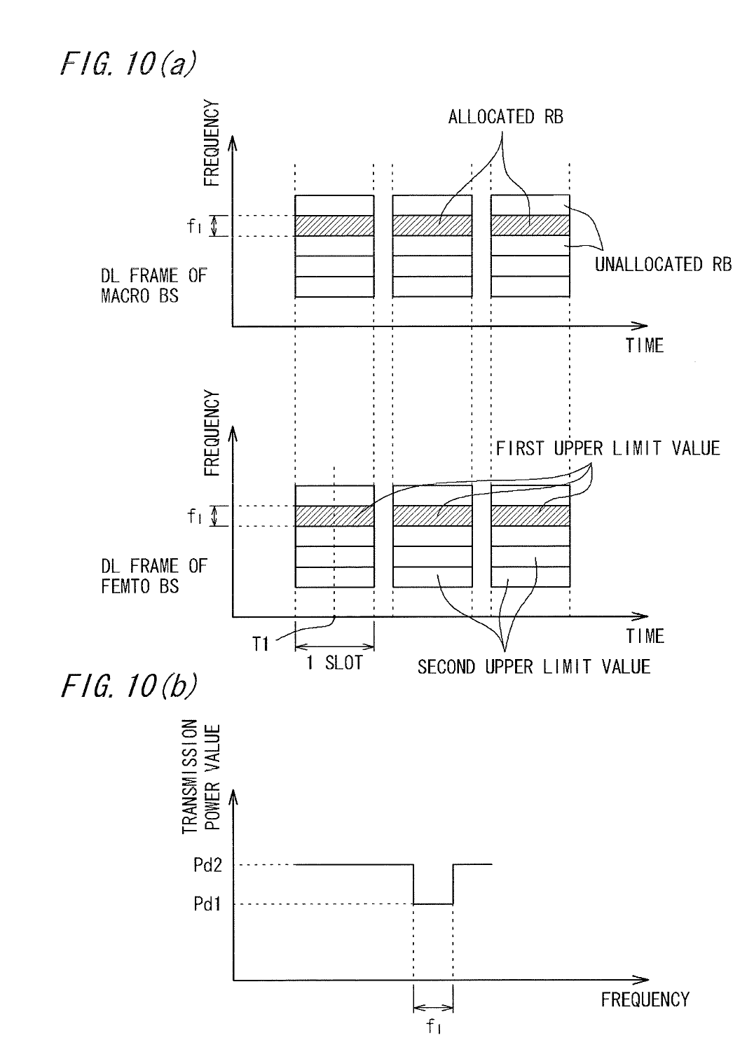

FIG. 10(a) is a diagram showing an example of a radio resource allocation status in a part of a downlink radio frame of the macro BS 1a, and an example of setting of upper limit values of a transmission signal in a downlink radio frame (in the same part as above) of the femto BS 1b. FIG. 10(b) is a diagram showing a manner of setting upper limit values of the transmission power in the frequency direction at time T1 in FIG. 10(a).

FIG. 10(a) shows the allocation status in each resource block, and setting of the upper limit value. In the upper part of FIG. 10(a), hatched resource blocks positioned in the frequency band f1 are the above-mentioned allocated resource blocks, and unhatched resource blocks are the above-mentioned unallocated resource blocks. Note that in FIG. 10(a) only the PDSCH is shown for easy understanding.

As shown in FIG. 10(a), the output control unit 20 of the femto BS 1b sets a transmission power value Pd1 as the first upper limit value for the allocated resource blocks, and sets a transmission power value Pd2 as the second upper limit value for the unallocated resource blocks.

As shown in FIG. 10(b), the second upper limit value (the transmission power value Pd2) is set to be greater than the first upper limit value (the transmission power value Pd1). The second upper limit value (the transmission power value Pd2) is set to a value required for forming a femto cell FC of the femto BS 1b. The first upper limit value (the transmission power value Pd1) is set to a value that does not cause interference in an MS 2 located in the neighborhood of the own femto cell FC.

While FIG. 10(a) shows the case where the allocated resource blocks are positioned in the same frequency band f1, the above-mentioned setting is similarly performed even in the case where a plurality of allocated resource blocks are positioned in different frequency bands at the same timing.

As described above, the upper limit setting unit 20b sets the upper limit value of the transmission power of the own downlink transmission signal, for each resource block, based on the downlink allocation information.

Referring back to FIG. 8, after the setting of the upper limit value of the transmission power, the control unit 20c of the output control unit 20 causes the modulation unit 19 to adjust the transmission power of the downlink transmission signal, for each resource block, within the range of the set upper limit value, and then ends the process (step S5).

In this case, the output control unit 20 adjusts the transmission power of the allocated resource blocks within the range of the first upper limit value that does not cause interference in the MS 2 located in the neighborhood of the own femto cell FC. Therefore, it is possible to suppress interference that the downlink transmission signal from the femto BS 1b causes in the macro MS 2a.

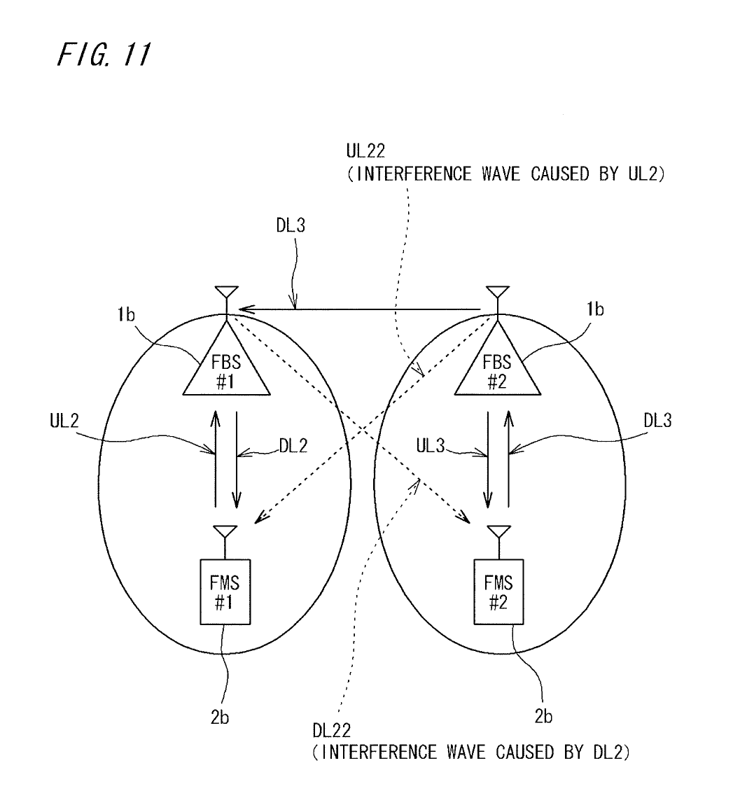

FIG. 11 is a diagram showing interferences in communication between a femto BS 1a (FBS#1) and a femto MS 2a (FMS#1), and in communication between a femto BS 1b (FBS#2) as another BS 1 and a femto MS 2b (FMS#2) as another MS 2.

FIG. 11 shows a case where the femto BS 1b (FBS#1) as own BS 1 receives a downlink signal DL3 from the another femto BS 1b (FBS#2), and thereby determines in step S3 that the another BS 1 is a femto BS 1b.

In the following description with reference to FIG. 11, the femto BS 1b (FBS#1) as own BS 1 is simply referred to as FBS#1, the femto MS 2a (FMS#1) connected to the FBS#1 is simply referred to as FMS#1, the another femto BS 1b (FBS#2) is simply referred to as FBS#2, and the femto MS 2a (FMS#2) connected to the FBS#2 is simply referred to as FMS#2.

In the case of FIG. 11, the FBS#1 transmits a downlink signal DL2 to the FMS#1 connected to the FBS#1. The downlink signal DL2 is likely to interfere with the FMS#2 connected to the FBS#2. This is because the downlink signal DL2 from the FBS#1 might reach the FMS#2 as an interference wave DL22.

Also in this case, as in the case shown in FIG. 9, the transmission power of the downlink signal DL2 from the FBS#1, i.e., the interference wave DL22, is set to a power with which the interference wave DL22 does not reach the FMS#2, for only the resource blocks allocated to the FMS#2. Thereby, it is possible to suppress such interference to the FMS#2.

Referring back to FIG. 8, when it is determined in step S3 that the another BS 1 is a femto BS 1b (FBS#2), the interference amount estimation unit 20a of the output control unit 20 estimates an amount of interference that the own downlink transmission signal causes in the FMS#2 connected to the FBS#2 (step S6).

In this case, the allocated resource blocks specified in step S2 are the resource blocks being allocated to the FMS#2.

Since the FMS#2 exists in the relatively narrow femto cell FC formed by the FBS#2, if it is considered that the FMS#2 and the FBS#2 exist in approximately the same position as viewed from the FBS#1, the path-loss value of the downlink signal DL3 from the FBS#2 to the FBS#1 can be estimated to be the path-loss value of the interference wave DL22 (downlink signal DL2) from the FBS#1 to the FBS#2. Since the path-loss value is a propagation loss depending on the distance between the devices, the interfering device can estimate, from its current transmission power, the magnitude of the power with which the interference wave reaches the interfered device. Therefore, it is possible to estimate the amount of interference from the estimated path-loss value.

The following will describe, in detail, the reason why the amount of interference can be estimated from the estimated path-loss value.

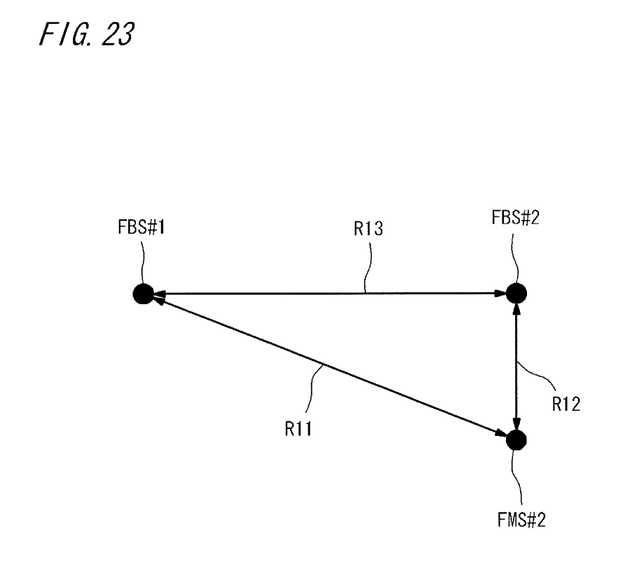

FIG. 23 is a diagram for explaining the positional relationships among the FBS#1, the FBS#2, and the FMS#2. Since the FMS#2 exists in a relatively narrow femto cell FC formed by the FBS#2, the FMS#2 and the FBS#2 can be regarded to exist in approximately the same position as viewed from the FBS#1. That is, since the distance R12 between the FBS#2 and the FMS#2 is sufficiently short relative to the distance R11 between the FBS#1 and the FMS#2, the distance R11 and the distance R13 between the FBS#1 and the FBS#2 can be regarded to be approximately the same. As a result, the path-loss value of the downlink signal DL3 from the FBS#2 to the FBS#1 can be estimated to be the path-loss value of the interference wave DL22 (downlink signal DL2) from the FBS#1 to the FBS#2.

Further, since the path-loss value is a propagation loss depending on the distance between the devices, the interfering device can estimate, from its current transmission power, the magnitude of the power with which the interference wave reaches the interfered device. Therefore, it is possible to estimate the amount of interference from the estimated path-loss value.

As described above, the interference amount estimation unit 20a estimate the amount of interference that the downlink signal of the FBS#1 causes in the FMS#2, based on the path-loss value of the downlink signal from the FBS#2 to the FBS#1, which is provided from the path-loss value obtaining unit 17.

The amount of interference is expressed by the following equation (4). In the equation, the unit of each value is “dBm”.

amount of interference=Pt−L (4)
where, Pt is the transmission power value, and L is the path-loss value.

Then, based on the amount of interference estimated in step S6, the upper limit setting unit 20b obtains a first upper limit value to be set to the transmission power of the allocated resource blocks (step S7).

As for the first upper limit value, a value is adopted which is obtained by adding a predetermined offset value Po to a transmission power value Pt at which the amount of interference has a value (allowable interference value) that allows determination that the interference does not adversely affect the interfered side. That is, a transmission power value Pd3 as the first upper limit value is expressed by the following equation (5). In the equation, the unit of each value is “dBm”.

transmission power value Pd3=allowable interference value+L+Po (5)

The offset value Po is a value to be added only when the another BS 1 is a femto BS 1b, and as described later, is a value to cause the transmission power to be greater than in the case where the another BS 1 is a macro BS 1a.

Next, the upper limit setting unit 20b sets the first upper limit value obtained based on the amount of interference, to the transmission power in the resource blocks allocated to the FMS#2, and sets the second upper limit value to the transmission power in the resource blocks that are not allocated to the macro MS 2a (step S8).

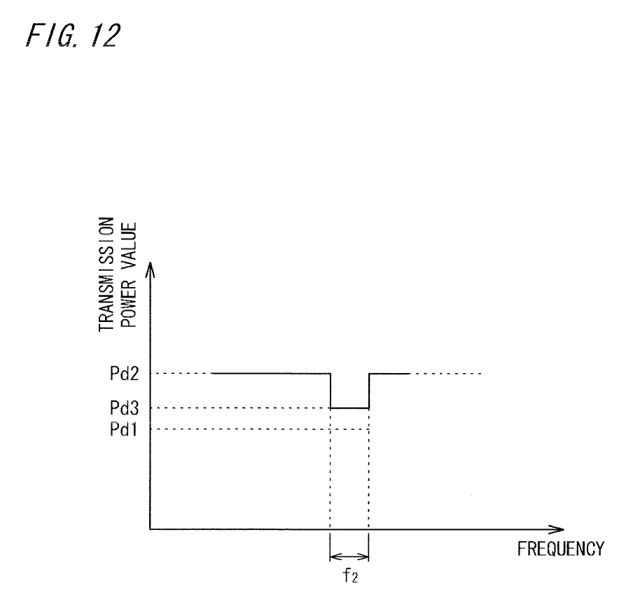

FIG. 12 is a diagram showing an example of a manner of setting the upper limit values of the transmission power in the frequency direction. In FIG. 12, the frequency band f2 indicates a part corresponding to the allocated resource blocks, and the other part corresponds to the unallocated resource blocks.

The transmission power value Pd3 as the first upper limit value of the transmission power set to the allocated resource blocks is obtained based on the above equation (5) in principle. Then, as shown in FIG. 12, the transmission power value Pd3 is set to be greater than the transmission power value Pd1 as the first upper limit value in the case where the another BS 1 is determined as a macro BS 1a, and smaller than the transmission power value Pd2 as the second upper limit value.

Therefore, in the femto BS 1b of the present embodiment, the interference suppression effect for the macro MS 2a is set to be relatively greater than the interference suppression effect for the FMS#2.

It is generally preferable that a femto BS 1b is set to perform its communication after communication by a macro BS 1a that forms a macro cell MC. This is because the communication performed by the macro BS 1a that forms the macro cell as a broad communication area is highly public.

In contrast, the femto BS 1b of the present embodiment is provided with the determination unit 24 that determines whether the another BS 1 is a femto BS 1b, and the output control unit 20, as described above, determines the first upper limit value to be set to the allocated resource blocks, in accordance with the determination result of the determination unit 24. Therefore, it is possible to appropriately set the first upper limit value in accordance with whether the another BS 1 is a macro BS 1a.

Furthermore, in the present embodiment, as described above, the interference suppression effect for the macro MS 2a is set to be relatively greater than the interference suppression effect for the FMS#2. Therefore, it is possible to give higher priority to communication by the macro BS 1a than to communication by the FBS#2.

As described above, the upper limit setting unit 20b sets the upper limit value of the transmission power of the own downlink transmission signal, for each resource block, based on the downlink allocation information (step S8). Thereafter, the control unit 20c of the output control unit 20 causes the modulation unit 19 to adjust the transmission power of the downlink transmission signal, for each resource block, within the range of the set upper limit value (step S5), and then ends the process.

[1.1.5.4 Suppression of Interference Caused by an Uplink Transmission Signal from a Femto MS]

Next, a description will be given of a process performed by the output control unit 20 of the femto BS 1b according to the present embodiment, to suppress interference that an uplink transmission signal from a femto MS 2b causes in another BS 1.

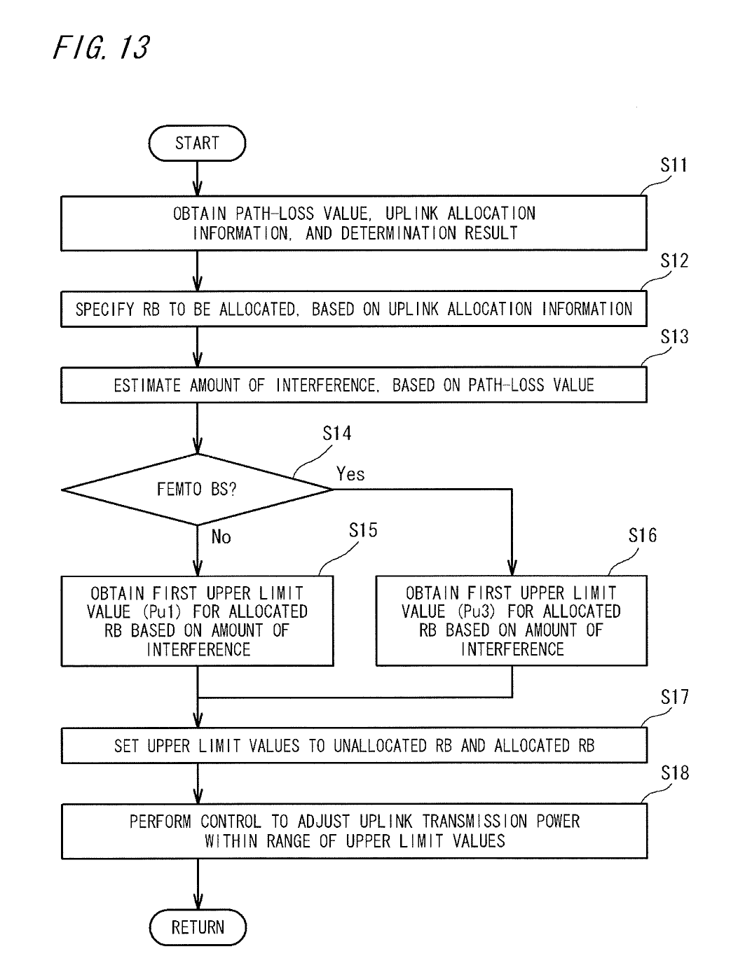

FIG. 13 is a flowchart showing a process of controlling the transmission power of the uplink transmission signal from the femto MS 2b, which is performed by the output control unit 20.

Firstly, the output control unit 20 obtains the path-loss value, the determination result, and the uplink allocation information (step S11), and specifies resource blocks allocated to another MS 2 in the uplink, with reference to the uplink allocation information (step S12).

Next, the interference amount estimation unit 20a of the output control unit 20 estimates the amount of interference that the uplink transmission signal of the femto MS 2b may cause in another BS 1(step S13).

As shown in FIGS. 9 and 11, since the femto MS 2b (FMS#1) connected to the femto BS 1b (FBS#1) exists in the relatively narrow femto cell FC that is formed by the femto BS 1b (FBS#1), if it is considered that the femto MS 2b (FMS#1) and the femto BS 1b (FBS#1) exist in approximately the same position as viewed from the macro BS 1a (FBS#2) as the another BS 1, the path-loss value of the downlink signal DL1 (DL3) from the macro BS 1a (FBS#2) to the femto BS 1b (FBS#1) can be estimated to be the path-loss value of the interference wave UL21 (UL22) (uplink signal UL2) from the femto MS 2b (FMS#1) to the macro BS 1a (FBS#2). As described above, since the path-loss value is a propagation loss depending on the distance between the devices, the interfering device can estimate, from its current transmission power, the magnitude of the power with which the interference wave reaches the interfered device. Therefore, it is possible to estimate the amount of interference from the estimated path-loss value.

The following will describe, in detail, the reason why the amount of interference can be estimated from the estimated path-loss value.

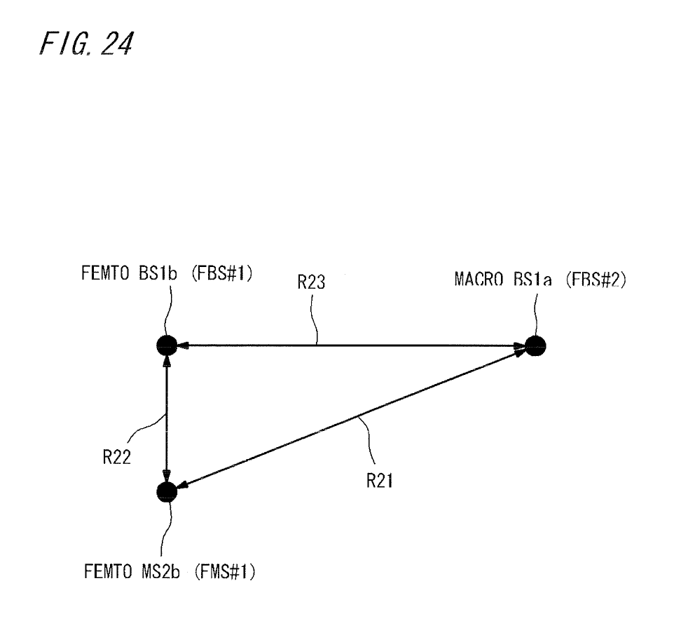

FIG. 24 is a diagram for explaining the positional relationships among the femto BS 1b (FBS#1), the femto MS 2b (FMS#1), and the macro BS 1a (FBS#2) in each of the cases shown in FIGS. 9 and 11.

Since the femto MS 2b (FMS#1) connected to the femto BS 1b (FBS#1) exists in the relatively narrow femto cell FC that is formed by the femto BS 1b (FBS#1), it is considered that the femto MS 2b (FMS#1) and the femto BS 1b (FBS#1) exist in approximately the same position as viewed from the macro BS 1a (FBS#2) that is another BS 1. That is, since the distance R22 between the femto BS 1b (FBS#1) and the femto MS 2b (FMS#1) is sufficiently short relative to the distance R21 between the femto MS 2b (FMS#1) and the macro BS 1a (FBS#2), the distance R21 and the distance R23 between the femto BS 1b (FBS#1) and the macro BS 1a (FBS#2) can be regarded to be approximately the same. As a result, the path-loss value of the downlink signal DL1 (DL3) from the macro BS 1a (FBS#2) to the femto BS 1b (FBS#1) can be estimated to be the path-loss value of the interference wave UL21 (UL22) (uplink signal UL2) from the femto MS 2b (FMS#1) to the macro BS 1a (FBS#2). As described above, since the path-loss value is a propagation loss depending on the distance between the devices, the interfering device can estimate, from its current transmission power, the magnitude of the power with which the interference wave reaches the interfered device. Therefore, it is possible to estimate the amount of interference from the estimated path-loss value.

Further, in the case shown in FIG. 9, the distance between the macro BS 1a and the femto BS 1b (femto MS 2b) is relatively longer than the distance between the femto BS 1b and the femto MS 2b, more accurate estimation can be achieved.

As described above, based on the path-loss value of the downlink signal from the another BS 1 to the femto BS 1b (own BS 1), which is provided from the path-loss value obtaining unit 17, the interference amount estimation unit 20a estimates the amount of interference that the uplink signal from the femto MS 2b connected to the own BS 1 may cause in the another BS 1.

After the estimation of the amount of interference in step S13, the upper limit setting unit 20b determines whether the another BS 1 is a femto BS 1b, based on the above-mentioned determination result (step S14).

When it is determined that the another BS 1 is not a femto BS 1b (the another BS 1 is a macro BS 1a) (the case of FIG. 9), the upper limit setting unit 20b of the output control unit 20 obtains, based on the amount of interference obtained in step S13, a transmission power value Pu1 as the first upper limit value to be set to the transmission power of the allocated resource blocks (step S15).

On the other hand, when it is determined that the another BS 1 is a femto BS 1b (the case of FIG. 11), the upper limit setting unit 20b obtains, based on the amount of interference, a transmission power value Pu3 as the first upper limit value to be set to the transmission power of the allocated resource blocks (step S16).

The transmission power value Pu3 can be similarly obtained by the above equation (5). Further, the transmission power value Pu1 is set to a value obtained by subtracting the offset value Po added to the transmission power value Pu3. That is, the transmission power values Pu1 and Pu3 are expressed by the following equations (6) and (7), respectively. In the equations, the unit of each value is “dBm”.

transmission power value Pu1=allowable interference value+L (6)

transmission power value Pu3=allowable interference value+L+Po (7)

The offset value Po is a value to be added only when the another BS 1 is a femto BS 1b, and a value to cause the transmission power to be greater than in the case where the another BS 1 is a macro BS 1a. That is, when the another BS 1 is a femto MS 2b, the upper limit setting unit 20b obtains the transmission power value Pu1 based on the amount of interference, and then adds the offset value Po to the transmission power value Pu1, thereby obtaining the transmission power value Pu3 as the first upper limit value.

After obtaining the first upper limit value in step S15 or S16, the upper limit setting unit 20b sets the first upper limit value obtained in the step to the transmission power of the allocated resource blocks, and sets the transmission power value Pu2 (the second upper limit value stored in advance) to the transmission power of the resource blocks not allocated to the macro MS 2a (step S17).

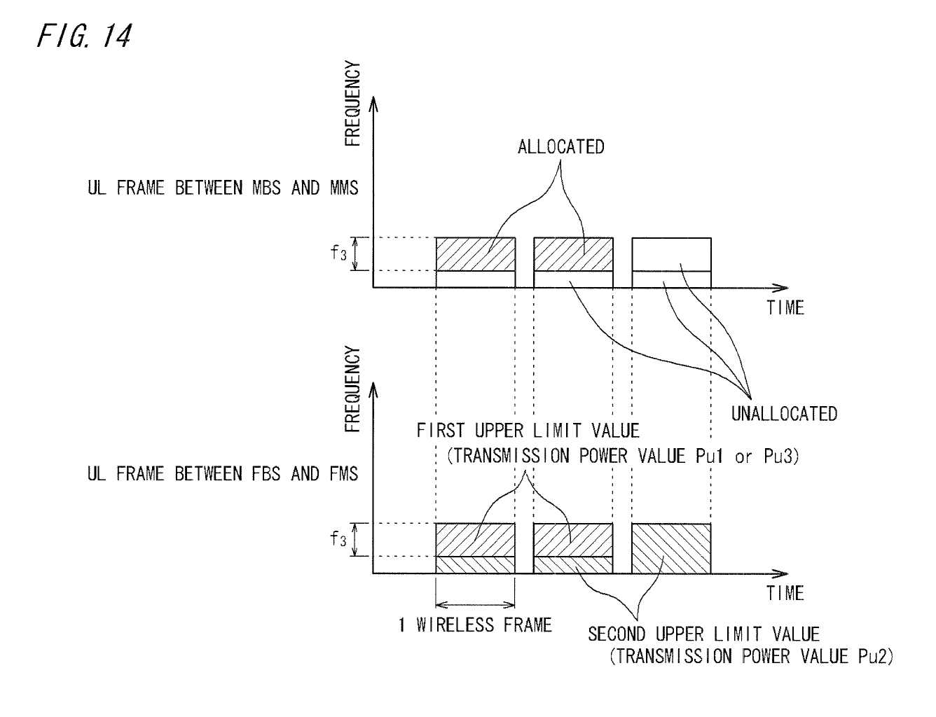

FIG. 14 is a diagram showing, in the case where the another BS 1 is the macro BS 1a, an example of an allocation status of a radio resource allocated to the macro MS 2b in an uplink radio frame between the macro BS 1a and the macro MS 2a, and an example of setting of upper limit values of the transmission signal in the uplink radio frame between the femto BS 1b and the femto MS 2b in the same area as the above uplink frame.

FIG. 14 shows the allocation status for each radio frame, and setting of the upper limit values. In an upper part of FIG. 14, hatched areas positioned in the frequency band f3 indicate parts constituted by the allocated resource blocks, and unhatched areas indicate parts constituted by the unallocated resource blocks.

As shown in FIG. 14, the output control unit 20 of the femto BS 1b sets the first upper limit value (the transmission power value Pu1 or Pu3) to the areas constituted by the allocated resource blocks, and sets the second upper limit value (the transmission power value Pu2) to the areas constituted by the unallocated resource blocks.

The transmission power value Pu2 as the second upper limit value is set to a sufficient value for the uplink transmission signal of the femto MS 2b having this transmission power to achieve wireless communication with the femto BS 1b connected to the femto MS 2b.

Further, the transmission power values Pu1 and Pu3 are obtained by the above equations (6) and (7) in principle, respectively, and then these values are set to be smaller than the transmission power value Pu2.

Also in this case, the output control unit 20 sets, based on the determination result of the determination unit 24, the first upper limit value to either the transmission power value Pu1 or the transmission power value Pu3 greater than the value Pu1, and thus higher priority is given to the communication by the FBS#2 than to the communication by the macro BS 1a.

As described above, the upper limit setting unit 20b sets the upper limit value of the transmission power of the uplink transmission signal of the femto MS 2b (own MS 2), for each resource block, based on the uplink allocation information, the determination result, and the path-loss value.

Referring back to FIG. 13, after setting of the upper limit values of the transmission power of the uplink transmission signal, the control unit 20c of the output control unit 20 causes the modulation unit 19 to adjust the transmission power of the uplink transmission signal, for each resource block, within the range of the set upper limit value (step S18), and then ends the process.

Specifically, the output control unit 20 generates control information for controlling the transmission power of the uplink transmission signal, which information includes the set upper limit values and the like, and provides the control information to the modulation unit 19. The modulation unit 19 stores the control information in the downlink transmission signal to provide the same to the own femto MS 2b. Thus, the femto MS 2b is caused to adjust the transmission power of the uplink transmission signal for each resource block, based on the control information.

According to the femto BS 1b of the present embodiment configured as described above, the output control unit 20 controls the transmission powers of the femto BS 1b and the femto MS 2b connected thereto, for each resource block, so as not to interfere with another MS 2 and another BS 1, based on the allocation information indicating the allocation status for each resource block of the radio resource allocated to the another MS 2. Therefore, the output control unit 20 can perform control to suppress interference individually for only the transmission power of desired resource blocks. That is, by individually controlling only the transmission power of the desired resource blocks, the output control unit 20 can perform interference control to individually suppress interference to another MS 2 and/or another BS 1. As a result, more effective interference suppression is achieved according to various situations.

Further, in the femto BS 1b of the present embodiment, the output control unit 20 specifies, based on the above-mentioned allocation information, resource blocks that are allocated to the another MS 2 and therefore might cause interference between the another BS 1 and the another MS 2, and sets the first upper limit value to the transmission power of the specified allocated resource blocks so as to control the transmission power in a range in which the allocated resource blocks do not cause interference.

Furthermore, in the present embodiment, the output control unit 20 is configured to set the second upper limit value larger than the first upper limit value, to the transmission power of the unallocated resource blocks other than the specified allocated resource blocks. Therefore, the transmission power of the femto BS 1b or the femto MS 2b connected thereto in the allocated resource blocks is adjusted within the range of the first upper limit value smaller than the second upper limit value, and is set to be relatively smaller than the transmission power of the unallocated resource blocks. As a result, as for the unallocated resource blocks that are less likely to cause interference, a relatively high transmission power is maintained to maintain its communication quality. On the other hand, as for the allocated resource blocks, the transmission power value thereof is reduced to suppress interference.

Furthermore, according to the femto BS 1b of the present embodiment configured as described above, the output control unit 20 performs control based on the path-loss value that is obtained by the path-loss value obtaining unit 17 and allows estimation of the amount of interference. Therefore, the output control unit 20 can appropriately adjusts the uplink transmission signal of the MS 2 connected to the femto BS 1b and the downlink transmission signal of the femto BS 1b, within a range of the maximum transmission powers in which the uplink transmission signal and the downlink transmission signal do not interfere with another BS 1 and another MS 2. That is, the output control unit 20 can perform interference control for suppressing interference to the another BS 1 and the another MS 2, by subjecting the downlink transmission signal to power control based on the path-loss value. As a result, effective interference suppression is achieved without unnecessarily reducing the transmission power.

Furthermore, in the femto BS 1b of the present embodiment, when controlling the transmission powers of the uplink transmission signal of the femto MS 2b connected to the femto BS 1b and the downlink transmission signal of the femto BS 1b, the upper limit values thereof are set to the maximum transmission powers with which the uplink transmission signal and the downlink transmission signal do not interfere with another BS 1 and another MS 2. Therefore, more effective interference suppression is achieved.

### 1.2 Second Embodiment

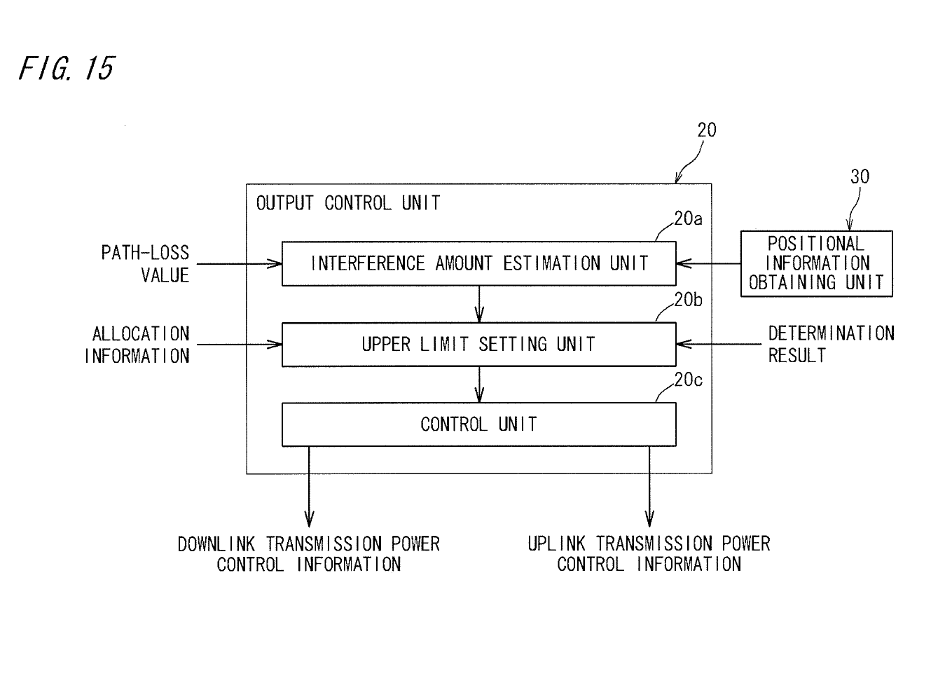

FIG. 15 is a block diagram showing the configuration of an output control unit 20 of a femto BS 1b according to a second embodiment of the present invention. The second embodiment is different from the first embodiment in that the signal processing unit 5 is provided with a positional information obtaining unit 30 for obtaining positional information of BSs 1 and MSs 2. Other components are identical to those of the first embodiment.

The femto MS 2b of the present embodiment estimates an amount of interference that an MS 2 connected to the femto BS 1b may cause in another BS 1, by using the path-loss value provided from the path-loss value obtaining unit 17, and the positional information of BSs 1 and MSs 2 obtained by the positional information obtaining unit 30.

The positional information obtaining unit 30 obtains, from an upper layer, positional information of the position where the femto BS 1b is located, positional information of a femto MS 2b connected to the femto BS 1b, positional information of another BS 1, and positional information of another MS 2, and outputs the respective pieces of positional information thus obtained to the interference amount estimation unit 20a of the output control unit 20.

The following will describe a process of, when the another BS 1 is a macro BS 1a (the case of FIG. 9), suppressing interference that the femto MS 2b causes in the macro BS 1a as the another MS 2.

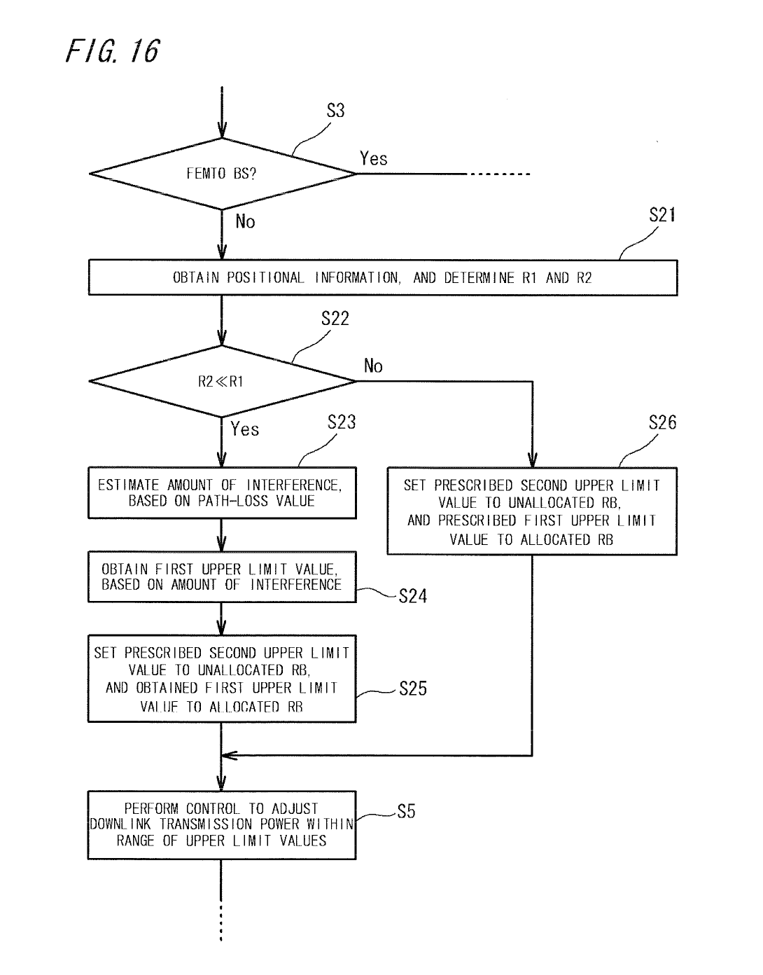

FIG. 16 is a flowchart showing the process steps to be performed by the output control unit 20 of the present embodiment after it is determined that the another BS 1 is a macro BS 1a in step S3 in the flowchart shown in FIG. 8. In the present embodiment, the process steps other than the process steps shown in FIG. 16 are identical to those of the first embodiment.

In FIG. 16, when it is determined in step S3 that the another BS 1 is not a femto BS 1b (the another BS 1 is a macro BS 1a), the interference amount estimation unit 20a of the output control unit 20 obtains the positional information of the femto BS 1b (own BS 1), the positional information of the macro BS 1a, and the positional information of the macro MS 2a (another MS 2), from the positional information provided from the positional information obtaining unit 30. Then, the interference amount estimation unit 20a obtains a distance R1 between the femto BS 1b and the macro MS 2a, and a distance R2 between the macro BS 1a and the macro MS 2a (step S21).

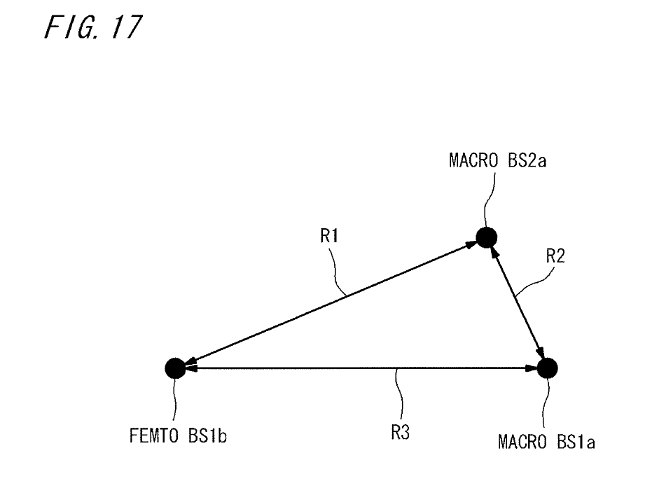

FIG. 17 is a diagram for explaining the positional relationships among the femto BS 1b, the macro MS 2a, and the macro BS 1a.

As shown in FIG. 17, when the distance R2 between the macro BS 1a and the macro MS 2a is sufficiently shorter than the distance R1 between the femto BS 1b and the macro MS 2a, the macro BS 1a and the macro MS 2a are regarded to exist in approximately the same position as viewed from the femto BS 1b, and thus the distance R1 is regarded to be approximately equal to the distance R3 between the femto BS 1b and the macro BS 1a. As a result, it is possible to estimate an amount of interference by using the path-loss value between the femto BS 1b and the macro BS 1a, which is obtained by the path-loss value obtaining unit 17.

Referring back to FIG. 16, the interference amount estimation unit 20 determines whether the distance R2 is sufficiently short relative to the distance R1 (step S22). Upon determining that the distance R2 is sufficiently short relative to the distance R1, the interference amount estimation unit 20a estimates an amount of interference that the downlink signal from the femto BS 1b causes in the macro MS 2a, based on the path-loss value of the downlink signal from the macro BS 1a to the femto BS 1b, which is provided from the path-loss value obtaining unit 17 (step S23).

Based on the amount of interference obtained in step S23, the upper limit setting unit 20b obtains a first upper limit value to be set to the transmission power in the allocated resource blocks (step S24).

A transmission power value Pd4 obtained as the first upper limit value is expressed by the following equation (8). Note that in the equation (8) the unit of each value is “dBm”.

transmission power value Pd4=allowable interference value+L

Accordingly, the transmission power value Pd4 is set to a value that is by an offset value Po smaller than the transmission power value Pd3 obtained as the first upper limit value in step S7 in FIG. 8.

Then, the upper limit setting unit 20b sets the first upper limit value obtained based on the amount of interference, to the transmission power of the allocated resource blocks, and sets the prescribed second upper limit value (transmission power value Pd2) to the transmission power of the unallocated resource blocks (step S25).

On the other hand, when determining in step S22 that the distance R2 is not sufficiently short relative to the distance R1, the upper limit setting unit 20b of the output control unit 20 sets the prescribed first upper limit value (transmission power value Pd1) which has been stored in advance, to the transmission power of the resource blocks allocated to the macro MS 2a (another MS 2), and sets the prescribed second upper limit value (transmission power value Pd2) which has been stored in advance, to the transmission power of the resource blocks not allocated to the macro MS 2a (step S26).

After the setting of the upper limit values in step S25 or S26, the process goes to step S5. Step S5 is identical to that described for the first embodiment.

As described above, according to the femto BS 1b of the present embodiment, since an amount of interference that the MS 2 connected to the femto BS 1b (own BS 1) may cause in the another BS 1 is estimated based on the path-loss value provided from the path-loss value obtaining unit 17, and the positional information obtained by the positional information obtaining unit 30, it is possible to appropriately estimate the amount of interference in accordance with the situation determined by the positional relationships among the femto BS 1b, the macro BS 1a, and the macro MS 2a.

### 1.3 Third Embodiment

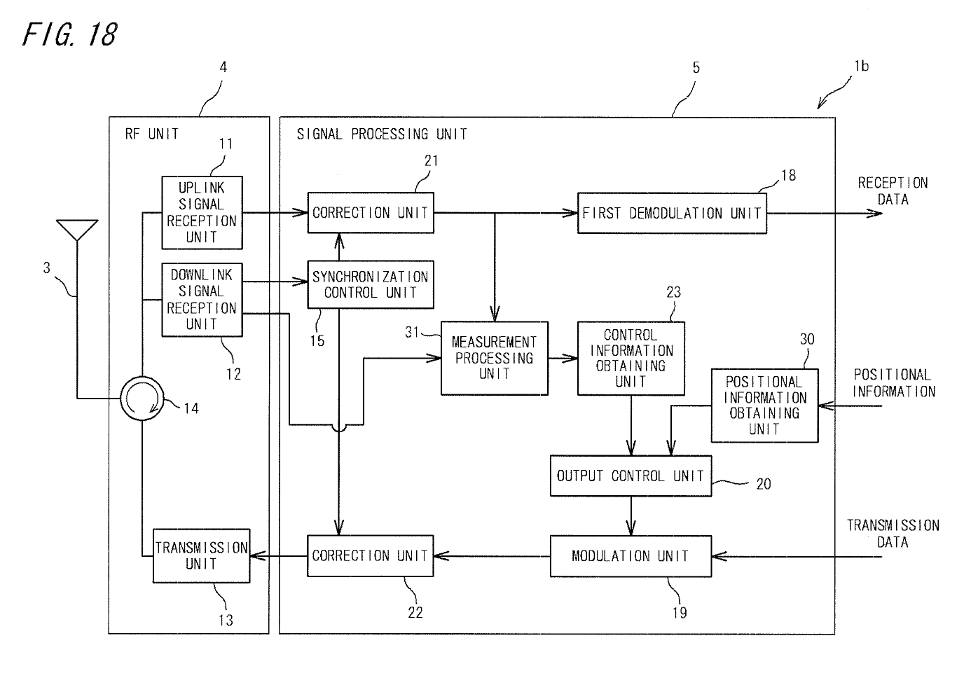

FIG. 18 is a block diagram of a femto BS 1b according to a third embodiment of the present invention.

The third embodiment is different from the first embodiment in that a measurement processing unit 31 is provided instead of the second demodulation unit 16 and the path-loss value obtaining unit 17, and a positional information obtaining unit 30 is provided.

As described for the second embodiment, the positional information obtaining unit 30 obtains, from an upper layer, positional information of the position where the femto BS 1b (own BS 1) is located, positional information of a femto MS 2b connected to the femto BS 1b, positional information of another BS 1, and positional information of another MS 2, and outputs the respective pieces of positional information thus obtained to the interference amount estimation unit 20a in the output control unit 20.

In the femto BS 1b of the present embodiment, allocation information relating to a radio resource allocated to the another MS 2 is obtained by a measurement process performed by the measurement processing unit 31.

Further, the upper limit values to be set to the transmission powers of allocated resource blocks and unallocated resource blocks are determined based on positional information of BSs 1 and MSs 2 obtained by the positional information obtaining unit 30.

Hereinafter, the function of the measurement processing unit 31 will be described.

The measurement processing unit 31 has a function of performing measurement (measurement process) of the transmission conditions, such as transmission powers and operating frequencies, of a downlink signal from another BS 1 and an uplink signal from another MS 2.

Specifically, the measurement processing unit 31 obtains a downlink reception signal from another BS 1 received by the downlink signal reception unit 12, and an uplink reception signal from another MS 2 received by the uplink signal reception unit 11, and determines the reception powers of these reception signals for each resource block.

In order to obtain the downlink signal from the another BS 1, which is required for the measurement process, the measurement processing unit 31 suspends transmission by the transmission unit 13.

Alternatively, the measurement processing unit 31 may cause the femto MS 2b connected to the femto BS 1b to suspend transmission of its uplink signal, in order to obtain the uplink reception signal from the another MS 2, which is required for the measurement process. This is because the uplink signal reception unit 11 receive both the uplink signal from the femto MS 2b and the uplink signal from the another MS 2.

Note that it is preferable that the measurement process is performed immediately after the synchronization process, as described later.

After obtaining the downlink reception signal from the downlink signal reception unit 12, the measurement processing unit 31 obtains an average value of the reception power (average power value) for each resource block.

The measurement processing unit 31 extracts, from the obtained downlink reception signal, portions assumed to correspond to resource block units, separately from each other in the time axis direction. Further, from each of the extracted portions, the measurement processing unit 31 extracts a portion corresponding to the frequency width of each resource block, and obtains the power of the portion of each frequency width as an average power value of the corresponding resource block.

After obtaining the average power value of each resource block, the measurement processing unit 31 outputs the average power values, as measurement result information, to the control information obtaining unit 23.

The measurement processing unit 31 obtains, from the downlink signal reception unit 12, the downlink signal before demodulation, and obtains the average power value for each resource block from this signal. Therefore, the measurement processing unit 31 extracts, from this signal, the portions assumed to correspond to the resource block units, separately from each other in the time axis direction. For this purpose, the measurement processing unit 31 needs to recognize the frame timing of the another BS 1 that is the transmission source of the downlink reception signal.

Here, if frame-timing synchronization has been achieved between the another BS 1 and the femto BS 1b, the measurement processing unit 31 can grasp the frame timing of the another BS 1 from the frame timing of the femto BS 1b, and thereby, the measurement processing unit 31 can accurately estimate the units of resource blocks in the time axis direction and can accurately obtain the average power values. For this reason, it is preferable that the measurement process is performed immediately after the synchronization process.

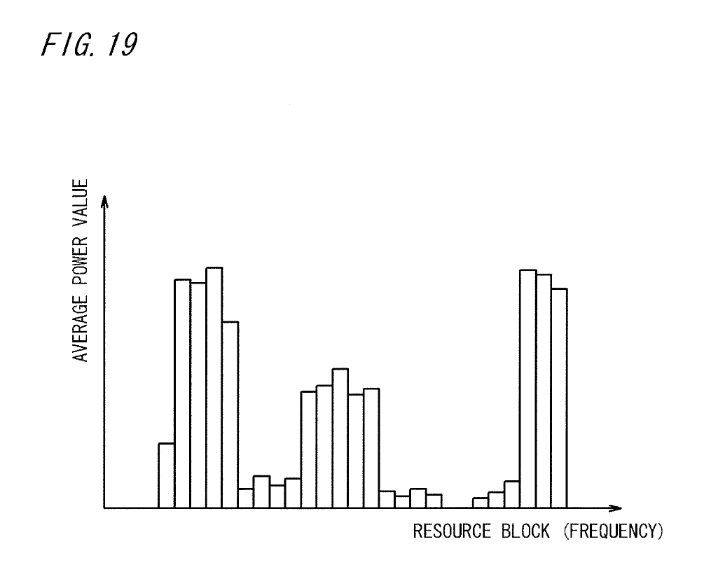

FIG. 19 is a diagram showing an example of average power values of the respective resource blocks, which are obtained by the measurement processing unit 31. In FIG. 19, the horizontal axis indicates the resource blocks arranged in the frequency direction, and the vertical axis indicates the average power values.

As shown in FIG. 19, some resource blocks have relatively high average power values while other resource blocks have relatively low average power values. It is understood that user data is stored in the resource blocks having the relatively high average power values, and these resource blocks are allocated as a radio resource to the another MS 2.

On the other hand, it is understood that no user data is allocated to the resource blocks having the relatively low average power values, and these resource blocks are not allocated to the another MS 2.

As described above, it is possible to grasp, for each resource block, the allocation status of the radio resource that the another BS 1 allocates to the another MS 2, based on the measurement result information obtained in the measurement process.

The measurement processing unit 31 performs, on the uplink reception signal, the measurement process in the same manner as described for the downlink reception signal, and outputs the measurement result information to the control information obtaining unit 23.

Based on the measurement result information, the control information obtaining unit 23 generates downlink allocation information and uplink allocation information as information indicating the allocation status of the radio resource that the another BS 1 allocates to the another MS 2, and outputs these pieces of information to the output control unit 20.

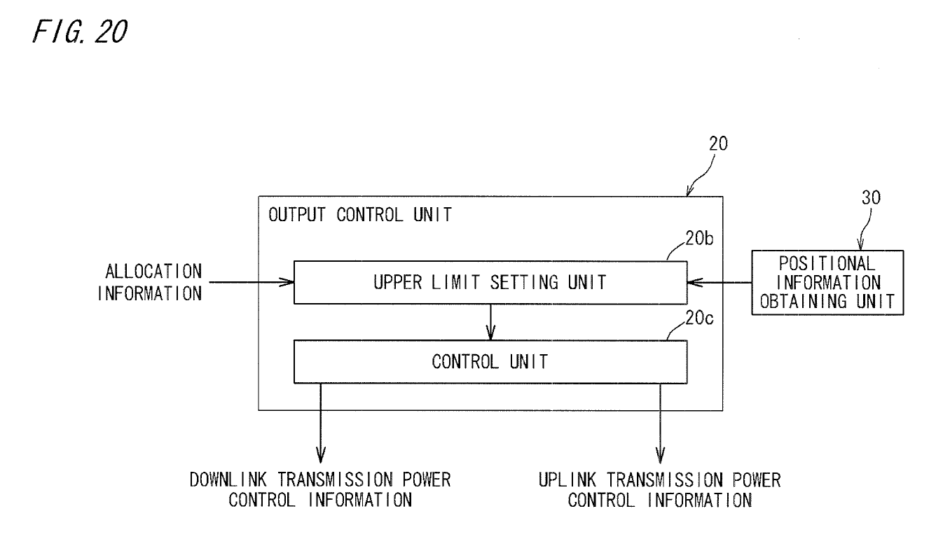

FIG. 20 is a block diagram showing the configuration of the output control unit 20 according to the present embodiment. In FIG. 20, the upper limit setting unit 20b obtains the downlink allocation information and the uplink allocation information from the control information obtaining unit 23, and specifies, with reference to these pieces of information, resource blocks allocated to the another MS 2 in the downlink and the uplink, and unallocated resource blocks.

Further, the upper limit setting unit 20b obtains positional information of the another BS 1 and the another MS 2 that are estimated as the transmission sources of the downlink reception signal and the uplink reception signal received in the measurement process, from the positional information of BSs 1 and MSs 1 provided from the positional information obtaining unit 30.

The upper limit setting unit 20b also obtains the positional information of the femto BS 1b (own BS 1) and the positional information of the femto MS 2b (own MS 2) connected to the femto BS 1b.

Then, the upper limit setting unit 20b obtains a distance between the femto BS 1b and the another MS 2, and a distance between the femto MS 2b and the another BS 1.

If the distance between the femto BS 1b and the another MS 2 and the distance between the femto MS 2b and the another BS 1 are sufficiently long, the possibility of interference between the respective devices is low. However, if the distances are relatively short, the possibility of interference is high.

Therefore, the upper limit setting unit 20b of the present embodiment is configured to set the first upper limit value to be set to the transmission power of the allocated resource blocks, for each of the above-mentioned cases, in accordance with the distance between the femto BS 1b and the another MS 2 and the distance between the femto MS 2b and the another BS 1. More specifically, the shorter the distance is, the smaller the first upper limit value is set.

The upper limit setting unit 20b has, stored therein, a table in which the distance between the femto BS 1b and the another MS 2 and the distance between the femto MS 2b and the another BS 1 are associated with the first upper limit values appropriately set based on the respective distances. With reference to this table, the upper limit setting unit 20b determines and sets the first upper limit values, based on the distances obtained from the respective pieces of positional information. Note that the prescribed second upper limit value is set to the transmission power of the unallocated resource blocks.

Since the present embodiment is not provided with the determination unit of the first embodiment for determining whether the another BS 1 is a macro BS 1a or a femto BS 1b, the same first upper limit value is set regardless of the type of the another BS 1.

Based on the upper limit values set as described above, the control unit 20c of the output control unit 20 controls the transmission powers of the femto BS 1b (own BS 1) and the femto MS 2b.

According to the femto BS 1b of the present embodiment, the first upper limit value is set to be small if the possibility of interference is high because the distance between the femto BS 1b and the another MS 2 and the distance between the femto MS 2b and the another BS 1 are short. Therefore, more effective interference suppression is achieved.

In the present embodiment, the upper limit setting unit 20b obtains positional information of the another BS 1 and the another MS 2 that are estimated as the transmission sources of the downlink reception signal and the uplink reception signal received in the measurement process, from the positional information of BSs 1 and MSs 2 provided from the positional information obtaining unit 30. However, if the upper limit setting unit 20b cannot specify the positional information of the another BS 1 and the another MS 2 estimated as the transmission sources, the upper limit setting unit 20b may set the prescribed first upper limit value.

### 1.4 Modifications and the Like

The present invention is not limited to the above-described embodiments.

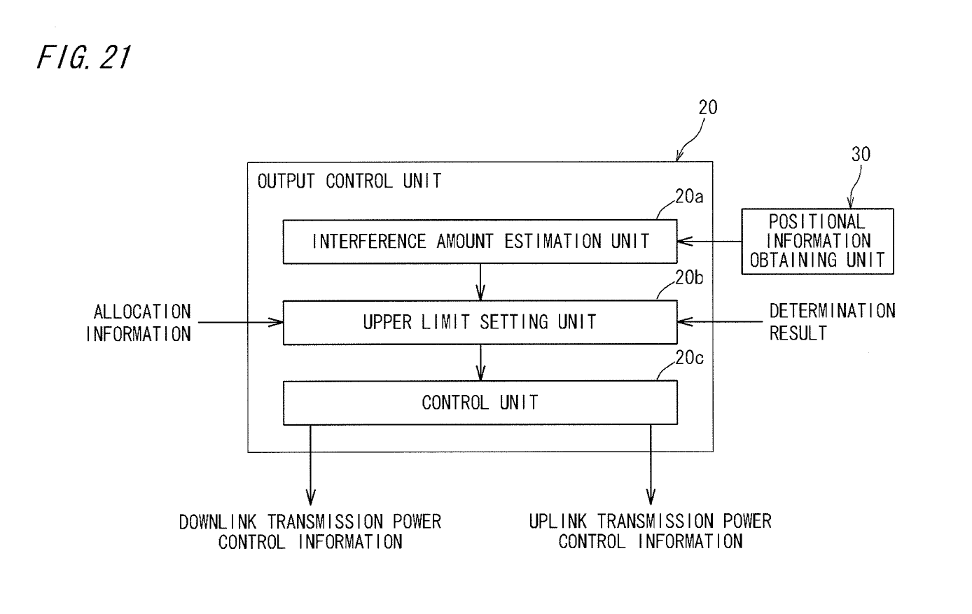

In the first and second embodiments, the amount of interference is estimated based on the path-loss value from another BS 1 to the femto BS 1b (own BS 1). However, for example, as shown in FIG. 21, interference amount estimation unit 20a may be configured to obtain the positional information of BSs 1 and MSs 2 from only the positional information obtaining unit 30, and estimate the amount of interference from only the positional information.

In this case, since, as described above, the possibility of occurrence of interference is increased if the distance between the interfering device and the interfered device is relatively short, it is possible to estimate an amount of interference that the femto BS 1b (own BS 1) and the femto MS 2b (own MS 2) cause in the another MS 2 and the another BS 1, based on the positional information, by grasping, in advance, the relationships among the distance between the interfering device and the interfered device, the transmission power, and the amount of interference.

The femto BS 1b according to the above-described embodiments is provided with the downlink signal reception unit 12 for receiving a downlink signal from another BS 1. However, for example, the femto BS 1b may have the configuration of an MS 2b shown in FIG. 7 so that the femto BS 1b can function as an MS 2 while having the function as a BS 1. In this case, the femto BS 1b (own BS 1) communicates with the femto MS 2b connected thereto, and simultaneously, causes the part functioning as an MS 2 to function as another MS 2 and communicate with another BS 1. As a result, it is possible to obtain the allocation information and the like between the another BS 1 and the another MS 2 more easily.

Further, in the above-described embodiments, the femto BS 1b is configured to suppress interference that its downlink signal causes in another MS 2, and interference that an uplink signal from an MS 2 connected to the femto BS 1b causes in another BS 1. However, the femto BS 1b may be configured to suppress only either of interference that its downlink signal causes in another MS 2, and interference that an uplink signal from an MS 2 connected to the femto BS 1b causes in another BS 1.

The positional information obtaining unit 30 according to the second and third embodiments is configured to obtain the positional information of BSs 1 and MSs 2 from the upper layer. However, each of BSs 1 and MSs 2 may be provided with a GPS, and store its positional information in its transmission signal. Then, the BS 1 of the present invention can obtain the positional information of each BS 1 (MS 1) by receiving the transmission signal.

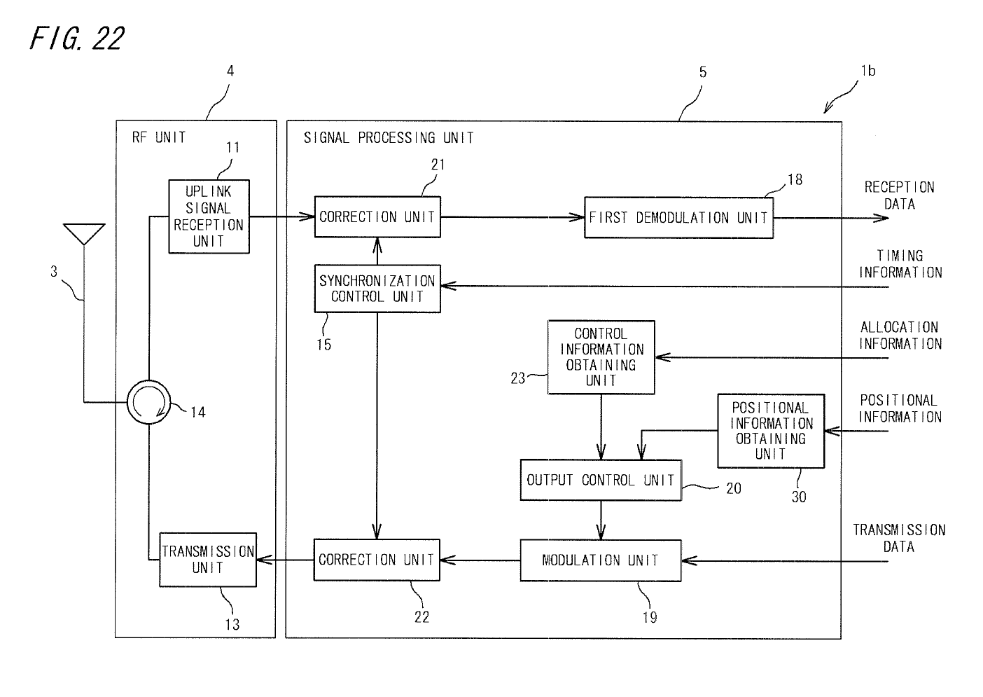

In the above-described embodiments, the downlink signal reception unit 12 obtains the frame timing of another BS 1, which is required for the synchronization process, and the allocation information relating to a radio resource allocated to another MS 2, which is required for output control. However, as shown in FIG. 22, the femto BS 1b may be configured to obtain the frame timing information of another BS 1, the allocation information, and the like, via wired LAN or the like. In this case, the downlink signal reception unit 12 for receiving a downlink signal from another BS 1 is not needed, resulting in a simplified configuration.

In the above-described embodiments, the femto BS 1b is configured to suppress interference that its downlink signal causes in another MS 2, and interference that an uplink signal from an MS 2 connected to the femto BS 1b causes in another BS 1. However, the femto BS 1b may be configured to suppress only one of interference that its downlink signal causes in another MS 2, and interference that an uplink signal from an MS 2 connected to the femto BS 1b causes in another BS 1.

In the above-described embodiments, the present invention is applied to a femto BS. However, the present invention is also applicable to, for example, a BS that forms a micro cell or a pico cell that is a communication area narrower than a macro cell.

Further, in the above-described embodiments, the relationship of the femto BS of the present invention with a macro BS is described. However, the same function and effect as described above can be achieved also when a BS that forms a micro cell or the like that is a communication area broader than a femto cell is used instead of the macro BS.

In the above-described second embodiment, the output control unit 20 determines in step S22 in FIG. 16 whether the distance R32 is sufficiently short relative to the distance R31. However, the output control unit 20 may be configured to determine whether the distance R32 is shorter than a threshold that has been set in advance. In this case, the threshold is set to a value that allows determination that the distance R32 is sufficiently short such that the path-loss value between the femto BS 1b and the macro BS 1a can be regarded as the path-loss value between the macro BS 1a and the macro MS 2a.

The positional information obtaining unit 30 of the second embodiment is configured to obtain the positional information of BSs 1 and MSs 2 from the upper layer. However, each of BSs 1 and MSs 2 may be provided with a GPS, and store its positional information in its transmission signal. Then, the BS 1 of the present invention can obtain the positional information of each BS 1 or MS 1 by receiving the transmission signal.

[Chapter 2: Interference Suppression Control Based on Interfered Power Estimated Based on CQI Information]

In a base station device described in Chapter 2, the techniques for the base station device described in Chapter 1 are employed within the consistent scope. In Chapter 2, for those points that are not particularly described, the matters described in Chapter 1 are incorporated.

### 2.1 First Embodiment

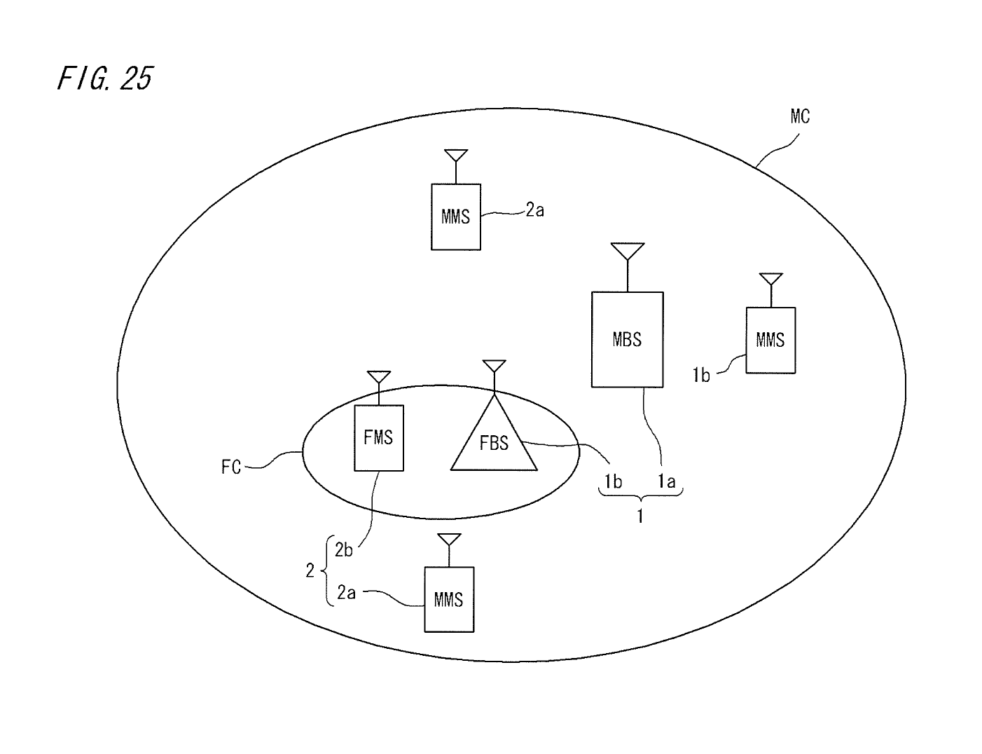

FIG. 25 is a schematic diagram showing the configuration of a wireless communication system including a base station device according to a first embodiment in Chapter 2.

Although the configuration of the communication system and the frame structure for LTE according to the present embodiment are identical to those described in Chapter 1, a supplemental description for the frame structure will be given hereinafter.

Allocation of user data stored in a PDSCH in a DL frame is notified to a terminal device by downlink allocation information relating to downlink radio resource allocation, which is stored in a PDCCH allocated to the beginning of each subframe. The downlink allocation information is information indicating radio resource allocation for each PDSCH, and the downlink allocation information allows the terminal device to determine whether data directed to the terminal device is stored in the subframe.

A physical uplink control channel (PUCCH) is allocated to each of both ends of each subframe in a UL frame, in the frequency axis direction. The PUCCH is used for transmission of: information relating to an ACK and a NACK in response to an HARQ relating to reception data of a PDSCH; downlink CQI information for notifying a base station device of a CQI indicating the reception quality when a terminal device receives a downlink transmission signal; and the like. Allocation of the PUCCH is notified to the terminal device by a PBCH in the DL frame.

Further, a sounding reference signal (SRS) is allocated to the last symbol of each subframe. The SRS is a reference signal to be transmitted by using known transmission power and phase, and is used by a base station device that has received this signal to measure an uplink CQI of an uplink signal for each frequency of each terminal device.

[2.1.1 Configuration of Base Station Device]

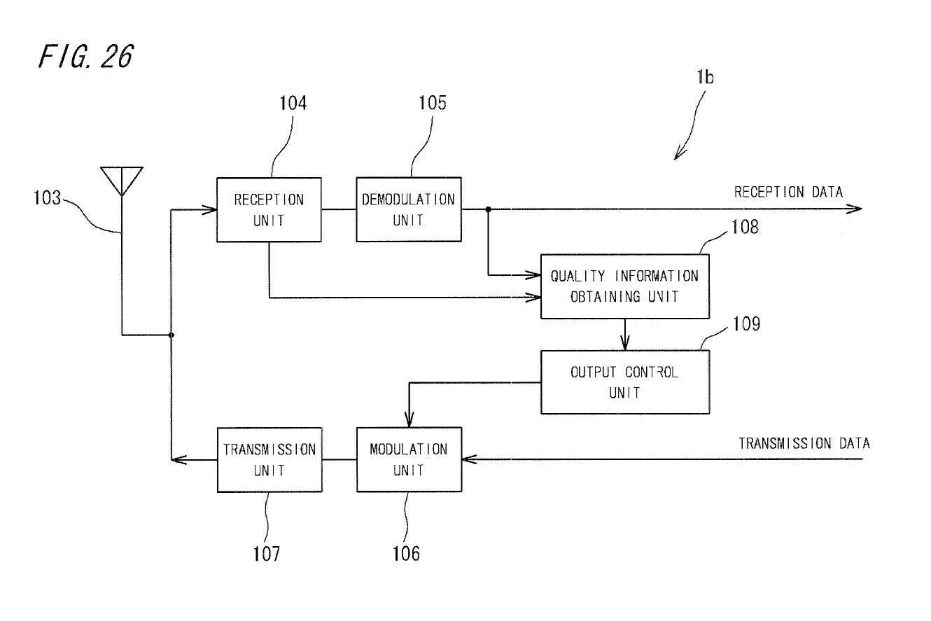

FIG. 26 is a block diagram showing the major configuration of a femto BS 1b according to the present embodiment. Although the configuration of the femto BS 1b will be described hereinafter, the configuration of a macro BS 1a is substantially the same as the femto BS 1b.

The femto BS 1b includes: an antenna 3; a reception unit 104 connected to the antenna 3; a demodulation unit 105 that demodulates an uplink reception signal provided from the reception unit 104 into uplink reception data, and outputs the data to an upper layer; a modulation unit 106 that modulates various kinds of transmission data provided from the upper layer, and outputs a downlink transmission signal; a transmission unit 107 that transmits, via the antenna 103, the downlink transmission signal outputted from the modulation unit 106; a quality information obtaining unit 108 that obtains information relating to uplink and downlink CQIs; and an output control unit 109 that controls the transmission power of the downlink transmission signal.

The reception unit 104 includes a filter that allows only the frequency band of the uplink signal to pass therethrough, an amplifier, an A/D converter, and the like. The reception unit 104 obtains an uplink signal from an MS 2, from the reception signal received by the antenna 103, amplifies the uplink signal, converts the amplified signal into a digital signal, and outputs the digital signal as an uplink reception signal to the demodulation unit 105.

The transmission unit 107 includes a D/A converter, a filter, an amplifier, and the like. The transmission unit 107 receives the downlink transmission signal outputted from the modulation unit 106 as a digital signal, convert the digital signal into an analog signal, amplifies the analog signal, and transmits as a downlink signal via the antenna 103.

The modulation unit 106 subjects the transmission data provided from the upper layer to a predetermined modulation scheme, for each predetermined data unit, based on an instruction of a scheduler or the like (not shown), and allocates the modulated data to a DL frame for each resource block unit, thereby generating a downlink transmission signal of the femto BS 1b (own downlink transmission signal).

Further, when generating the own downlink transmission signal, the modulation unit 106 stores, in a PDCCH of the own downlink transmission signal, uplink transmission power control information that causes a femto MS 2b connected to the femto BS 1b to adjust the transmission power of its uplink transmission signal, and transmits the own downlink transmission signal to the femto MS 2b, thereby adjusting the transmission power of the femto MS 2b.

Moreover, the modulation unit 106 sets, for each resource block, the transmission power of the own downlink transmission signal and the transmission power of the uplink transmission signal of the femto MS 2b connected to the femto BS 1b, and adjusts, for each resource block, the transmission power of the downlink transmission signal, based on downlink transmission power control information outputted from the output control unit 109.

Similarly, the uplink transmission power control information transmitted to the femto MS 2b causes the femto MS 2b to adjust the transmission power of the uplink transmission signal for each resource block.

The quality information obtaining unit 108 obtains downlink CQI information as downlink signal reception quality information, which is included in the uplink reception data demodulated by the demodulation unit 105. Further, the quality information obtaining unit 108 receives, from the reception unit 104, the SRS separated from the uplink reception signal, and measures, based on the SRS, the reception quality of the received uplink signal as a CINR (Carrier to Interference plus Noise Ratio), and obtains a result of the measurement as uplink CQI information that is uplink signal reception quality information.

Furthermore, the quality information obtaining unit 108 obtains, based on the SRS, a path-loss value L between the femto BS 1b and the femto MS 2b. The path-loss value L is expressed by the following equation (101). In the equation, the unit of the path-loss value L is “dB”, and the unit of parameters indicating other powers is “dBm”. Hereinafter, the unit of parameters indicating powers is “dBm” in the specification.

path-loss value L=Pu_{ref}−Pr (101)

In equation (101), Pu_{ref} is the power of the SRS at transmission, and Pr is the power of the SRS at reception. Since the power Pu_{ref} of the SRS at transmission has been known as described above, the quality information obtaining unit 108 can obtain a path-loss value L between the femto BS 1b and the femto MS 2b by obtaining the power Pr at which the femto BS 1b receives the SRS.

The quality information obtaining unit 108 outputs, to the output control unit 109, information relating to the reception qualities of the uplink and downlink signals, such as the downlink CQI information, the uplink CQI information, and the path-loss value L.

The output control unit 109 generates, based on the downlink CQI information, the uplink CQI information, and the path-loss value L which are provided from the quality information obtaining unit 108, transmission power control information for adjusting the transmission power of the own downlink transmission signal and the transmission power of the uplink transmission signal of the femto MS 2b that is an MS 2 (hereinafter, also referred to as own MS 2) connected to the femto BS 1b, and outputs the transmission power control information to the modulation unit 106.

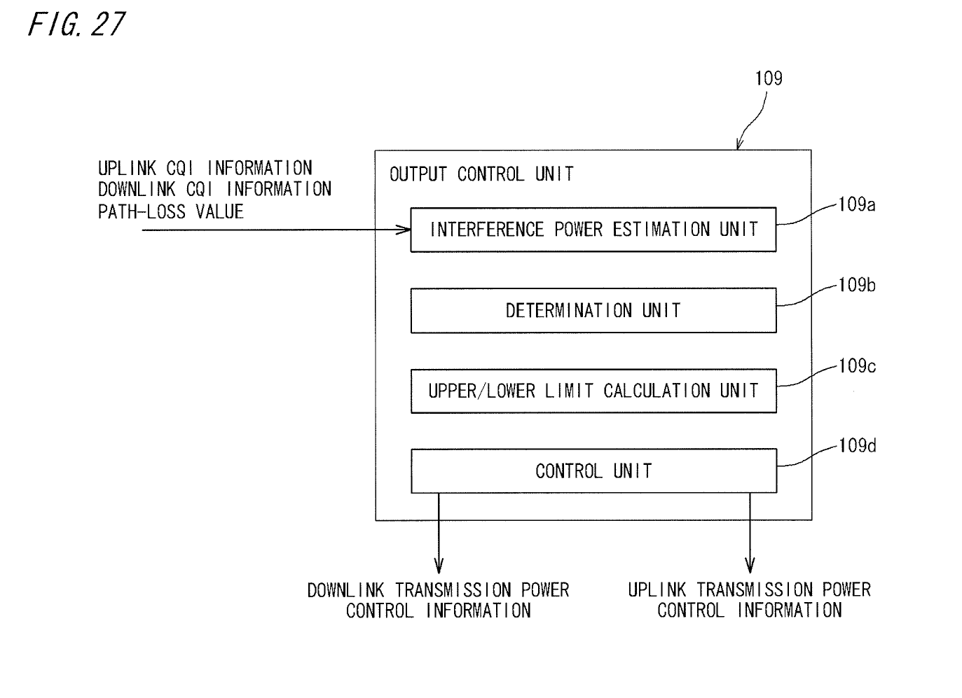

FIG. 27 is a block diagram showing the configuration of the output control unit 109. In FIG. 27, the output control unit 109 includes: an interference amount estimation unit 109a that estimates, based on the information relating to the reception qualities, which is provided from the quality information obtaining unit 108, a downlink interference power of the downlink signal received by the own MS 2, and an uplink interference power of the uplink signal received by the femto BS 1b; a determination unit 109b that determines whether the both interference powers are caused by interference of the transmission signal of another BS 1 or an MS 2 (hereinafter, also referred to as another MS 2) connected to the another BS 1; an upper/lower limit calculation unit 109c that sets, based on the determination result of the determination unit 109b and the both interference powers, upper limit values and/or lower limit values of the transmission powers of the own downlink transmission signal and the uplink transmission signal of the own MS 2; and a control unit 109d that causes the modulation unit 106 to perform a process relating to adjustment of the transmission powers of the both transmission signals, within the ranges of the powers determined by the set upper and lower limit values.

The control unit 109d generates uplink transmission power control information and downlink transmission power control information for causing the modulation unit 106 to control the transmission powers, and outputs these pieces of information to the modulation unit 106, thereby causing the modulation unit 106 to control the transmission powers.

[2.1.2 Configuration of Terminal Device]

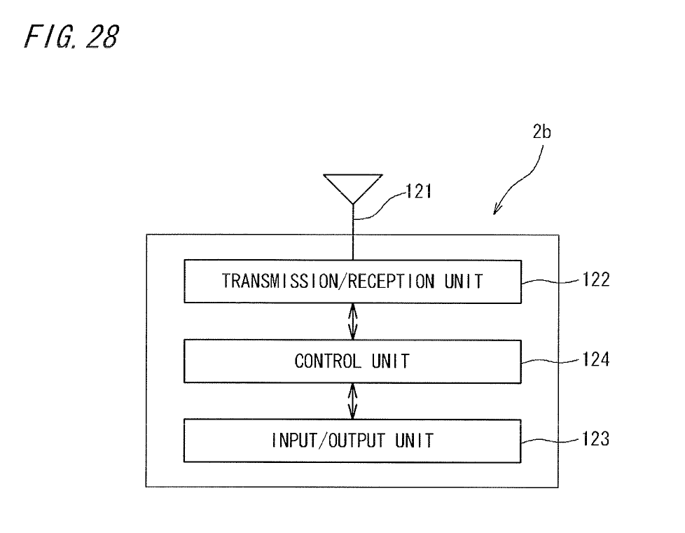

FIG. 28 is a block diagram showing the configuration of an MS 2. Note that a macro MS 2a and a femto MS 2b have the same configuration, except that the connection destinations thereof are a macro BS 1a and a femto BS 1b, respectively.

The MS 2 includes: an antenna 121; a transmission/reception unit 122 to which the antenna 121 is connected and which performs reception of a downlink signal from a BS 1 and transmission of an uplink signal to be transmitted; an input/output unit 123 that is implemented by a keyboard, a monitor, and the like, and performs input/output of reception/transmission data; and a control unit 124 that controls the transmission/reception unit 122 and the input/output unit 123, and performs processes required for communication with a BS 1, such as modulation, demodulation, and the like.

The control unit 124 receives various kinds of control information included in a downlink signal from a BS 1 connected to the MS 2, and performs communication with the BS 1 in accordance with the control information. The various kinds of control information may include: uplink allocation information indicating a frequency band allocated to the uplink signal of the MS 2; information relating to the transmission power; and information relating to the modulation scheme. These pieces of information are provided from the BS 1. That is, the BS 1 transmits the various kinds of control information to the MS 2 connected thereto to perform control relating to the uplink signal of the MS 2.

Further, upon receiving an instruction to measure a CQI of a downlink signal from the BS 1 to which the MS 2 is connected, the control unit 124 measures a CINR of the received downlink signal, and transmits the result of the measurement as downlink CQI information to the BS 1. The control unit 124 measures a CINR by using a plurality of reference signals as known signals that are arranged (dotted) in predetermined positions, among a plurality of symbols constituting a radio frame in the downlink signal transmitted by the BS 1.

Further, the control unit 124 has a function of performing a process relating to an HARQ. That is, the control unit 124 decodes the encoded data received from the BS 1, and subjects the decoded data to error check. When the control unit 124 determines that the decoded data is erroneous data, the control unit 124 transmits a NACK for the corresponding packet. When the control unit 124 determines that the data has been decoded correctly, the control unit 124 transmits an ACK.

Hereinafter, a description will be given of a control process relating to the transmission power of a transmission signal from the femto BS 1b of the present embodiment or a femto MS 2b connected to the femto BS 1b, which is performed by the output control unit 109 of the femto BS 1b.

[2.1.3 Control of the Transmission Power of a Downlink Transmission Signal from the Femto BS 1b]

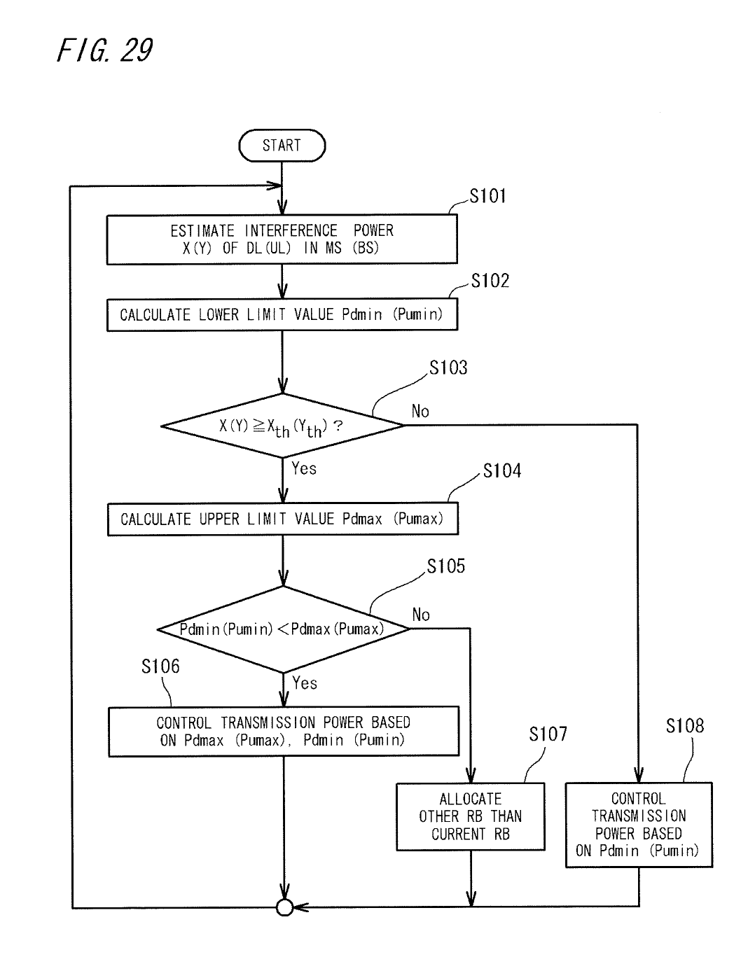

FIG. 29 is a flowchart showing a process of controlling the transmission power of a downlink transmission signal (uplink transmission signal), which is performed by the output control unit 109. A process of controlling the transmission power of an uplink transmission signal of the femto MS 2b connected to the femto BS 1b is substantially identical to the process for the downlink transmission signal of the femto BS 1b. In FIG. 29, the names of parameters, in parentheses, corresponding to the uplink transmission signal are appended to the names of the parameters corresponding to the downlink transmission signal, respectively. The following description will be focused on the control of the transmission power of the downlink transmission signal.

Upon receiving, from the quality information obtaining unit 108, the downlink CQI information from the femto MS 2b and the path-loss value L between the femto BS 1b and the femto MS 2b, the output control unit 109 causes the interference power estimation unit 109a to estimate a downlink interference power in the femto MS 2b (step S101). Specifically, the interference power estimation unit 109a estimates a downlink interference power based on the following equation (102).

downlink interference power X=Pd_{ref}−L−CINR_{d}−N_{d} (102)

In equation (102), “Pd_{ref}” is the power of the above-mentioned reference signal at transmission, which is a known signal included in the downlink signal, “CINR_{d}” is the CINR of the reference signal at reception of the downlink signal in the femto MS 2b, which is obtained from the downlink CQI information, and “N_{d}” is noise that occurs in a physical layer or the like, or unavoidable noise power, which can be calculated in advance by a predetermined method.

That is, when the femto MS 2b receives the downlink transmission signal from the femto BS 1b, if there is no external interference factor in the transmission path between the femto BS 1b and the femto MS 2b, a value obtained by summing the CINR_{d}, the path-loss value L, and the noise power N coincides with the power Pd_{ref} of the reference signal at transmission. However, if the CINR_{d} is lowered due to external interference, the sum becomes smaller than the power Pd_{ref}. A value obtained by subtracting the sum from the power Pd_{ref} is the external interference power, which is calculated as the downlink interference power X as shown in equation (102).

Next, the output control unit 109 causes the upper/lower limit calculation unit 109c to calculate a lower limit value Pdmin of the transmission power of the downlink transmission signal of the femto BS 1b (step S102). The lower limit value Pdmin is expressed by the following equation (103).

lower limit value Pdmin=CINR_{dmin}+X+L+N_{d} (103)

In equation (103), CINR_{dmin} is a minimum CINR required for downlink communication between the femto BS 1b and the femto MS 2b. The upper/lower limit calculation unit 109c adds the CINR_{dmin} in the light of the interference power, the path-loss value, and the noise power, thereby determining, as a lower limit value Pdmin, a minimum transmission power of the downlink transmission signal, which ensures communication with the femto MS 2b.

Next, the output control unit 109 causes the determination unit 109b to determine whether or not the downlink interference power X is equal to or greater than a predetermined threshold Xₜₕ (step S103).

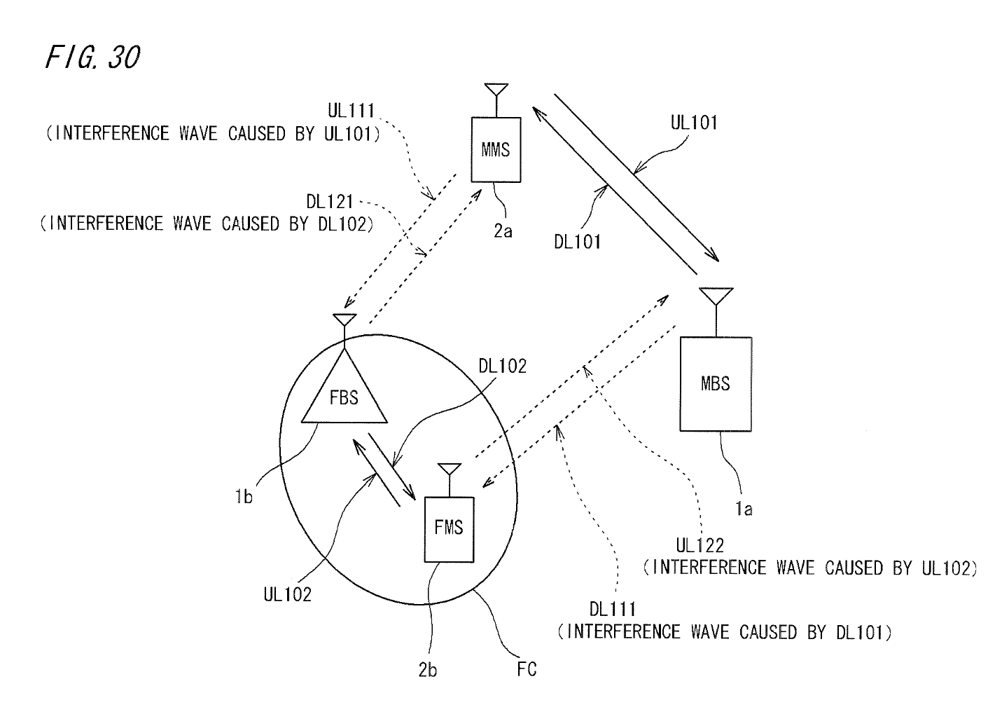

FIG. 30 is a diagram showing interferences in communication between the macro BS 1a and the macro MS 2a, and communication between the femto BS 1b and the femto MS 2b.

In the case of FIG. 30, the femto MS 2b receives a downlink signal DL102 transmitted from the femto BS 1b, and might receive, as an interference wave DL 111, a downlink signal DL101 transmitted to the macro MS 2a from the macro BS 1a as another BS 1.

For example, if the range of the downlink frame resource blocks as the radio resource allocated to the femto MS 2b overlaps the range of the downlink frame resource blocks allocated to the macro MS 2a, the femto MS 2b receives the interference wave DL111 of the downlink signal DL101 transmitted to the macro MS 2a.

When the femto MS 2b receives the downlink signal from the another BS 1 and suffers interference from the downlink signal, this interference causes reduction in the downlink signal reception quality CINR_{d} of the femto MS 2b, and as shown in equation (102), the downlink interference power X in the femto MS 2b increases. Therefore, the femto BS 1b can determine, based on the value of the downlink interference power X, whether the femto MS 2b suffers interference from the downlink signal of the another BS 1. Specifically, when the downlink interference power X is equal to or greater than the threshold Xₜₕ, the femto BS 1b determines that the femto MS 2b suffers interference from the downlink signal of the another BS 1.

In the case where the femto MS 2b suffers interference from the downlink signal of the another BS 1, it can be recognized that there is a macro MS 2a (another MS 2) to which resource blocks are allocated such that the range of the resource blocks overlaps the range of the resource blocks allocated to the femto MS 2b. Further, when the resource blocks in the downlink frame of the femto MS 2b overlap the resource blocks in the downlink frame of the another MS 2, the macro MS 2a might receive the interference wave DL121 of the downlink signal DL102 transmitted to the femto MS 2b from the femto BS 1b, and therefore, it can be recognized that the downlink signal DL102 of the femto BS 1b is likely to interfere with the macro MS 2a.

As described above, the femto BS 1b determines, based on the value of the downlink interference power X, whether the femto MS 2b suffers interference from the downlink signal from the another BS 1, and thereby also determines whether there is another MS 2 to which resource blocks are allocated such that the range of the resource blocks overlaps the range of the resource blocks allocated to the femto MS 2b, and moreover, determines whether the downlink signal DL102 of the femto BS 1b is likely to interfere with another MS 2. In this way, the output control unit 109 has a function as a determination unit that determines whether the downlink signal DL102 of the femto BS 1b is likely to interfere with another MS 2.

The threshold Xₜₕ in step S103 is a threshold value for determining whether the downlink interference power X is caused by interference of a downlink signal from another BS 1 than the femto BS 1b. The threshold Xₜₕ is set at a value which allows determination that the femto MS 2b suffers interference from the downlink signal of the another BS 1, and that the downlink signal DL102 of the femto BS 1b is likely to interfere with another MS 2, if the downlink interference power X exceeds this value.

When determining in step S103 that the downlink interference power X is equal to or greater than the predetermined threshold Xₜₕ, the output control unit 109 causes the upper/lower limit calculation unit 109c to determine an upper limit value Pdmax of the transmission power of the downlink transmission signal of the femto BS 1b, which upper limit value determines a range of the power in which interference to the another MS 2 can be suppressed (step S104).

The upper limit value Pdmax is determined based on the following equation (104).

upper limit value Pdmax=Pd_{const}−X+L (104)

The Pd_{const} is a fixed value, which is obtained by simulation or the like in advance so that the upper limit value Pdmax becomes a value suitable to suppress interference to the another MS 2, relative to the downlink interference power X determined based on the threshold Xₜₕ.

In equation (104), the downlink interference power X is subtracted from each value including the fixed value Pd_{const}. The greater the downlink interference power X, the smaller the upper limit value Pdmax. When the downlink interference power X is great and thereby it is determined that the interference power from the another BS 1 is relatively great, the femto BS 1b and the macro MS 2a are highly likely to interfere with each other because, for example, the macro MS 2a is located close to the femto BS 1b. Therefore, it can be determined that the downlink signal DL 102 of the femto BS 1b is also highly likely to interfere with the macro MS 2a.

Next, the upper/lower limit calculation unit 109c determines whether the lower limit value Pdmin obtained in step S102 is smaller than the upper limit value Pdmax (step S105). Upon determining that the lower limit value Pdmin is smaller than the upper limit value Pdmax, the output control unit 109 goes to step S106. In step S106, the output control unit 109 causes the control unit 109d to control the transmission power of the resource blocks allocated to the femto MS 2b within a range of power from the upper limit value Pdmax to the lower limit value Pdmin (step S106), and then ends the process.

When it is determined that the femto MS 2b suffers interference from the downlink signal DL101 of the macro BS 1a, there is a macro MS 2a (another MS 2) to which resource blocks are allocated so that the range of the resource blocks overlaps the range of resource blocks allocated to the femto MS 2b, as described above. In this case, if the transmission power of the downlink transmission signal of the femto BS 1b is increased without any limitation, the downlink transmission signal is likely to interfere with the macro MS 2a.

Generally, it is preferable that a femto BS is set so as to perform its communication after communication of a macro BS that forms a macro cell MC. This is because the communication performed by the macro BS that forms a macro cell as a broad communication area is highly public.

In this regard, in the femto BS 1b of the present embodiment, when the output control unit 109 determines, based on the downlink interference power X, that the femto MS 2b suffers interference from the downlink signal DL101 of the macro BS 1a and therefore the downlink signal DL102 of the femto BS 1b is likely to interfere with the another MS 2, the output control unit 109 controls the transmission power of the downlink transmission signal of the femto BS 1b within the range from the upper limit value Pdmax at which interference to the another MS 2 can be suppressed, to the lower limit value Pdmin that is the minimum transmission power of the downlink transmission signal at which communication with the femto MS 2b can be ensured. Therefore, the femto BS 1b can control the transmission power of its downlink transmission signal within a range of power in which the downlink transmission signal does not cause interference in the macro MS 2a. Thus, the femto BS 1b can effectively suppress interference to the macro MS 2a, and can ensure communication with the femto MS 2b while giving priority to communication of the macro BS 1a.

On the other hand, when it is determined in step S105 that the lower limit value Pdmin is not smaller than the upper limit value Pdmax, it is difficult to control the transmission power of the downlink transmission signal of the femto BS 1b so as to ensure communication with the femto MS 2b while suppressing interference to the macro MS 2a. So, in this case, the output control unit 109 outputs, to the modulation unit 106, the result of the determination in step S105, and control information indicating the resource blocks allocated to the femto MS 2b, to cause the modulation unit 106 to perform an allocation process of allocating, to the femto MS 2b, resource blocks other than the resource blocks currently allocated to the femto MS 2b (step S107), and then ends the process.

In this way, the output control unit 109 causes the modulation unit 106 to perform the allocation process of allocating resource blocks to the femto MS 2b so as to avoid the situation that the resource blocks to be allocated to the femto MS 2b overlap the resource blocks allocated to at least the macro MS 2a (another MS 2), thereby suppressing interference that the downlink transmission signal of the femto BS 1b causes in the macro MS 2a. As a result, the femto BS 1b can ensure communication with the femto MS 2b without interfering with the macro MS 2a.

When it is determined in step S103 that the downlink interference power X is smaller than the predetermined threshold Xₜₕ, it can be determined that the femto MS 2b does not suffer interference from the downlink signal DL101 of the macro BS 1a. In this case, the output control unit 109 causes the control unit 109d to control the transmission power of the resource blocks allocated to the femto MS 2b, in the downlink transmission signal of the femto BS 1b, based on only the lower limit value Pdmin without setting the upper limit value Pdmax (step S108), and ends the process.

In this case, since it is determined that the femto MS 2b does not suffer interference from the downlink signal DL101 of the macro BS 1a, it can be determined that there is no another MS 2 to which resource blocks are allocated such that the range of the resource blocks overlap the range of the resource blocks allocated to the femto MS 2b, and the downlink signal DL102 of the femto BS 1b is not likely to interfere with the macro MS 2a. Therefore, the femto BS 1b can control the transmission power of the downlink transmission signal within the range of power that the femto BS 1b can adjust, without limiting the transmission power by an upper limit value.

[2.1.4 Control of Transmission Power of an Uplink Transmission Signal of a Femto MS 2b Connected to the Femto BS 1b]

The process of controlling the transmission power of an uplink transmission signal of a femto MS 2b is basically identical to the flowchart shown in FIG. 29.

The output control unit 109 determines an uplink interference power Y, based on the uplink CQI information generated by the quality information obtaining unit 108, and the path-loss value L. The uplink interference power Y is expressed by the following equation (105).

uplink interference power Y=Pu_{ref}L−CINRᵤ−Nᵤ (105)

In equation (105), as described above, “Pu_{ref}” is the power of the SRS at transmission, “CINRᵤ” is the CINR of the SRS at the time when the femto BS 1b receives the uplink signal from the femto MS 2b, which is obtained from the uplink CQI information, and “Nᵤ” is unavoidable noise power.

As shown in FIG. 30, the femto BS 1b receives an uplink signal UL102 transmitted from the femto MS 2b, and might receive, as an interference wave UL111, an uplink signal UL101 transmitted from the macro MS 2a (another MS 2) to the macro BS 1a.

For example, if the range of resource blocks in an uplink frame as a radio resource allocated to the femto MS 2b overlap the range of resource blocks in an uplink frame allocated to the macro MS 2a, the femto BS 1b receives the interference wave UL111 of the uplink signal UL 101 transmitted to the macro BS 1a.

In the case where the femto BS 1b receives the downlink signal from the another MS 2 and suffers interference from the downlink signal, this interference causes reduction in the uplink signal reception quality CINRᵤ of the femto BS 1b, and as shown in equation (105), the uplink interference power Y in the femto BS 1b increases. Therefore, the femto BS 1b can determine, based on the value of the uplink interference power Y, whether the femto BS 1b suffers interference from the uplink signal of the another MS 1.

In the case where the femto BS 1b suffers interference from the uplink signal of the another MS 1, it can recognized that there is a macro MS 2a (another MS 2) to which resource blocks are allocated such that the range of the resource blocks overlaps the range of the resource blocks in the uplink frame allocated to the femto MS 2b. Further, when the resource blocks in the uplink frame of the femto MS 2b overlap the resource blocks in the uplink frame of the another MS 2, the macro BS 1a might receive the interference wave UL122 of the uplink signal UL102 transmitted from the femto MS 2b to the femto BS 1, and therefore, it can be recognized that the uplink signal UL102 of the femto MS 2b is likely to interfere with the macro BS 1a.

As described above, the femto BS 1b determines, based on the value of the uplink interference power Y, whether the femto BS 1b suffers interference from the uplink signal from the another MS 1, and thereby also determines whether there is another MS 2 to which resource blocks are allocated such that the range of the resource blocks overlaps the range of resource blocks allocated to the femto MS 2b, and moreover, determines whether the uplink signal UL102 of the femto MS 2b is likely to interfere with the macro BS 1a. In this way, the output control unit 109 has a function as a determination unit that determines whether the uplink signal UL102 of the femto MS 2b is likely to interfere with the macro BS 1a.

That is, as for the control of the transmission power of the uplink transmission signal from the femto MS 2b, the output control unit 109 determines in step S103 in FIG. 29 whether or not the uplink interference power Y is equal to or greater than a predetermined threshold Yₜₕ, thereby determining whether the uplink transmission signal from the femto MS 2b is likely to interfere with the macro BS 1a.

The subsequent process is identical to the process of controlling the transmission power of the downlink transmission signal of the femto BS 1b. That is, the output control unit 109 appropriately determines an upper limit value Pumax and a lower limit value Pumin in accordance with the results of the respective determinations, and causes the modulation unit 106 to control the transmission power of the uplink transmission signal of the femto MS 2b, based on the set upper and lower limit values, and then ends the process.

The threshold Yₜₕ is a threshold value for determining whether the uplink interference power Y is caused by interference of an uplink signal from the another MS 2, and is set at a value that allows determination that the femto BS 1b suffers interference from the uplink signal from the another MS 1, and that the uplink signal UL102 of the femto MS 2b connected to the femto BS 1b is likely to interfere with the another BS 1.

The upper limit value Pumax and the lower limit value Pumin are determined based on the uplink interference power Y as expressed by the following equations (106) and (107), respectively.

lower limit value Pumin=CINRᵤₘᵢₙ+Y+L+Nᵤ (106)

upper limit value Pumax=Pu_{const}−Y+L+Nᵤ (107)

The Pu_{const} is a fixed value, which is obtained by simulation or the like in advance so that the upper limit value Pumax becomes a value suitable to suppress interference to the another BS 1, relative to the uplink interference power Y determined based on the threshold Yₜₕ.

Further, in equation (106), “CINRᵤₘᵢₙ” is a minimum CINR required for uplink communication between the femto BS 1b and the femto MS 2b, and “N” is unavoidable noise power.

As described above, in the femto BS 1b of the above-mentioned configuration, the output control unit 109 can adjust the transmission power of the uplink signal of the femto MS 2b connected to the femto BS 1b or the transmission power of the downlink transmission signal of the femto BS 1b, based on the interference powers X and Y obtained from the CQI information relating to the reception qualities of the downlink signal and the uplink signal. Therefore, when it can be determined, based on the interference powers X and Y, that the uplink signal from the femto MS 2b connected to the femto BS 1b is likely to interfere with the another BS 1, or that the downlink transmission signal from the femto BS 1b is likely to interfere with the another MS 2, the output control unit 109 can adjust the transmission power of the uplink signal from the femto MS 2b or the transmission power of the downlink transmission signal from the femto BS 1b to suppress interference to the another MS 2 or the another BS 1.

As a result, the femto BS 1b of the present embodiment can effectively suppress interference by appropriately grasping the possibility of causing interference.

### 2.2 Second Embodiment

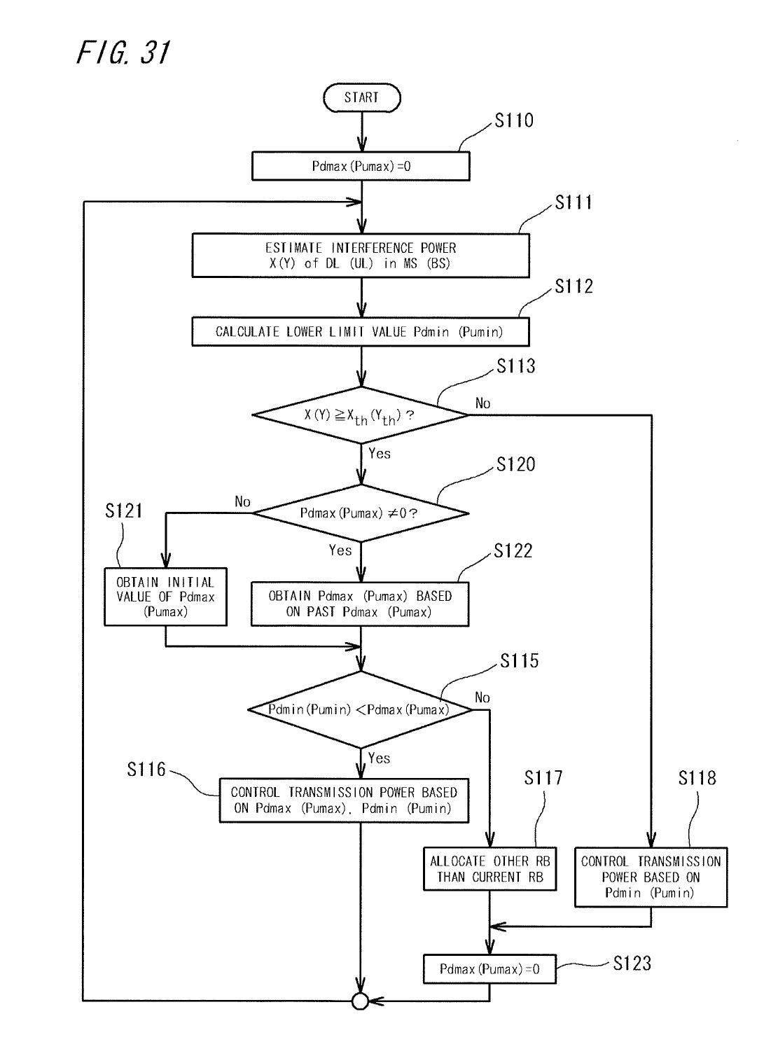

FIG. 31 is a flowchart showing a process of controlling the transmission power of a downlink transmission signal (uplink transmission signal), which is performed by an output control unit 109 of a femto BS 1b according to a second embodiment in Chapter 2. Also in this embodiment, the process of controlling the downlink transmission signal is substantially identical to the process of controlling the uplink transmission signal, and therefore, the following description is focused on the control of the transmission power of the downlink transmission signal.

The present embodiment is different from the first embodiment in that, when the output control unit 109 determines an upper limit value Pdmax in the process of controlling the transmission power, the output control unit 109 determines a new upper limit value Pdmax based on an upper limit value Pdmax determined in the past.

In FIG. 31, steps S111 to S113, and S115 to S118 are identical to steps S101 to S103, and S105 to S108 of the first embodiment described with reference to FIG. 29, respectively. Accordingly, step S110 and steps S120 to S123, which are different from the first embodiment, will be described below.

In the present embodiment, in advance of starting the process, the output control unit 109 sets the upper limit value Pdmax to “0” (step S110). Next, the output control unit 109 goes through steps S111, S112, and S113. When determining in step S113 that the downlink interference power X is equal to or greater than the threshold Xₜₕ, the output control unit 109 goes to step S120, and determines whether the upper limit value Pdmax is “0” (step S120).

When the upper limit value Pdmax is “0”, the output control unit 109 goes to step S121, and causes the upper/lower limit calculation unit 109c to calculate an upper limit value Pdmax as an initial value. In step S121, the upper/lower limit calculation unit 109c calculates an upper limit value Pdmax by using the method described in step S104 of the first embodiment. Thereafter, the output control unit 109 goes to step S115.

On the other hand, when the upper limit value Pdmax is not “0”, the output control unit 109 goes to step S122, and causes the upper/lower limit calculation unit 109c to calculate a new upper limit value Pdmax based on the upper limit value Pdmax calculated in the past (step S122), and then goes to step S115.

The upper/lower limit calculation unit 109c calculates a new upper limit value Pdmax, based on the following equation (108).

new upper limit value Pdmax=α×past Pdmax+(1−α)×(Pd_{const}−X+L+N_{d}) (108)

The past Pdmax is an upper limit value Pdmax obtained in the previous process, and α (0≦α≦1) is a factor for adjusting influences of the interference power X and the path-loss value L obtained in the current process, on the upper limit value Pdmax, and is set to an appropriate value in advance. Other factors are identical to those described for the first embodiment.

As shown in equation (108), the output control unit 109 of the present embodiment obtains a new upper limit value Pdmax by using the upper limit value Pdmax obtained in the past.

Subsequent to step S122, steps S115 to S117 and step S118 are identical to step S105 to S107 and step S108 of the first embodiment, respectively. However, the output control unit 109 goes to step S123 after completing step S117 in which the upper limit value Pdmax is not used for control of the transmission power, and step S118. In step S123, the output control unit 109 sets the upper limit value Pdmax to “0”, and then returns to step S111.

In the femto BS 1b of the present embodiment, as shown in equation (108), a new upper limit value Pdmax is calculated based on the upper limit value Pdmax obtained in the past, in the light of influences of the interference power X and the path-loss value L obtained in the current process. Therefore, variation in the upper limit value Pdmax successively obtained can be reduced. Thus, even when an interference power X having a considerable error due to a sudden interference wave or noise is obtained, influence of such interference power X can be minimized.

### 2.3 Third Embodiment

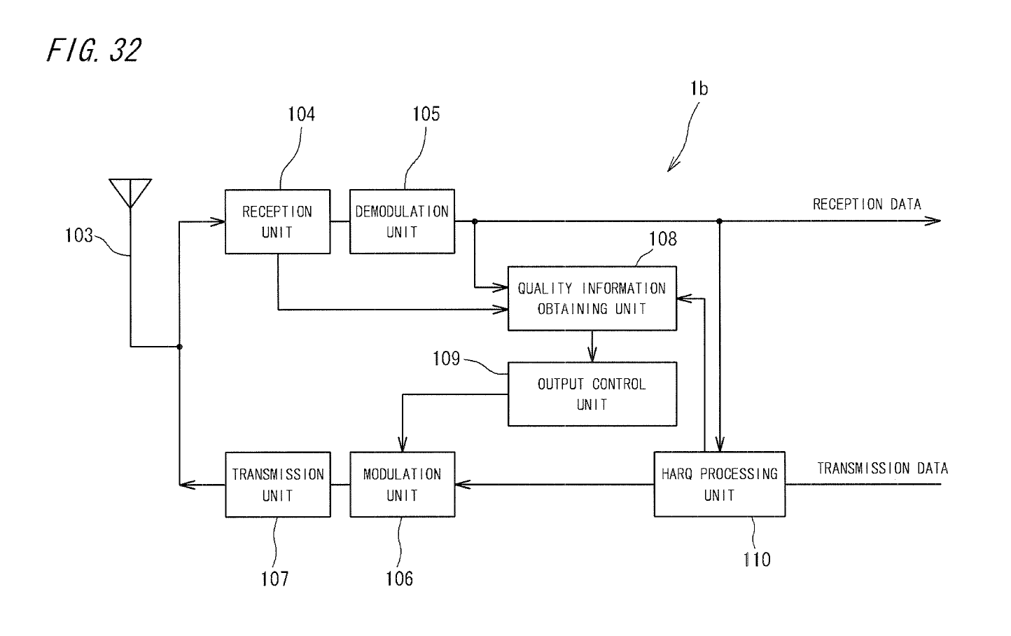

FIG. 32 is a block diagram showing a femto BS 1b according to a third embodiment in Chapter 2.

The present embodiment is different from the first and second embodiments in that the quality information obtaining unit 108 obtains information relating to the reception quality of a downlink signal, from an HARQ processing unit 10 that performs a process relating to an HARQ.

The HARQ processing unit 10 has a function of performing a process relating to an HARQ. Specifically, the HARQ processing unit 10 subjects transmission data provided from an upper layer to packet-by-packet error correction coding, and retransmits data in which error has occurred, in accordance with a response (ACK or NACK) from the femto MS 2b. The HARQ processing unit 10 obtains ACK or NACK that is a response from the MS 2, from the uplink reception data demodulated by the demodulation unit 105, and performs retransmission of data, based on the response.

Further, the HARQ processing unit 10 counts the number of ACKs and NACKs from the target femto MS 2b, with respect to a predetermined quantity of predetermined data prepared for recognizing the quality of the downlink signal, and outputs the count result information to the quality information obtaining unit 108.

Based on the count result information provided from the HARQ processing unit 10, the quality information obtaining unit 108 obtains the ratio of NACKs to ACKs with respect to the above-mentioned predetermined data, and estimates an CINR in the MS 2 from the obtained ratio. Specifically, the quality information obtaining unit 108 grasps in advance the value of CINR corresponding to the ratio, and prepares and stores a table representing the relationship between the ratio and the CINR. The quality information obtaining unit 108, which has obtained the ratio, refers to the table to obtain the corresponding CINR as an estimated value.

The quality information obtaining unit 108 outputs the estimated CINR, as downlink signal reception quality information, to the output control unit 109.

The output control unit 109 obtains a downlink interference power X, based on equation (102), with the Pd_{ref} in equation (102) being the transmission power of the predetermined data at transmission, by using the CINR provided from the quality information obtaining unit 108.

In the case of the present embodiment, since the CINR in the area where the above-mentioned predetermined data is arranged in the downlink radio frame can be measured, the degree of freedom in the measurable area is increased, and thus the CINR in the required area can be appropriately measured.

Although in the present embodiment the downlink interference power X is estimated by using the CINR estimated from the ratio of NACKs to ACKs, a CINR based on the downlink CQI information from the femto MS 2b may be used in combination with the estimated CINR. In this case, multifaceted CINR measurement is achieved, resulting in more enhanced measurement accuracy.

### 2.4 Modifications and the Like

The present invention is not limited to the above-described embodiments. In the above-described embodiments, the CINR measured by using the SRS is obtained as the uplink CQI information that is the signal reception quality information for the uplink transmission signal from the femto MS 2b. However, a CINR may be measured by using a plurality of reference signals as known signals arranged in predetermined positions among a plurality of symbols constituting the radio frame in the uplink signal. Alternatively, a predetermined quantity of predetermined data may be transmitted to the femto MS 2b with a predetermined transmission power, and the quality information obtaining unit 108 of the femto BS 1b may measure a BER (Bit Error Rate) at reception of the predetermined data, and estimate a CINR of the uplink signal from the BER. As a method of estimating a CINR from a BER, a table in which CINRs are associated with BERs may be prepared in advance, and a CINR may be estimated from the corresponding BER with reference to the table, like in the case of estimating a CINR from the ratio of NACKs to ACKs.

In the above-described embodiments, the lower limit value Pdmin is obtained based on the minimum CINR required for communication between the femto BS 1b and the femto MS 2b, and the interference power X, as shown in equations (103) and (106). However, for example, a transmission power, with which the ratio of NACKs to ACKs obtained when the femto BS 1b transmits predetermined data becomes a value that can maintain the minimum necessary communication quality, may be set as a lower limit value Pdmin. Alternatively, a lower limit value Pdmin may be obtained by using a value of CINR that can achieve predetermined throughput.

In the above-described embodiments, the transmission power is controlled with the upper limit value Pdmax (Pumax) when it is determined in step S103 that the downlink (uplink) interference power X (Y) is equal to or greater than the threshold Xₜₕ, whereas the transmission power is controlled without setting an upper limit value Pdmax (Pumax) when the downlink (uplink) interference power X (Y) is smaller than the threshold Xₜₕ. However, for example, when the downlink (uplink) interference power X (Y) is not greater than the threshold Xₜₕ, an upper limit value Pdmax (Pumax) may be set, which is greater than an upper limit value Pdmax (Pumax) to be set when the downlink (uplink) interference power X (Y) is equal to or greater than the threshold Xₜₕ. In this way, the transmission power may be controlled so as to adjust the upper limit value in accordance with the determination based on the threshold Xₜₕ (determination as to whether there is a possibility of causing interference in another BS 1 or MS 2).

[Chapter 3: Interference Suppression Control Based on Statistical Data of Radio Resource Usage Status]

In a base station device described in Chapter 3, the techniques for the base station device described in Chapter 1 or 2 are employed within the consistent scope. In Chapter 3, for those points that are not particularly described, the matters described in Chapters 1 and 2 are incorporated.

The configuration of the communication system and the frame structure for LTE in Chapter 3 are identical to those described in Chapter 1.

Although the timings of the DL frame and the UL frame are not described in Chapter 3, the timings of the DL frame and the UL frame are synchronized between the base station devices, and communication in each cell is performed in the state where so-called inter-base-station synchronization is achieved.

[3. Configuration of Base Station Device]

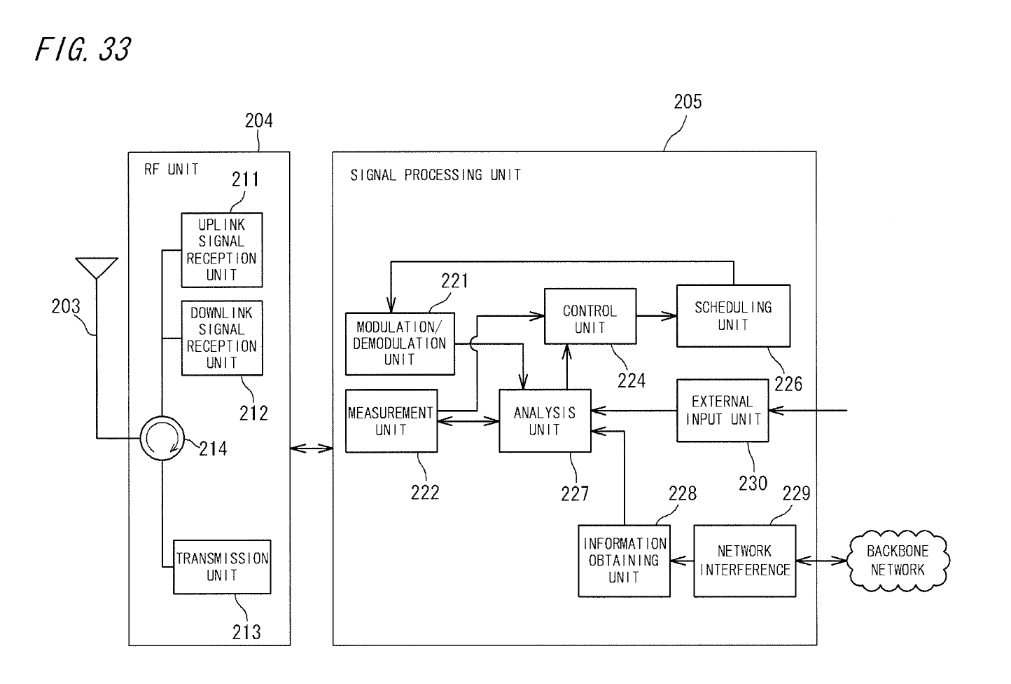

FIG. 33 is a block diagram showing the configuration of a femto BS 1b according to an embodiment in Chapter 3. While the configuration of the femto BS 1b will be described hereinafter, the configuration of a macro BS 1a is substantially the same as the femto BS 1b.

The femto BS 1b includes an antenna 203, a transmission/reception unit (RF unit) 204 to which the antenna 203 is connected, and a signal processing unit 205 that performs signal processing for signals transmitted to and received from the RF unit 204, and a process of suppressing interference to another cell (a base station device or a terminal device in another cell).

[3.1 RF Unit]

The RF unit 204 includes an uplink signal reception unit 211, a downlink signal reception unit 212, and a transmission unit 213. The uplink signal reception unit 211 receives an uplink signal from an MS 2, and the downlink signal reception unit 212 receives a downlink signal from another macro BS 1a or another femto BS 1b. The transmission unit 213 transmits a downlink signal to the MS 2.

RF unit 204 further includes a circulator 214. The circulator 214 provides a reception signal from the antenna 203 to the uplink signal reception unit 211 and to the downlink signal reception unit 212, and provides a transmission signal outputted from the transmission unit 213 to the antenna 203. The circulator 214 and a filter included in the transmission unit 213 prevent the reception signal from the antenna 203 from being transmitted to the transmission unit 213.

Further, the circulator 214 and a filter included in the uplink signal reception unit 211 prevent the transmission signal outputted from the transmission unit 213 from being transmitted to the uplink signal reception unit 211. Furthermore, the circulator 214 and a filter included in the uplink signal reception unit 212 prevent the transmission signal outputted from the transmission unit 213 from being transmitted to the uplink signal reception unit 212.

The uplink signal reception unit 211 includes a filter that allows only the frequency band of the uplink signal to pass therethrough, an amplifier, an A/D converter, and the like. The uplink signal reception unit 211 obtains the uplink signal of the MS 2 from the reception signal received by the antenna 203, amplifies the uplink signal, converts the amplified signal into a digital signal, and outputs the digital signal to a signal processing unit 205. Thus, the uplink signal reception unit 211 is a reception unit configured to comply with reception of the uplink signal from the MS 2, and is a reception unit that a base station device essentially requires.

The transmission unit 213 includes a D/A converter, a filter, an amplifier, and the like. The transmission unit 213 receives a transmission signal outputted as a digital signal from the signal processing unit 205, converts the digital signal into an analog signal, amplifies the analog signal, and outputs the amplified signal as a downlink signal from the antenna 203.

The femto BS 1b of the present embodiment further includes the downlink signal reception unit 212. The downlink signal reception unit 212 receives (measures) a downlink signal transmitted by another BS 1 than the femto BS 1b (another base station device).

In the present embodiment, the downlink signal from the another BS 1, which has been received by the downlink signal reception unit 212, is used for such as obtaining the resource usage status by the another BS 1.

The downlink signal reception unit 212 includes a filter that allows only the frequency band of the downlink signal from the another BS 1 to pass therethrough, an amplifier, an A/D converter, and the like. The downlink signal reception unit 212 obtains the downlink reception signal from the another BS 1, from the reception signal received by the antenna 203, amplifies the reception signal, converts the amplified signal into a digital signal, and outputs the digital signal.

The downlink reception signal outputted from the downlink signal reception unit 212 is provided to the signal processing unit 205, and processed by the modulation/demodulation unit 221 and the measurement unit 22.

[3.2 Signal Processing Unit]

The signal processing unit 205 includes a modulation/demodulation unit 221 that performs signal processing for transmission/reception signals exchanged between an upper layer of the signal processing unit 205 and the RF unit 204. The modulation/demodulation unit 221 demodulates, as uplink reception data, the uplink signal provided from the uplink signal reception unit 211, and outputs the data to the upper layer. Further, the modulation/demodulation unit 221 modulates various kinds of transmission data provided from the upper layer. Furthermore, the modulation/demodulation unit 221 is able to demodulate a downlink signal from another cell, which has been received by the downlink signal reception unit 212, and demodulate an uplink signal from another cell, which has been received by the uplink signal reception unit 212.

The signal processing unit 205 further includes the measurement unit 222 that measures the intensity or the like of the power of the uplink signal and/or the downlink signal from the another cell. The measurement unit 222 measures, in units of resource blocks (predetermined frequency band widths), the power of the downlink and/or uplink signal from the another cell, which has been received by the reception unit 211 or 212, thereby obtaining the amount of power in units of resource blocks.

The measurement by the measurement unit 222 is realized by periodically suspending communication in the own cell, and obtaining the signal from the another cell during the suspension.

A resource block, whose power value measured by the measurement unit 222 is great, is likely to be used in another cell. When the power of a signal from another cell is great, this situation means that a transmission signal from the own cell, whose power is great, is highly likely to reach the another cell, and therefore, the transmission signal is highly likely to interfere with the another cell.

On the other hand, a resource block, whose power value measured by the measurement unit 222 is small, is not used in another cell. Even if the resource block is used in another cell, only a signal of small power reaches the own cell because, for example, a base station device or a terminal device in the another cell is far from the own cell. When the power of the signal from the another cell is small, a transmission signal from the own cell, whose power is great, is less likely to reach the another cell, and therefore, the transmission signal is less likely to interfere with the another cell.

In this way, the reception power of each resource block indicates the usage status of the resource block in another cell, and the probability of interference to the another cell.

A control unit 224 of the signal control unit 205 performs control to suppress interference to another cell, from the viewpoint mentioned above. More specifically, in order to suppress interference, the control unit 224 has a function of adjusting, in units of resource blocks, (the upper limit value of) the transmission power of the femto BS 1b (own base station device), and a function of adjusting, in units of resource blocks, (the upper limit value of) the transmission power of a terminal device connected to the own base station device. Control information of the transmission power of the terminal device is stored in a PDCCH of a downlink transmission signal to be transmitted to the terminal device. The control information allows the terminal device to perform signal transmission with the transmission power adjusted by the base station device.

By suppressing (the upper limit values of) the transmission powers of the own base station device and the terminal device communicating with the own base station device, the signals from these devices become less likely to reach another cell, and thus interference from the own cell to the another cell can be suppressed.

The control unit 224, as a control unit performing control to suppress interference, also has a function of controlling allocation (scheduling) of resource blocks. The control unit 224 can control a scheduling unit 226 that performs allocation of a radio resource (resource blocks). That is, the control unit 224, in order to suppress interference, selects resource blocks that are less likely to cause interference in another cell from among all the available resource blocks, and selects a scheduling algorism suitable for interference suppression.

The control unit 224 has a function of adjusting the manner of interference suppression by adjusting the magnitude of the transmission power or adjusting the manner of resource block allocation, and these adjustments are performed based on a result of analysis by an analysis unit 227 included in the signal processing unit 205.

A measured value pₙ(t,f) of power of each resource block f (f: resource block number), which has been measured at time t by the measurement unit 222, is provided to the analysis unit 227. The analysis unit 227 subjects the measured power value pₙ(t,f) to analysis (statistical processing) for interference suppression control.

In n represents the number given to the measured value. Assuming that the number of the measured value in one day is n and the currently measured value is represented by pₙ(t,f), the number of the measured value in the previous day is represented by n−1, and the measured value of the power measured for the same resource block fat the same time t in the previous day is represented by pₙ₋₁(t,f).

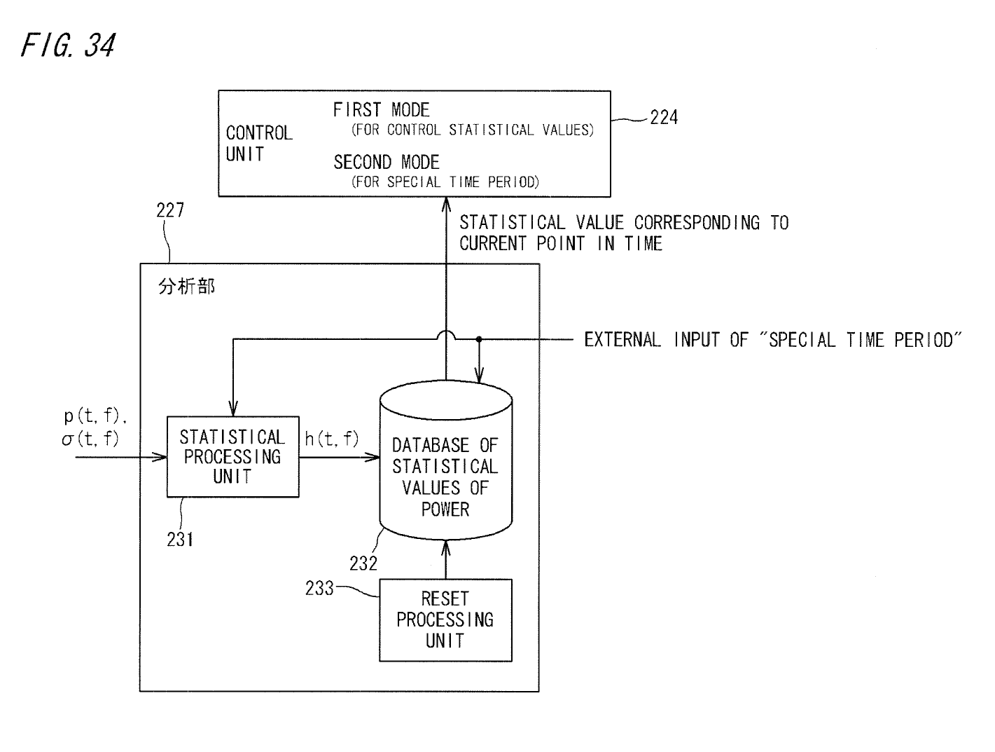

As shown in FIG. 34, the analysis unit 227 includes a statistical processing unit 231 that tallies the data of powers measured by the measurement unit 222, and subjects the data to statistical processing.

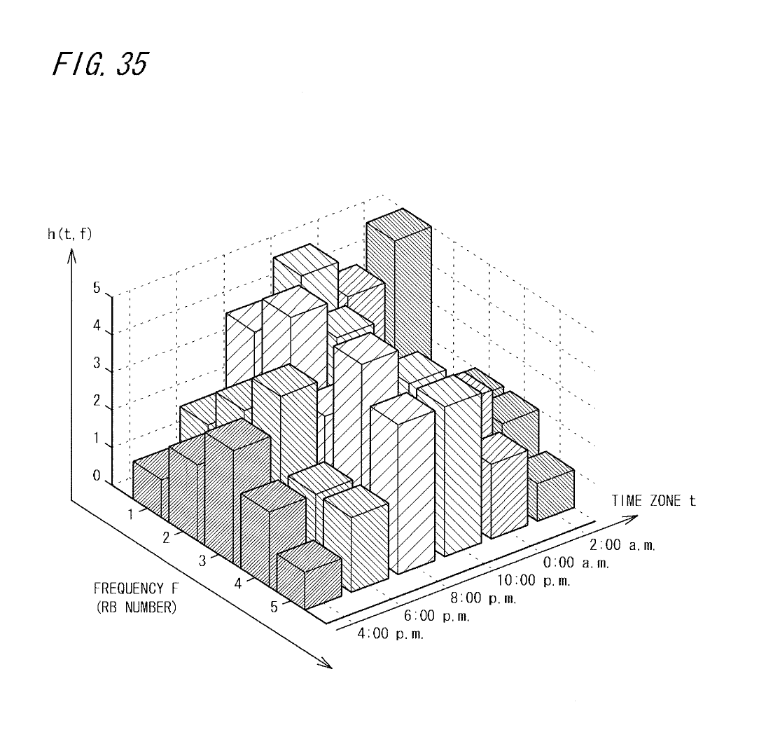

The statistical processing unit 231 of the present embodiment tallies up the power of each resource block, for each predetermined time zone (e.g., each time zone of two hours) in one day, and generates a statistical value. For example, as shown in FIG. 35, assuming that the resource block (RB) numbers f are 1 to 5 . . . , an average power value of each resource block (number f) in each time zone t is calculated as a statistical value h(t,f) by the statistical processing unit 231.

The average power value h(t,f) calculated by the statistical processing unit 231 may be a an average value obtained by forgetting factor averaging, or an average value of N pieces of measured power values p(t,f).

In the forgetting factor averaging, the average power value h (t,f) is calculated as follows.

hₙ(t,f)=(1−α)·pₙ(t,f)+α·hₙ₋₁(t,f)

where, α is the forgetting factor, and 0≦α≦1 is satisfied.

The average power value h(t,f) of N pieces of measured power values p (t,f) is calculated as follows.

hₙ(t,f)=(1/N)·(pₙ(t,f)−p_{n-N}(t,f))+hₙ₋₁(t,f)

Since the average power value hₙ(t,f) is updated every day by the statistical processing unit 231, the average power value hₙ(t,f) as the statistical value can be updated based on the latest usage status of each resource block in another cell.

After the average power values hₙ(t,f) of the respective resource blocks (number f) in the respective time zones t have been calculated by the statistical processing unit 231, a database 232 is updated with the average power values hₙ(t,f). That is, in the database 232, as shown in FIG. 35, the magnitudes of the average power values hₙ(t,f) of the respective resource blocks fin another cell in the respective time zones t in one day are stored.

In many cases, the magnitude of the average power value hₙ(t,f) is not equal among a plurality of resource blocks, and some resource blocks have relatively high powers while other resource blocks have relatively low powers. This is because all the resource blocks are not equally used, but some resource blocks are used very often depending on the transmission path environment of another cell, or the like.

Further, the number of terminal devices varies or the transmission path environment varies depending on the time zone. Therefore, the usage status of one resource block varies depending on the time zone t, and thereby the average power value hₙ(t,f) thereof varies. This is because the number of terminal devices in the neighborhood of another base station device varies between the daytime and the nighttime, or a factor that affects the transmission path environment, such as the volume of traffic around the another base station device, varies. That is, since the another base station device intends to perform scheduling adapted to the number of terminal devices or the transmission path environment, the reception power observed for each resource block varies depending on variation in the number of terminal devices or the transmission path environment.

However, even on different days, the number of terminal devices or the transmission path environment around the another base station device in the same time zone does not vary very much, and therefore, the another base station device is highly likely to perform similar scheduling. Accordingly, although the data of the statistical values as shown in FIG. 35 are based on the power data obtained in the past, it is considered that the data of the statistical values represent the predictive values of the resource block usage statuses in the another cell in a certain time zone in the future.

While in the present embodiment the statistical values in each time zone are obtained, a period (predetermined period) to be the unit of obtaining the statistical values is not limited thereto, and may be day (day of the week), month, holiday, year's end, Golden Week, or the like.

The control unit 224 refers to the data of the average power values hₙ(t,f) as shown in FIG. 35 which are stored in the database 232, and determines a manner of suppressing interference, based on the average power values hₙ(t,f).

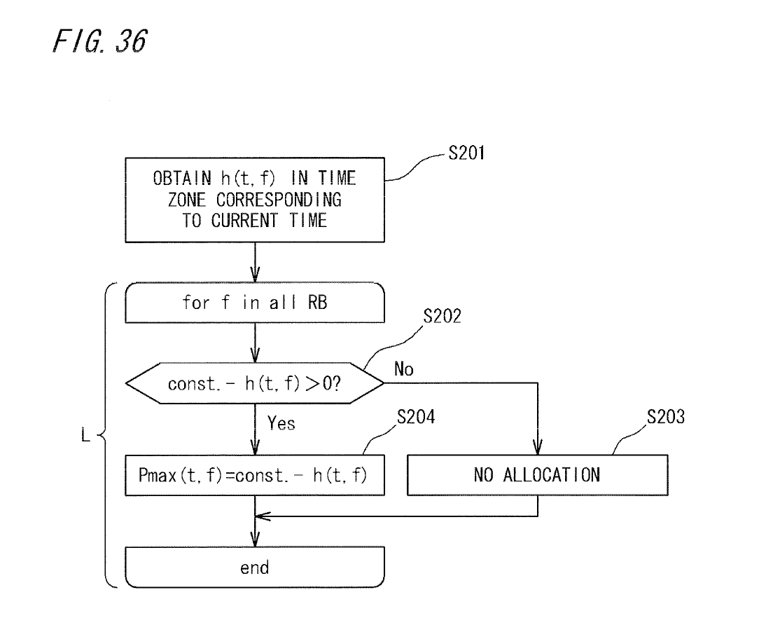

Specifically, as shown FIG. 36, the control unit 224 obtains, from the database 232, the average power values hₙ(t,f) of all the resource blocks f (all the uplink resource blocks and all the downlink resource blocks) in time zone t corresponding to the current time (time at which interference suppression is performed) (step S201).

Step S201 is followed by a loop process L of executing steps S202, S203, and S204.

In the loop process, firstly, the average power value hₙ(t,f) of each resource block f obtained from the database 232 is compared with a predetermined threshold (const.) (step S202). When the average power value hₙ(t,f) of the resource block f is greater than the threshold (const.), in order to avoid interference to the resource block f, the control unit 224 adjusts resource allocation so that no terminal device is allocated to the resource block f (step S203).

On the other hand, when the average power value hₙ(t,f) of the resource block f is smaller than the threshold (const.), the resource block f is used for allocation to a terminal device in the own cell. However, the control unit 224 performs a process of suppressing the transmission power of the resource block (step S204).

Specifically, the control unit 224 sets the magnitude of the transmission power of the own cell (the base station device or the terminal device) to a value obtained by subtracting the average power value hₙ(t,f) of the resource block f from the threshold (const.). That is, the control unit 224 adjusts the upper limit value of the transmission power so as to reduce the transmission power of the own cell with increase in the average power value hₙ(t,f) of the another cell, thereby suppressing interference.

In other words, when the average power value hₙ(t,f) of the another cell is small, the possibility of causing interference to the another cell is low, and therefore, the upper limit value of the transmission power can be increased. As a result, efficient communication with increased communication speed can be achieved.

By performing the above-mentioned process (determination of a manner of interference suppression) for each resource block f, an appropriate manner of interference suppression can be determined in accordance with the past resource usage status in the another cell.

The statistical value h(t,f) is not limited to the average power value, and any data may be used so long as the data represents the usage status of each resource block in another cell. For example, the usage status data may be an average value h(t,f) of power variance σ²(t,f). An average value of power variance can be obtained by obtaining variance values from the power values p(t,f) in each predetermined time zone (period) measured by the measurement unit 222, and then obtaining an average value of the variance values. The average value of power variance may be either an average value obtained by forgetting factor averaging, or an average value of N pieces of power variance values.

In the forgetting factor averaging, the variance average value h(t,f) is calculated as follows.

hₙ(t,f)=(1−α)·σ²ₙ(t,f)+α·hₙ₋₁(t,f)
where, α is the forgetting factor, and 0<α<1 is satisfied.

The average value h(t,f) of N pieces of power variance values σ²(t,f) is calculated as follows.

hₙ(t,f)=(1/N)·(σ²ₙ(t,f)−σ²_{n-N}(t,f))+hₙ₋₁(t,f)

When the power variance value σ²ₙ(t,f) in a certain resource block fin a certain time zone t is large, this situation means that the resource block f is allocated to various terminal devices in the time zone t, and therefore, allocation of the resource block f varies significantly. On the other hand, when the power variance value σ²ₙ(t,f) is small, this situation means that the resource block f is locally allocated to a specific terminal device in the time zone t.

So, the control unit 224 selects a scheduling algorism in which allocation is variable, such as proportional fairness (PF), for a group of resource blocks each having a relatively large average value h(t,f) of power variance values σ²(t,f), and causes the scheduling unit 226 to execute the algorism. That is, when variation in the used resource in the another cell is significant, variation in the used resource is caused to occur also in the own cell, thereby to reduce the probability that interference actually occurs (the probability that the own cell and the another cell use the same resource blocks).

In the above case, since the possibility that the resource blocks used in the own cell overlap the resource blocks used in the another cell cannot be eliminated, the control unit 224 reduces the transmission power for all the frequencies (all the resource blocks), thereby suppressing interference.

On the other hand, as for a group of resource blocks each having a relatively small average value h(t,f) of power variance values σ²(t,f), resource blocks each having a relatively small power value (t,f) are used among such resource blocks. In this case, the control unit 224 causes the scheduling unit 226 to execute localized allocation, such as semi-persistent scheduling, in which the same resource block is allocated to the same terminal device continuously in time. That is, when variation in the used resource in the another cell is not significant, resource blocks that are not used in the another cell are locally used, thereby avoiding interference to the another cell.

In this case, since the probability of causing interference to the another cell is low, the control unit 224 performs control to increase the transmission power in the own cell. Thereby, efficient communication with increased communication speed can be achieved.

The database 232, as described above, holds the statistical values h(t,f) based on the past usage statuses of the respective resource blocks in the another cell, and this is based on the premise that the past usage statues will occur similarly in the future under the same condition (time and date). This premise holds true only when the criterion for determining resource allocation in the another base station device, such as the scheduling algorism possessed by the another base station device, is unchanged. Accordingly, when the criterion is changed, the reliability of the past statistical values is degraded.

So, the present embodiment is provided with a reset processing unit 233 that resets a part or the entirety of the past statistical values h(t,f) stored in the database 232, at a desired timing (timing at which the reliability of the past statistical values is degraded), and performs tallying of power values and recalculation of statistical values h(t,f). After the reset has been performed, the statistical processing unit 231 recreates statistical values.

Timing at which the reliability of the past statistical values is degraded may be timing when software of the another base station device is updated. There are cases where the software may contain a process that affects the criterion for determining resource allocation in the another base station device, such as scheduling algorism.

Since such updating of software causes reduction in the reliability of the past statistical values, the reset processing unit 233 resets (erases) desired statistical values among the statistical values stored in the database 232. The statistical values that are not affected by such updating and are kept reliable need not be erased.

If the timing at which the software is updated in the another base station device is known in advance, the timing is set in the analysis unit 227, and the reset processing unit 233 performs reset at the set timing. Alternatively, the reset timing may be notified from the another base station device in which the software has been updated, via a backbone network or the like described later.

The usage status data available in the present embodiment is not limited to the power value and the power variance value, and may be allocation information of resource blocks in the another cell. Since the allocation information of resource blocks in the another cell is included in a downlink frame of the another cell, the allocation information may be obtained by reading the frame to generate a statistical value of the usage status of each resource block

The resource block allocation information is not necessarily obtained by reading the downlink frame of the another cell as described above, and may be obtained from a backbone network. As shown in FIG. 33, the signal processing unit 205 has an interface 229 for the backbone network, and the interface 229 enables an information obtaining unit 228 of the signal processing unit 205 to obtain necessary information such as allocation information from the another base station device.

Further, the signal processing unit 205 includes an external input unit 230 that receives an input of a specific time period (specific time zone, date, or the like) from the outside of the base station device.

The “specific time period” (hereinafter referred to as “special time period”) received by the external input unit 230 is a “time period” that can be set later, even during operation of the base station device, and is different from the “predetermined time period” (in the present embodiment, for example, a time zone of two hours) that is set in advance (at shipping) as a unit in which the statistical processing unit 231 tallies up the usage status data (power data).

The special time period may be a date and a time when an event to which many people will attend is held in the neighborhood of another base station device, a newly established holiday, or a date and a time when unusual resource allocation is expected to be performed.

For example, in a case where a one-shot event is held in a certain time zone in a certain day and more people than usual get together in a cell of another base station device (macro BS), the number of terminal devices in the another cell increases, and the probability that the own base station device (femto BS) interferes with the another cell is significantly increased. In this case, the past statistical values are not very useful.

That is, when the probability that another base station device uses a resource block, which is estimated not to be used by the another base station device according to the past statistical values, is increased due to increase in the number of terminal devices, it is necessary to avoid interference by reducing the transmission powers of all the resource blocks regardless of the past resource usage status of the another base station device.

In order to deal with such situation, the control unit 224 has a first mode (normal mode for controlling statistical values) in which interference suppression is performed based on the statistical values stored in the database 232, and a second mode (special mode for special time period) in which, during an externally inputted special time period, interference suppression (e.g., uniform suppression of transmission power for all the resource blocks) for the special time period is performed without using the statistical values stored in the database 232.

When the timing at which interference suppression control should be performed is within the special period time, the control unit 224 preferentially executes the second mode to ensure appropriate interference suppression.

In a case where the externally inputted special time period will come many times in the future, such as a new holiday, the special time period may be used as a new unit in which the statistical processing unit 231 tallies up the usage status data (power data). Thereby, it is possible to accumulate the statistical values of the usage statuses of the respective resource blocks in the another cell during the special time period. Thus, the control unit 224 can perform interference suppression control, based on the statistical values in the special time period.

[Chapter 4: Interference Suppression Control in Accordance with Temporal Variation in Radio Resource Allocation]

In a base station device described in Chapter 4, the techniques for the base station device described in Chapter 1, 2, or 3 are employed within the consistent scope. In Chapter 4, for those points that are not particularly described, the matters described in Chapters 1, 2, and 3 are incorporated.

The configuration of the communication system and the frame structure for LTE in Chapter 4 are identical to those described in Chapter 1.

Although the timings of the DL frame and the UL frame are not described in Chapter 4, the timings of the DL frame and the UL frame are synchronized between the base station devices, and communication in each cell is performed in the state where so-called inter-base-station synchronization is achieved.

### 4.1 Configuration of Base Station Device

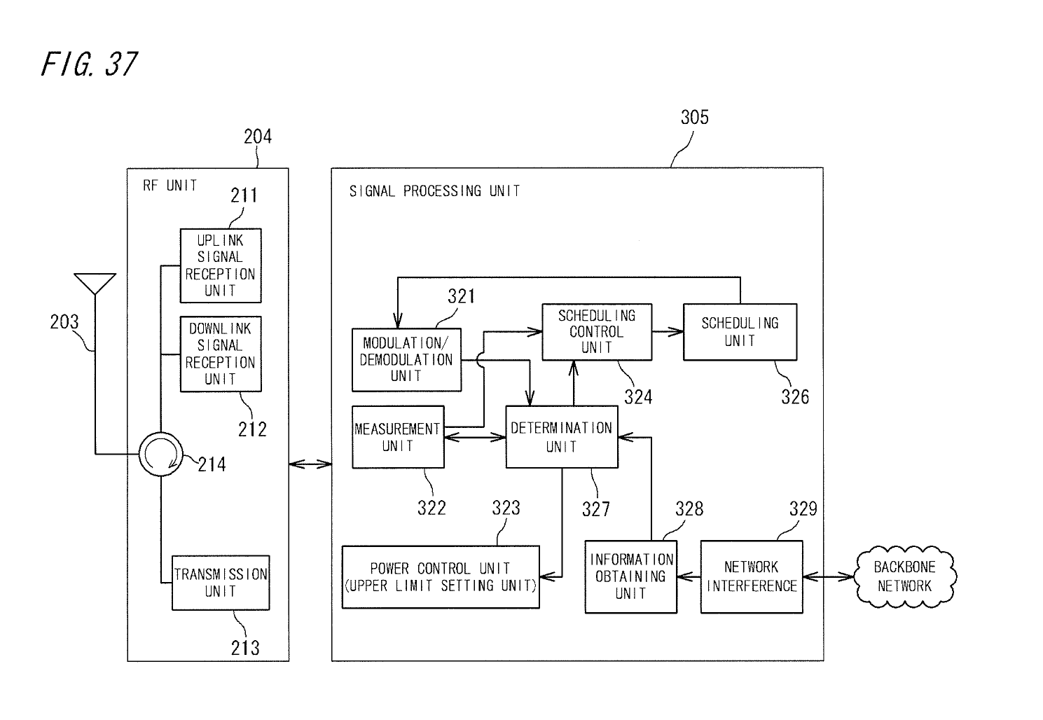

FIG. 37 is a block diagram showing the configuration of a femto BS 1b according to an embodiment in Chapter 4. While the configuration of the femto BS 1b will be described hereinafter, the configuration of a macro BS 1a is substantially the same as the femto BS 1b.

The femto BS 1b includes an antenna 303, a reception unit (RF unit) 304 to which the antenna 303 is connected, and a signal processing unit 305 that performs signal processing for signals transmitted to and received from the RF unit 304, and a process of suppressing interference to another cell (a base station device or a terminal device in another cell).

[4.1.1 RF Unit]

The RF unit 304 includes an uplink signal reception unit 311, a downlink signal reception unit 312, a transmission unit 313, and a circulator 314. Since these components are identical to those of the RF unit 204 according to the embodiment in Chapter 3, repeated description is not necessary.

[4.1.2 Signal Processing Unit]

The signal processing unit 305 includes a modulation/demodulation unit 321 that performs signal processing for transmission/reception signals exchanged between an upper layer of the signal processing unit 305 and the RF unit 304. The modulation/demodulation unit 321 demodulates, as uplink reception data, an uplink signal provided from the uplink signal reception unit 311, and outputs the data to the upper layer. Further, the modulation/demodulation unit 321 modulates various kinds of transmission data provided from the upper layer. Furthermore, the modulation/demodulation unit 321 is able to demodulate a downlink signal from another cell, which has been received by the downlink signal reception unit 312, and demodulate an uplink signal from another cell, which has been received by the uplink signal reception unit 312.

The modulation/demodulation unit 321 subjects the transmission data provided from the upper layer to a predetermined modulation scheme, for a predetermined data unit, based on an instruction of a scheduling unit 321, and allocates the modulated data to a DL frame in units of resource blocks, thereby generating a downlink transmission signal of the femto BS 1b (own downlink transmission signal).

In the signal processing unit 305, when generating the own downlink transmission signal, a power control unit 323 generates uplink transmission power control information that causes a terminal device connected to the femto BS 1b to adjust the transmission power of its uplink transmission signal, and stores the uplink transmission power control information in a PDCCH of the own downlink transmission signal to be transmitted to the terminal device, thereby adjusting the transmission power of the terminal device.

Furthermore, the signal processing unit 305 has a function of setting, for each resource block, the transmission power of the own downlink transmission signal and the transmission power of the uplink transmission signal of the terminal device connected to the femto BS 1b, and adjusts, based on the downlink transmission power control information outputted from the power control unit 323, the transmission power of the downlink transmission signal for each resource block. The transmission power of the uplink transmission signal of the terminal device is similarly adjusted, for each resource block, based on the uplink transmission power control information transmitted to the terminal device.

The power control unit 323 functions as a control unit that adjusts the transmission power of the femto BS 1b (own base station device) and/or the transmission power of the terminal device communicating with the own base station device, thereby performing control to suppress interference to base station devices or terminal devices in another cell.

That is, when there is a possibility of causing interference to another cell, the power control unit 323 performs control to suppress (the upper limit value of) the own transmission power of the own base station device or the terminal device in the own cell, thereby preventing the signal transmitted from the own base station device or the terminal device in the own cell from becoming an interference signal in the another cell.

The signal processing unit 305 further includes a scheduling control unit 324 as a control unit that performs control to suppress interference. The scheduling control unit 324 controls a scheduling unit 326 that performs allocation of a radio resource (resource blocks). The scheduling unit 326 is able to execute a plurality of scheduling algorisms. The scheduling control unit 324 performs selection of a scheduling algorism to be executed, and setting relating to scheduling, and causes the scheduling unit 326 to execute scheduling according to the set content.

Examples of scheduling algorisms executable by the scheduling unit 326 may include round robin (RR), proportional fairness (PF), and maximum CIR.

The RR is a method in which resources are successively allocated to the users without considering the transmission path conditions or the like. In the RR, temporal variation in resource allocation is likely to increase.

The PF is a method in which scheduling is performed so as to make the communication speeds of the users equal. In the PF, temporal variation in resource allocation is reduced as compared to the RR.

The maximum CIR is a method in which a radio resource is allocated preferentially to a user having the highest CIR (Carrier to Interference Ratio). In the maximum CIR, temporal variation in resource allocation is reduced as compared to the PR and the PF, and localized allocation is substantially performed.

The scheduling unit 326 is also able to perform semi-persistent scheduling (SPS) in the LTE standard.

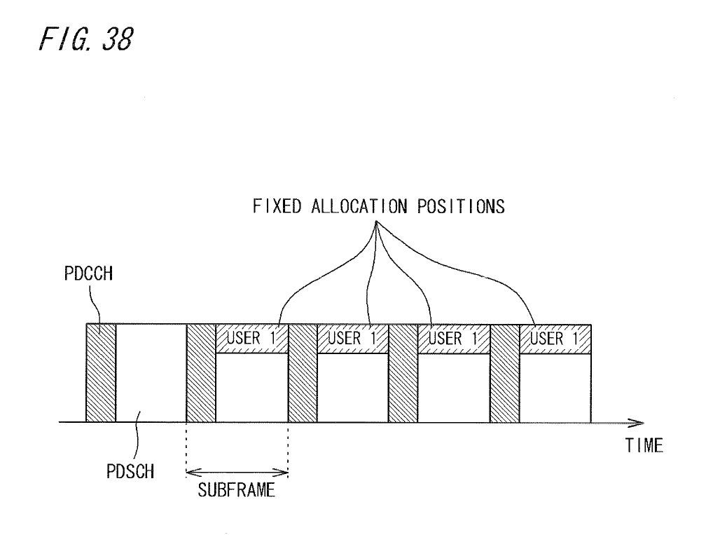

As shown in FIG. 38, the SPS is a method in which an allocation position (resource blocks to be allocated) is fixed over a plurality of subframes, for a terminal device of a specific user (“user 1” in FIG. 38). The SPS is suitable for application data, such as VoIP data, for which localized allocation is required.

The adjustment of the transmission power by the power control unit 323 and the control of scheduling by the scheduling control unit 324 are performed in accordance with a result of determination by a determination unit 327.

The determination unit 327 determines temporal variation in radio resource allocation to a terminal device from another base station device (particularly, a macro BS 1a). The temporal variation in radio resource allocation means variation in the manner of resource allocation between temporally different subframes. If the resource allocation manners in temporally different subframes are exactly the same, the degree of temporal variation is zero. If the resource allocation manners in temporally different subframes are partially the same and partially different, the degree of temporal variation is increased to some extent. If the resource allocation manners in temporally different subframes are completely different from each other, the degree of temporal variation is maximum.

In the case where temporal variation in resource allocation is small, if the resource allocation status in another base station device, which is obtained at a point in time, is used for prediction of resource allocation in subsequent subframes, the adequacy of the prediction is high. On the other hand, in the case where the temporal variation in resource allocation is great, if the resource allocation status in another base station device, which is obtained at a point in time, is used for prediction of resource allocation in subsequent subframes, the adequacy of the prediction is low. Accordingly, when the temporal variation in resource allocation is small, it is easy to perform interference suppression by avoiding use of a resource used by the another base station device in accordance with the resource allocation status of the another base station device.

As described above, when temporal variation in resource allocation is great, the resource allocation is highly unreliable. The magnitude of temporal variation in resource allocation indicates the possibility of prediction of resource allocation in the future.

Based on the above-mentioned points, the determination unit 327 determines temporal variation in resource allocation, in order to facilitate interference suppression control by the power control unit 323 and the scheduling control unit 324. The determination on temporal variation will be described later in detail.

The determination unit 327 obtains information required for determining temporal variation in resource allocation, from another base station device, a terminal device that communicates with the another base station device, or a device that controls the another base station device, and performs determination based on the information.

Examples of information available to determine temporal variation in resource allocation in another base station device may include: localized/distributed information; scheduling algorism type information; data application type information; and power variation information obtained by measurement. The determination unit 321 performs determination based on any of these pieces of information.

The localized/distributed information is information indicating whether the radio resource allocation method is localized FDMA (localized allocation), or distributed FDMA (distributed allocation).

The scheduling algorism type information is information indicating the type of scheduling algorism executed in another base station device, and as described above, the algorism type serves as an indicator that indicates the degree of temporal variation in resource allocation.

The application type information is information indicating the application type (VoIP, streaming, or WEB) of data. Since VoIP or streaming data is required to be continuously provided without interruption, localized allocation is adopted. On the other hand, since some delay is allowed in WEB data, WEB data is allocated discretely (bursty) in many cases, and thus temporal variation is increased.

The power variation information is obtained by measuring the power of each subframe in an uplink and/or a downlink in another cell. In the case of localized allocation, power variation between temporally different subframes is reduced. The power variation increases as the resource allocation varies.

The determination unit 327 is able to obtain the respective pieces of information from the modulation/demodulation unit 321, the measurement unit 322, and the information obtaining unit 328. When obtaining the respective pieces of information from the modulation/demodulation unit 321, the determination unit 327 may sniff communication between a base station device and a terminal device in another cell to take the information from messages included in a radio frame.

In the LTE standard, localized/distributed information relating to downlink is stored as a message of format lA or format 1B in a PDCCH, while localized/distributed information relating to uplink is stored as a message of format 0 in the PDCCH. Accordingly, it is possible to obtain localized/distributed information by sniffing communication in another cell and reading the message.

Furthermore, the scheduling type information and the application type information may also be included in the (downlink) frame of the another cell. Thereby, these pieces of information can be obtained by sniffing communication in the another cell.

Alternatively, a terminal device connected to the own base station device may be caused to obtain the localized/distributed information, the scheduling type information, the application type information, and the power variation information in another cell, and transmit the obtained information to the own base station device in the uplink, so that the own base station device can receive the respective pieces of information from the terminal device.

Alternatively, the above-mentioned respective pieces of information may be obtained from another base station device or a device (server) that controls the another base station device, via a backbone network (wired network) connecting base stations. The signal processing unit 305 has a network interface 329 for the backbone network, and the interface 329 allows the information obtaining unit 328 to obtain, via the backbone network, the localized/distributed information, the scheduling type information, the application type information and the like.

Since the higher-level device (server) that controls the another base station device also grasps the application type information, it is preferable that the application type information is obtained from the higher-level device via the backbone network.

The power variation information can be obtained by measuring a signal (signal intensity; amount of power) in communication in another cell by the measurement unit 322. The measurement unit 322 measures, in units of resource blocks, the power of uplink and/or downlink signals in another cell, thereby obtaining the amount of power in each resource block. Based on the amount of power, the determination unit 327 generates and obtains power variation information, and uses the power variation information for determination.

The method of determining temporal variation in resource allocation in another cell by using the power measured by the measurement unit 322 is advantageous in the case where none of the localized/distributed information, the scheduling type information, and the application type information can be obtained.

Measurement by the measurement unit 322 is performed by periodically suspending communication in the own cell, and obtaining a signal from another cell during the suspension.

### 4.2 Manner of Adjusting Interference Suppression Control

### First Example

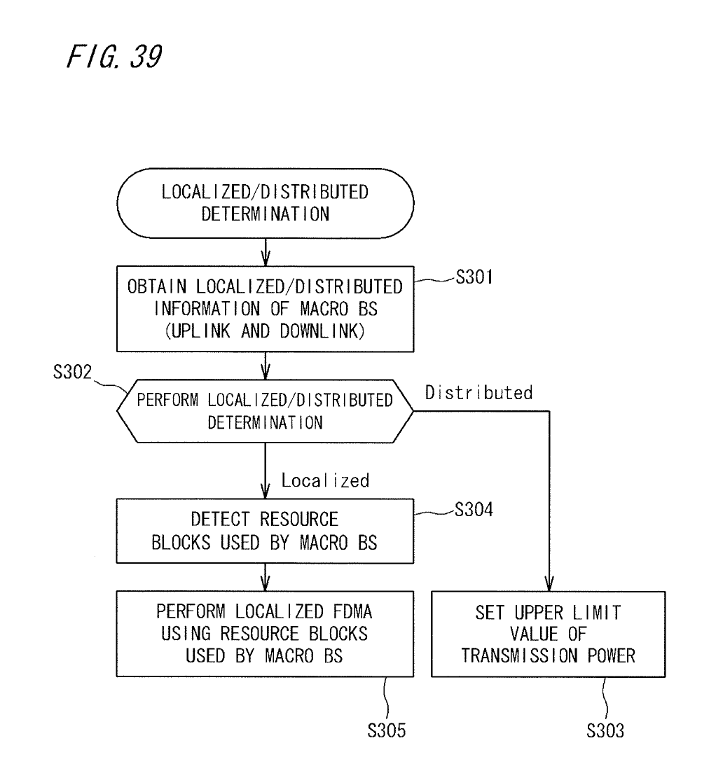

FIG. 39 shows a method of determining temporal variation in resource allocation in another cell based on localized/distributed information, and adjusting interference suppression control based on a result of the determination.

Firstly, localized/distributed information in uplink and/or downlink in another cell (macro BS) is obtained (step S301). As described above, this information can be obtained by reading a message in a frame of another cell, or via a backbone network.

Subsequently, based on the localized/distributed information, it is determined whether the allocation method adopted in the another cell (macro BS) is localized FDMA or distributed FDMA (step S302). When it is determined in step S302 that the allocation method is distributed FDMA, since variation in resource allocation is great, it is difficult to control interference suppression in units of resource blocks in accordance with the resource allocation in the another cell. So, the power control unit 323 reduces the upper limit value of the transmission power over the entirety of the used communication frequency band, thereby suppressing interference to the another cell (step S303).

Specifically, in step S303, the power control unit 323 sets an upper limit value so that the maximum value of the transmission power of the own base station device or the maximum value of the transmission power of the terminal device communicating with the own base station device becomes smaller than that in the normal state (the state in which interference suppression is not considered). Further, when a first upper value is set as the upper limit value of the transmission power in the normal state, the power control unit 323 performs, in step 13, setting to change the upper limit value of the transmission power to a second upper limit value that is lower than the first upper limit value.

Since the upper limit value of the transmission power is set over the entirety of the used communication frequency band in step S303, a signal transmitted from the own base station device or the terminal device communicating with the own base station device becomes less likely to reach the another cell, thereby suppressing interference to the another cell. Moreover, since the transmission power is reduced over the entirety of the used communication frequency band, it is possible to realize interference suppression even if temporal variation in resource allocation is great and therefore it is difficult to grasp the resource blocks used in the another cell.

On the other hand, when it is determined in step S302 that the resource allocation method adopted by another base station device (macro BS) is localized FDMA, unused resource blocks that are not being used in the cell of the another base station device are detected (step S304). This detection is achieved by reading the resource allocation information in the another base station device from a downlink frame of the another base station device. Alternatively, the power of the downlink signal from the another base station device may be measured in units of resource blocks by the measurement unit 322, and resource blocks whose powers are smaller than a threshold may be detected as unused resource blocks or as resource blocks that are not likely to cause interference.

Subsequently, the scheduling control unit 324 controls the scheduling unit 326 so that resource allocation in the own cell is performed by localized FDMA (step S305). In this case, the unused resource blocks in the another cell or the resource blocks that are not likely to cause interference are locally used in the own cell. Since the resource blocks other than those used in the another cell are locally used in the own cell in accordance with that the resource allocation in the another cell is localized FDMA, it is possible to efficiently avoid interference.

Specifically, even if the resource blocks unused in the another cell are used for communication in the own cell, no interference is caused in the another cell. So, the power control unit 323 relatively increases the transmission power in communication in the own cell for the resource blocks unused in the another cell. Thus, the communication speed is increased, and efficient communication is achieved.

Further, even the detected powers of the resource blocks used in the another cell are small when the base station device or the terminal device in the another cell is far from the own base station device. Such resource blocks are considered to be less likely to cause interference. Therefore, even if communication is performed with somewhat great transmission power for these resource blocks, the power is attenuated before reaching the another cell, and thus the degree of interference is reduced. Also in this case, the transmission power in communication in the own cell may be increased to increase the communication speed, which results in efficient communication.

As for the resource blocks that are used in the another cell and therefore are likely to cause interference, use of these resource blocks in the own cell may be avoided, or the transmission powers thereof may be sufficiently reduced to suppress interference.

The resource allocation and the setting of transmission power which have been performed in step S305 are continuously used until the resource allocation status in the another cell is again obtained in step S301. That is, even if the resource allocation status in the another cell is localized, it might be changed after the processes in steps S302 and S304 have been performed. Accordingly, the set values in step S305 are degraded in reliability with time, and might become noncompliant in real time with the resource allocation in the another cell.

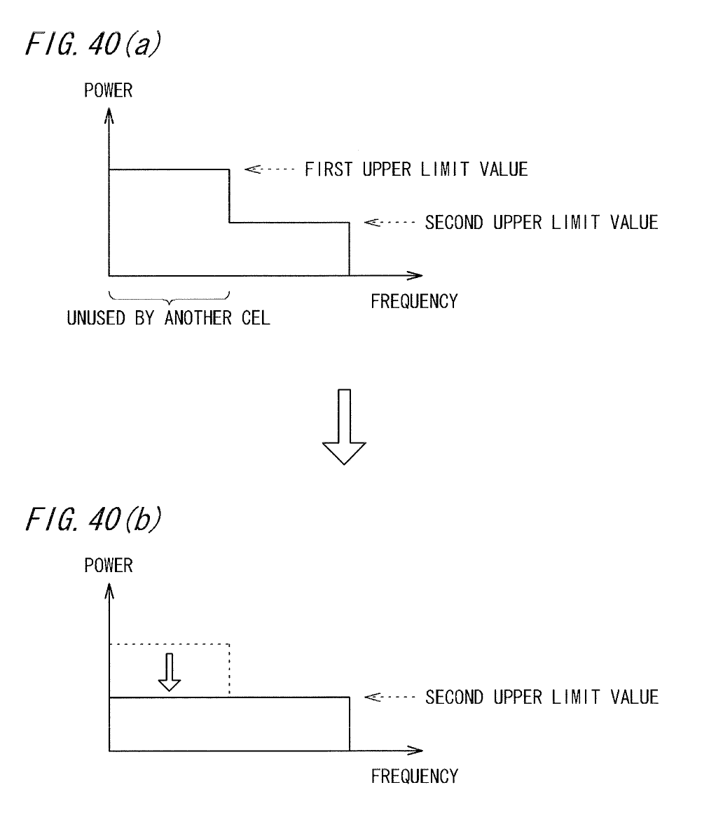

So, the power control unit 323 performs control (power reduction control) to reduce, with time, the upper limit value of the transmission power which has been set in step S305. That is, as shown in FIG. 40(a), it is assumed that, at the time of step S305, the power control unit 323 sets, for the frequency band (resource blocks) not used in the another cell, the upper limit value of the transmission power to the relatively high first upper limit value to enhance the communication efficiency, and sets, for the frequency band (resource blocks) used in the another cell, the upper limit value of the transmission power to the relatively low second upper limit value to suppress interference.

The set value shown in FIG. 40(a) is not locally used until the resource allocation status in the another cell is again obtained, but as shown in FIG. 40(b), the power control unit 323 lowers the upper limit value of the transmission power with time. In particular, it is preferable that the first upper limit value which might cause interference if the another cell uses the resource should be lowered to the second upper limit value which does not cause interference even if the another cell uses the resource.

As described above, the possibility that the resource allocation status in the another cell is maintained is lowered with time, and thereby the adequacy of interference suppression control in units of resource blocks in the own cell is degraded. In this situation, it is adequate to lower the transmission power over the entirety of the used communication frequency band, for interference suppression control.

The power reduction control may be executed not only after step S305 but also after step S303. That is, after the allocation method is determined to be distributed allocation and the upper limit value of the transmission power is set, the power control unit 323 may perform the power reduction control to reduce, with time, the magnitude of the transmission power of the own base station device and/or the magnitude of the transmission power of the terminal device communicating with the own base station device are reduced with time. This power reduction control is performed over the entirety of the used communication frequency band.

The amount of power to be reduced in the power reduction control is greater in the case where the allocation method is determined to be distributed allocation than in the case where the allocation method is determined to be localized allocation. Since reduction in the adequacy of adjustment of the interference suppressing manner, with time, is greater in the case of the distributed allocation than in the localized allocation, it is possible to suppress interference by increasing the amount of power to be reduced in the power reduction control when it is determined that the allocation method is distributed allocation.

### 4.3 Manner of Adjusting Interference Suppression Control

### Second Example

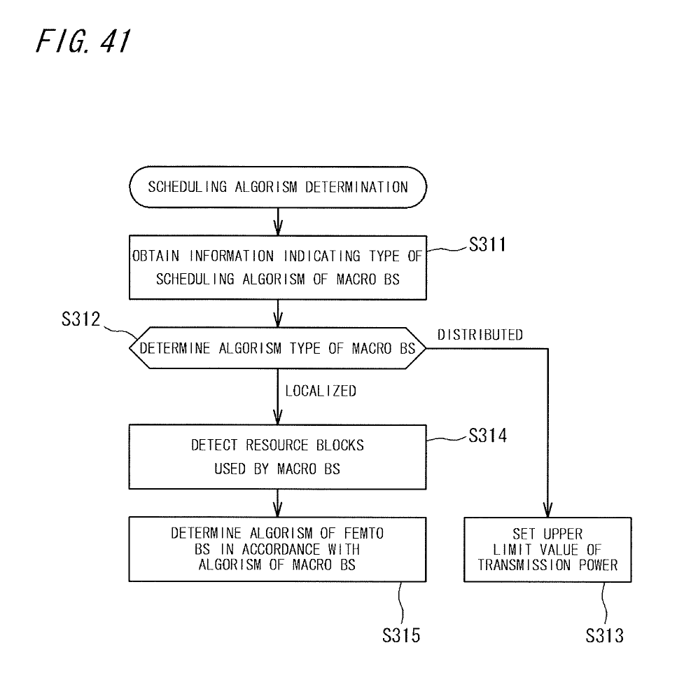

FIG. 41 shows a second example of a method of determining temporal variation in resource allocation in another cell based on the scheduling algorism type information, and adjusting interference suppression control based on a result of the determination.

Firstly, scheduling algorism type information in another base station device (macro BS) is obtained (step S311). This information can be easily obtained from the another base station device via a backbone network. However, if this information is included in a frame of the another cell, the information may be obtained by reading a message in the frame.

Subsequently, in order to determine temporal variation in resource allocation in the another cell, the type of the scheduling algorism adopted in the another base station device is determined based on the scheduling algorism type information (step S312). When it is determined that the scheduling algorism is very low in predictivity for resource allocation and is variable, such as RR, control to suppress the transmission power of the entirety of the used communication frequency band is performed as in step S303 shown in FIG. 39 (step S313).

On the other hand, when the scheduling algorism is PF, or maximum CIR, or SPS each having any aspect of localized allocation, resource blocks used by the another base station device are detected (step S314), and the scheduling control unit 324 in the own base station device 1 performs scheduling in the own base station device by an algorism according to the algorism of the another base station device (step S315).

The degree of temporal variation in resource allocation decreases in order of RR, PF, maximum CIR, and SPS. Accordingly, in step S315, if the algorism of the another base station device is SPS, the resource blocks used in the another cell are localized in a predetermined time period. Therefore, in the own base station device, resource blocks other than those used in the another cell are locally allocated based on SPS.

When the algorism adopted in the another cell is PF or maximum CIR, in contrast to the case of RR, specific resource blocks are likely to be locally used for a specific user, because of the communication environment or the like at that time.

Accordingly, in the own base station device, the resource blocks other than those used in the another cell are preferentially used to perform scheduling by PF or maximum CIR, and thus the probability of causing interference in the another cell can be reduced. However, even if the resource blocks other than those used in the another cell are used, the probability of causing interference in the another cell is still higher than in the case of SPS. Therefore, the transmission power is suppressed to be lower than that in the case of SPS.

When PF and maximum CIR are compared, temporal variation in resource allocation is smaller in maximum CIR than in PF. Accordingly, when, in the own base station device, scheduling is performed by maximum CIR using resource blocks other than those used in the another cell, the probability of causing interference in the another cell becomes lower than in the case using PF. When the probability of interference is low, actual occurrence of interference can be suppressed even if the transmission power in the own cell is increased, and therefore, the transmission power in the own cell can be increased.

As described above, the scheduling algorism of the another base station device has an influence on the degree of temporal variation. Therefore, if the type of the algorism is grasped, interference to the another cell can be suppressed by appropriately adjusting the resource blocks to be used, or (the upper limit value of) the transmission power of each resource block.

Also in steps S313 and S315 in FIG. 41, like in steps S303 and S305 in FIG. 39, power reduction control to reduce the transmission power may be performed after a certain period of time from when the scheduling algorism type of the another base station device has been obtained.

### 4.4 Manner of Adjusting Interference Suppression Control

### Third Example

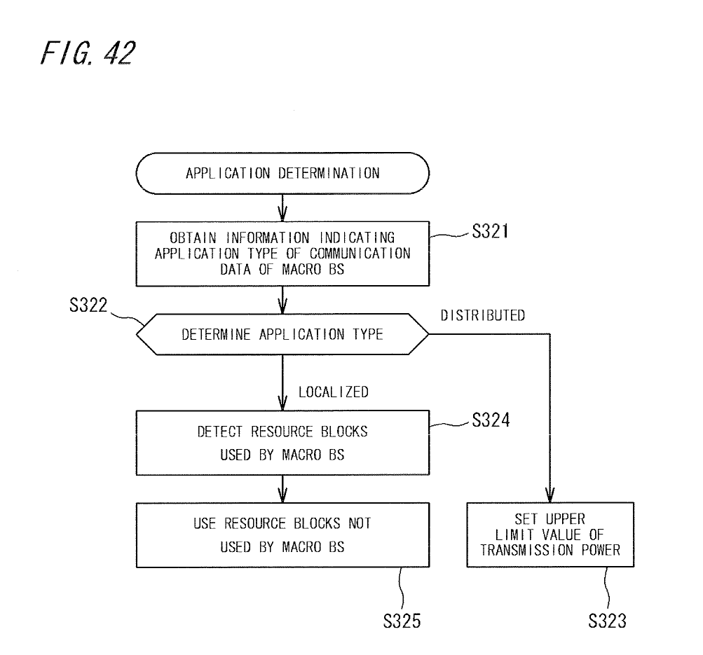

FIG. 42 shows a third example of a method of determining temporal variation in resource allocation in another cell based on information indicating the application type of communication data in the another cell, and adjusting interference suppression control based on a result of the determination.

Firstly, information indicating the application type of data transmitted/received in another base station device (macro BS) is obtained (step S321). This information can be easily obtained from the another base station device or a higher-level device of the another base station device via a backbone network. However, if this information is included in a frame of another cell, the information may be obtained by reading a message in the frame.

Subsequently, in order to determine temporal variation in resource allocation in the another cell, the application type of data to be transmitted in communication (particularly, downlink) in the another cell is determined based on the application type information (step S322). When it is determined that the application type is one that causes distributed allocation, such as WEB, control to suppress the transmission power of the entirety of the used communication frequency band is performed as in step S303 shown in FIG. 39 (step S323).

On the other hand, if the application type is VoIP or streaming, since such application type causes localized allocation, resource blocks that are not used by the another base station device (macro BS) are detected (step S324), and then the scheduling control unit 324 in the own base station device 1 performs scheduling by using the resource blocks that are not used by the another base station device (step S325). Also in steps S323 and S325, like in steps S303 and S305 in FIG. 39, the upper limit value of the transmission power may be adjusted, or power reduction control to reduce the upper limit value of the transmission power with time may be performed.

### 4.5 Manner of Adjusting Interference Suppression Control

### Fourth Example

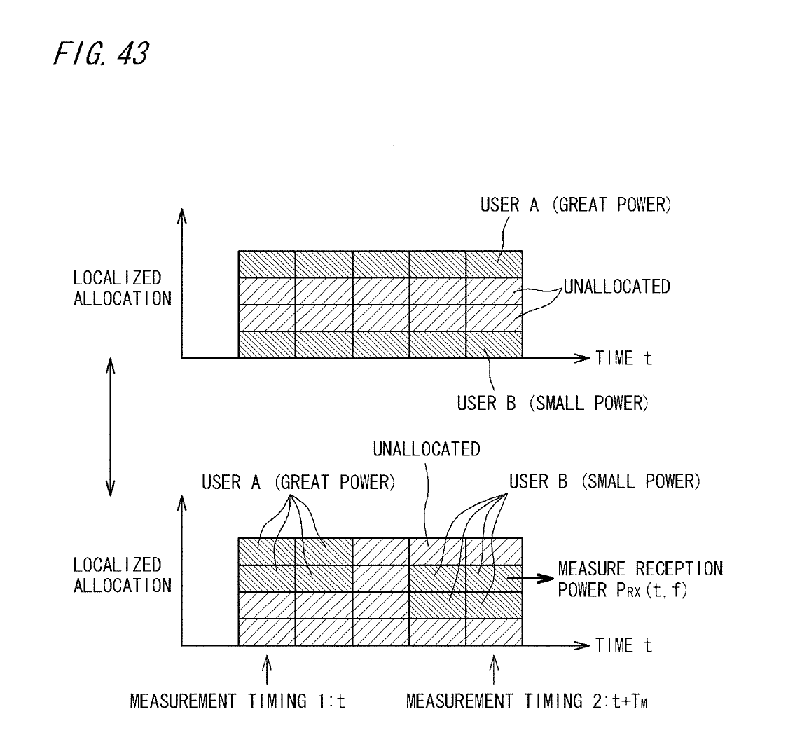

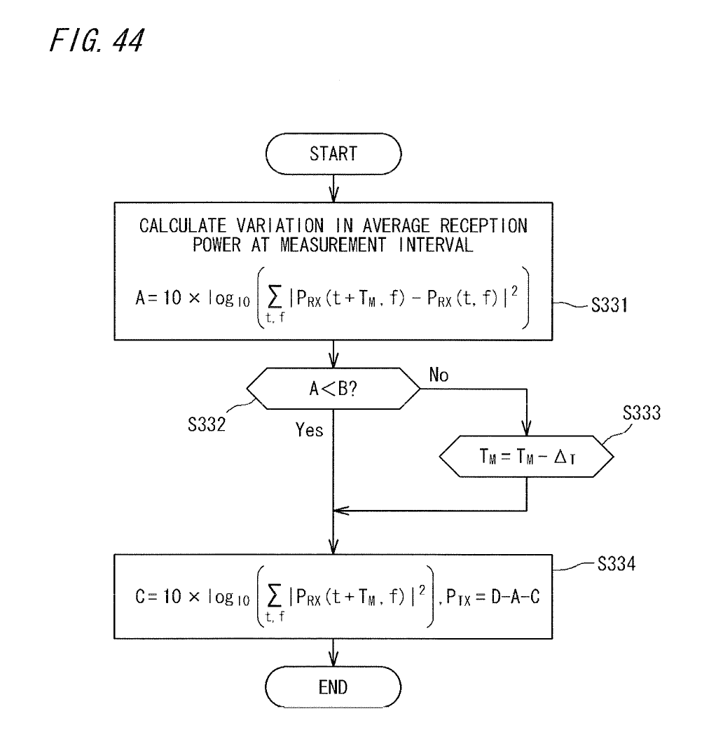

FIGS. 43 and 44 show a fourth example of a method of measuring the power of a communication signal in another cell by the measurement unit 322 to determine temporal variation in resource allocation in the another cell, and then adjusting the manner of interference suppression control based on a result of the determination.

When resource allocation is localized allocation as shown in FIG. 43(a), the frequency range (resource block) allocated to user A and the frequency range (resource block) allocated to user B do not vary with time. On the other hand, when resource allocation is distributed allocation as shown in FIG. 43(b), temporal variation is observed because the resource allocation varies with time.

So, it is possible to determine whether the resource allocation in the another cell is localized allocation, by measuring the signal power (reception power) in the another cell, for each frequency (resource block) by the measurement unit 322. For example, in FIG. 43, power P_{RX}(t,f) of each frequency (resource block) f is measured at measurement timing 1: t, and then power P_{RX}(t,f) of each frequency (resource block) f is measured at measurement timing 2: t+T_{M} which is next measurement timing after the elapse of T_{M}. In this case, if the resource allocation is localized allocation, the measurement results at the both points in time are approximately the same. However, if the resource allocation is distributed allocation, a difference between the measurement results increases.

So, as shown in FIG. 44, the determination unit 327 firstly calculates a variation (power variation information) A in an average reception power of each frequency (resource block) at the measurement interval T_{M}, based on an equation shown in FIG. 44 (step S331). The greater the variation A, the greater the degree of temporal variation in resource allocation in the another cell. The smaller the variation A, the smaller the degree of temporal variation.

Then, the determination unit 327 compares the variation A with a predetermined threshold B (step S332). If the variation A is greater than the threshold B, the determination unit 327 reduces the measurement interval T_{M} by about Δ_{T}. When the resource allocation in the another cell is distributed allocation, such reduction in the measurement interval T_{M} causes the subsequent measurement to occur more frequently, and enables the measurement unit 322 to grasp, more frequently, the magnitude of power in the another cell and the resource allocation status in the another cell.

On the other hand, when the variation A is smaller than the predetermined threshold B, (if the measurement interval T_{M} has been reduced, it is restored), transmission power P_{TX} in the own cell is obtained based on the variable A (step S334). Specifically, the reception power (gain) C from the another base station device (macro BS) is obtained from the result of the measurement, based on an equation shown in FIG. 44. In FIG. 44, D is the default transmission power (the upper limit value of the transmission power in the normal state).

When the reception power C from the another base station device is great, signal attenuation (path loss) from the another base station device is small. Therefore, signal transmission from the own base station device (femto BS) is highly likely to cause interference in the another base station device. Accordingly, when the reception power C is great, the transmission power P_{TX} in the own cell should be reduced to suppress such interference.

Further, when the variation A is great, even if the reception power C is small, the probability that the reception power C significantly varies is high. That is, when the variation A is great, even if the reception power C is small and therefore it is considered that the another base station device does not use many resources, the possibility that the another base station device suddenly becomes to use many resources is high. When the another base station device uses many resources, the probability that the own base station device uses the same resources as those used by the another base station device is increased, resulting in an increase in probability of causing interference to the another cell. Accordingly, when the probability is high, the transmission power P_{TX} in the own cell should be reduced to reduce the probability of occurrence of such interference.

So, in the present embodiment, when the variation A is great and therefore the probability of causing interference to the another cell is high, the transmission power P_{TX} in the own cell is reduced to suppress such interference (step S334). That is, the power control unit 323 determines the transmission power P_{TX} in the own cell as follows:

transmission power P_{TX}=D−A−C

The above-mentioned transmission power control may be performed for each frequency (resource block).

[Chapter 5: Interference Suppression Control in Accordance with the Number of Terminal Devices]

In a base station device described in Chapter 5, the techniques for the base station device described in Chapter 1, 2, 3, or 4 are employed within the consistent scope. In Chapter 5, for those points that are not particularly described, the matters described in Chapters 1, 2, 3, and 4 are incorporated.

The configuration of the communication system and the frame structure for LTE in Chapter 5 are identical to those described in Chapter 1, but a supplemental description for the frame structure will be given hereinafter.

In a PBCH in a DL frame, information relating to allocation of a PRACH is stored in addition to SIB1 and MIB.

The PRACH allocated in the UL frame is an area for transmitting a connection request (a random access preamble) with which a terminal device firstly accesses a base station device in advance of establishing connection with the base station device. The PRACH is set to have a frequency band width corresponding to 6 resource blocks (72 subcarriers), and a width corresponding to 1 subframe in the time axis direction. As described above, the base station device notifies the terminal device of allocation information indicating allocation of the PRACH, by using the PBCH (Physical Broadcast Channel) in the DL frame.

Although the timings of the DL frame and the UL frame are not described in Chapter 5, the timings of the DL frame and the UL frame are synchronized between the base station devices, and communication in each cell is performed in the state where so-called inter-base-station synchronization is achieved.

### 5.1 Configuration of Base Station Device

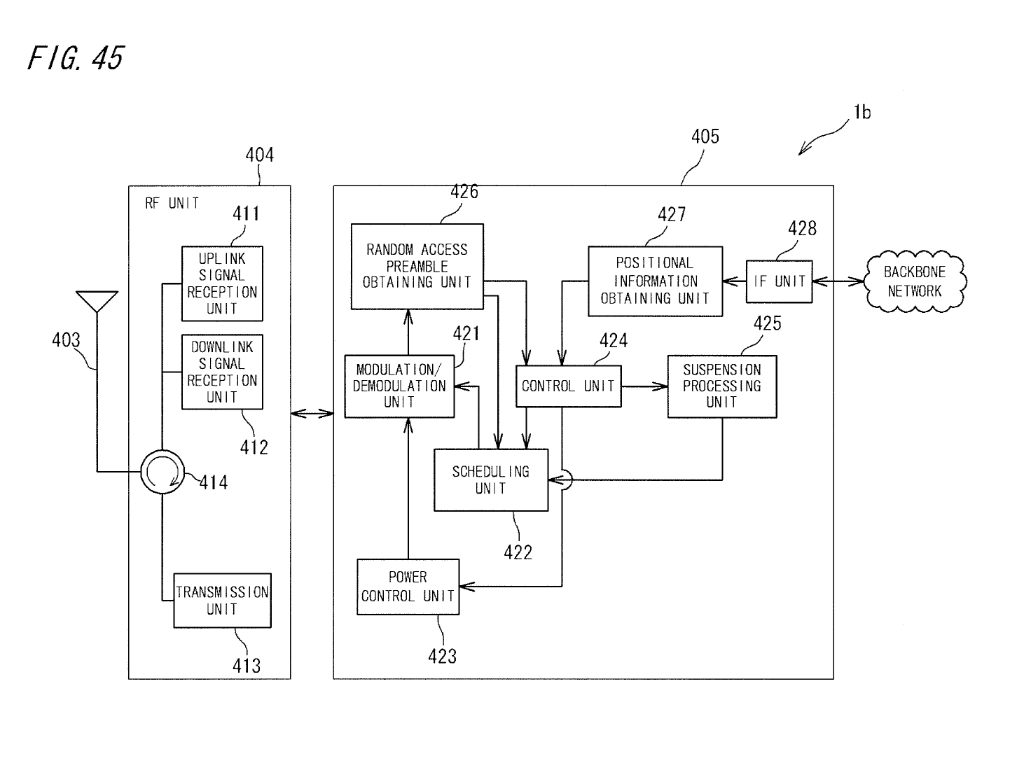

FIG. 45 is a block diagram showing the configuration of a femto BS 1b according to an embodiment in Chapter 5. While the configuration of the femto BS 1b will be described hereinafter, the configuration of a macro BS 1a is substantially the same as the femto BS 1b.

The femto BS 1b includes an antenna 403, a reception unit (RF unit) 404 to which the antenna 403 is connected, and a signal processing unit 405 that performs signal processing for signals transmitted to and received from the RF unit 404, and a process of suppressing interference to another cell (a base station device or a terminal device in another cell).

[5.1.1 RF Unit]

The RF unit 404 includes an uplink signal reception unit 411, a downlink signal reception unit 412, a transmission unit 413, and a circulator 414. These components are identical to those of the RF unit 204 according to the embodiments in Chapters 3 and 4.

A downlink reception signal outputted from the downlink signal reception unit 412 is provided to the signal processing unit 405, and processed by a modulation/demodulation unit 421 and the like described later.

[5.1.2 Signal Processing Unit]

The signal processing unit 405 includes a modulation/demodulation unit 421 that performs signal processing for transmission/reception signals exchanged between an upper layer of the signal processing unit 405 and the RF unit 404. The modulation/demodulation unit 421 demodulates, as uplink reception data, an uplink signal provided from the uplink signal reception unit 411, and outputs the data to the upper layer. Further, the modulation/demodulation unit 421 modulates various kinds of transmission data provided from the upper layer. Furthermore, the modulation/demodulation unit 421 is able to demodulate a downlink signal from another cell, which has been received by the downlink signal reception unit 412, and demodulate an uplink signal from another cell, which has been received by the uplink signal reception unit 12.

The modulation/demodulation unit 421 subjects the transmission data provided from the upper layer to a predetermined modulation scheme, for each predetermined data unit, based on an instruction of a scheduling unit 422, and allocates the modulated data to a DL frame in units of resource blocks, thereby generating a downlink transmission signal of the femto BS 1b (own downlink transmission signal).

The scheduling unit 422 determines radio resource allocation in the DL frame, based on instructions from various sections such as the upper layer.

In the signal processing unit 405, when generating the own downlink transmission signal, a power control unit 423 generates uplink transmission power control information that causes a terminal device connected to the femto BS 1b to adjust the transmission power of its uplink transmission signal, and stores the uplink transmission power control information in a PDCCH of the own downlink transmission signal to be transmitted to the terminal device, thereby adjusting the transmission power of the terminal device.

Further, the signal processing unit 405 has a function of adjusting the transmission power of the downlink transmission signal, based on downlink transmission power control information outputted from the power control unit 423.

The signal processing unit 405 further includes a control unit 424 that performs control to adjust the manner of suppressing interference to a base station device or a terminal device in another cell. The control unit 424 causes the power control unit 423 to adjusts the transmission power of the femto BS 1b (own base station device) and/or the transmission power of a terminal device connected to the own base station device, thereby performing control to adjust the manner of suppressing interference to the base station device (another base station device) in the another cell or to the terminal device (another terminal device) connected to the base station device in the another cell.

That is, when there is a possibility of interference to the another cell, the control unit 424 performs control to suppress (the upper limit value of) the transmission power of the own base station device or the terminal device in the own cell, thereby preventing a signal transmitted from the own base station device or the terminal device in the own cell from becoming an interference signal in the another cell.

Further, the control unit 424 causes the scheduling unit 422 to adjust the amount of radio resource to be allocated to the terminal device connected to the own base station device, thereby performing control to adjust the manner of suppressing interference to the base station device or the terminal device in the another cell.

Furthermore, the signal processing unit 405 includes a suspension processing unit 425 that performs a suspension process of suspending communication between the own base station device and the terminal device connected to the own base station device, and the control unit 424 causes the suspension processing unit 425 to perform the suspension process according to need, thereby performing control to adjust the manner of suppressing interference to the base station device or the terminal device in the another cell.

In advance of performing the suspension process, the suspension processing unit 425 notifies an MS 2b currently connected to the own base station device, that the suspension process is to be performed. Upon receiving this notification, the MS 2b suspends the communication with the own base station device and executes cell search, and then starts a process of accessing a base station device other than the own base station device.

As for interference suppression that the control unit 424 causes the power control unit 423, the scheduling unit 422, and the suspension processing unit 425 to perform, how the control unit 424 performs control to adjust the manner of the interference suppression will be described later in detail.

The control unit 424 performs control to suppress interference, in accordance with presence information relating to the presence statuses of terminal devices other than the terminal device connected to the own base station device, which is outputted from a random access preamble obtaining unit 426 and a positional information obtaining unit 427.

The random access preamble obtaining unit 426 obtains, from the modulation/demodulation unit 421, uplink reception signals received by the uplink signal reception unit 411, and obtains, from the uplink reception signals, connection requests (RAP: random access preambles) transmitted from terminal devices other than the terminal device connected to the own base station device, and then obtains, based on the RAPs, presence information indicating the presence statuses of the terminal devices.

A RAP is, as described above, a signal with which a terminal device accesses a base station device in advance of establishing communication connection with the base station device, and is transmitted on a contention basis. Each terminal device transmits a RAP by using a PRACH allocated to a UL frame as shown in FIG. 4.

The following will describe how a terminal device establishes communication connection with a base station device.

When a terminal device is activated by power-on or the like, the terminal device receives a P-SCH and an S-SCH that are broadcast from a base station device, and performs cell search to recognize a cell (base station device). Next, the terminal device obtains system information such as allocation information relating to allocation of a PRACH of the recognized cell, which information is broadcast by a PBCH, and transmits a RAP to the recognized cell to request access to the cell. Upon receiving the RAP, the base station device estimates, by using the RAP, a difference in transmission timing between the base station device and the terminal device, and transmits, to the terminal device, a response ((RAR: Random Access Response) to the RAP, which includes the received RAP, information relating to the difference in timing, permission of scheduling, and the like.

Upon receiving the RAR, the terminal device transmits identification information of the terminal device by using a channel in a PUSCH for which scheduling is permitted.

Upon receiving the identification information, the base station device identifies the terminal device. Then, the base station device, by using the PDSCH, notifies the terminal device that identification of the terminal device has been completed, and thus transmission/reception of user data is allowed.

In this way, communication connection is established between the terminal device and the base station device.

As described above, the terminal device transmits the RAP in advance of establishing communication connection with the base station device. The random access preamble obtaining unit 426 obtains, within a predeteimined time period, the RAPs transmitted from terminal devices other than the terminal device connected to the base station device, from the uplink reception signals received by the uplink signal reception unit 411, and thereby recognizes the terminal devices other than the terminal device connected to the own base station device, which exist in the range where the RAPs reach the own base station device. Therefore, the random access preamble obtaining unit 426 can obtain the presence information, based on the RAPs transmitted from the terminal devices.

Further, in order to obtain a RAP transmitted from a terminal device that intends to access another BS 1 to the another BS 1, the random access preamble obtaining unit 426 obtains control information relating to an area of a PRACH that the another BS 1 sets in its UL frame, and causes the scheduling unit 422 to set, in an UL frame of the own base station device, a PRACH (second PRACH) for sniffing a RAP from the terminal device that intends to access the another BS 1, in addition to a PRACH (first PRACH) for receiving a RAP from a terminal device that intends to access the own base station device.

The positional information obtaining unit 427 obtains positional information relating to the positions of terminal devices other than a terminal device connected to the own base station device, from another base station device or a device (server) for controlling the another base station device, via a backbone network (wired network) connecting base station devices. The signal processing unit 405 includes an interface 428 for the backbone network, and the interface 428 allows the positional information obtaining unit 427 to obtain the positional information via the backbone network.

The positional information obtaining unit 427 obtains the presence information from the positional information.

The content of the presence information will be described later in detail.

### 5.2 Control to Adjust the Manner of Interference Suppression, Performed by the Control Unit

### First Example

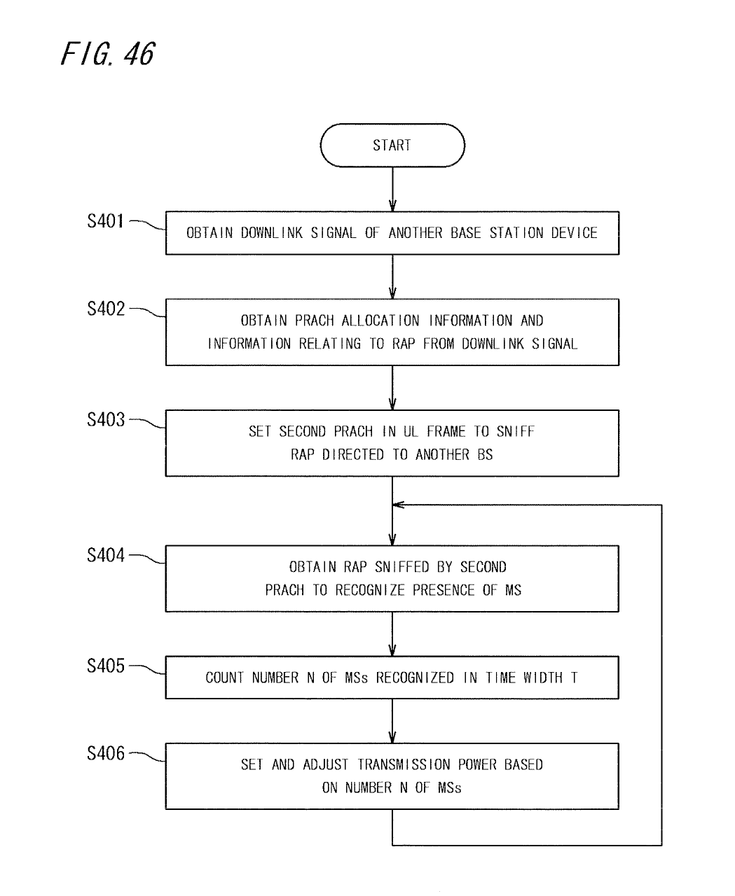

FIG. 46 is a flowchart showing a first example of process steps of interference suppression control performed by a femto BS 1b.

Firstly, the random access preamble obtaining unit 426 of the femto BS 1b obtains, from the modulation/demodulation unit 421, a downlink reception signal from another BS 1, which has been received by the downlink signal reception unit 412 (step S401), and obtains, from the downlink reception signal, control information required for transmitting a RAP to the another BS 1, such as allocation information of a PRACH in the another BS 1, and information relating to the format of RAP, among system information of the another BS 1 (step S402).

Next, based on the PRACH allocation information obtained in step S402, the random access preamble obtaining unit 426 causes the scheduling unit 422 to sets, in the UL frame of the own base station device, a first PRACH for receiving a RAP from an MS 2 that intends to access the own base station device, and a second PRACH for sniffing a RAP from an MS 2 that intends to access another BS 1 (step S403).

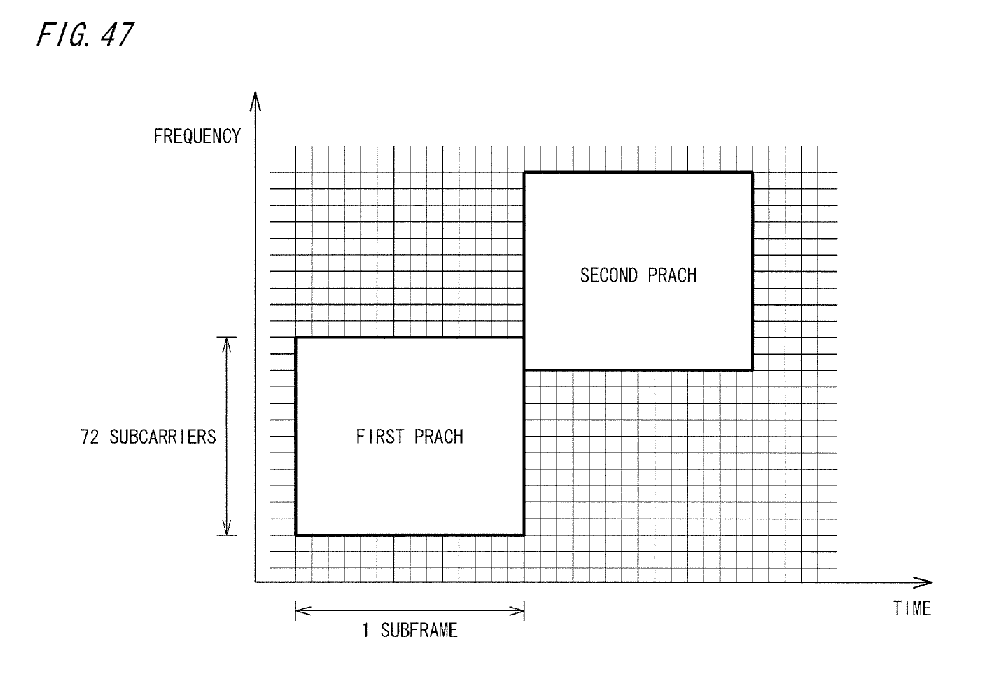

FIG. 47 is a diagram showing an example of a case where the first PRACH and the second PRACH are set on the UL frame. In FIG. 47, each PRACH is set to have a band width corresponding to 72 subcarriers in the frequency axis direction, and a width corresponding to 1 subframe in the time axis direction.

If the second PRACH overlaps the first PRACH, the scheduling unit 422 changes the area of the first PRACH for the MS 2b connected to the own base station device so as to prevent the first PRACH from overlapping the second PRACH.

Setting the first and second PRACHs as described above allows the femto BS 1b to receive the RAP transmitted from the terminal device that intends to access the femto BS 1b (own base station device), and to reliably sniff the RAP transmitted from the MS 2 that intends to access the another BS 1.

Referring back to FIG. 46, after setting of the second PRACH in step S403, when the femto BS 1b sniffs the RAP transmitted by using the second PRACH, the random access preamble obtaining unit 426 of the femto BS 1b obtains, from the uplink reception signal provided from the modulation/demodulation unit 421, the RAP of the MS 2 that intends to access the another BS 1, and recognizes that the MS 2 exists in the range where the RAP reaches the femto BS 1b (own base station device) (step S404). At this time, by using the information relating to the format of the RAP, which has been obtained in step S402, the random access preamble obtaining unit 426 can obtain the RAP transmitted from the MS 2 to the another BS 1.

Next, the random access preamble obtaining unit 426 counts the number N of terminal devices (MSs 2) recognized in a range of time width T from the present time back to the past by time T (step S405), and outputs, to the control unit 424, the number N of terminal devices, as presence information indicating the presence status of MSs 2 located in the neighborhood of the own base station device. That is, the number N of terminal devices is a value obtained by counting the MSs 2 located in the range in which their RAPs reach the own base station device, as those being located in the neighborhood of the own base station device, and the random access preamble obtaining unit 426 can grasp the number N of terminal devices (MSs 2) located near the own base station device so that the own base station device can receive their RAPs.

Based on the number N of terminal devices as the presence information, the control unit 424 sets the transmission power of the downlink signal of the own base station device, and the transmission power of the uplink signal of the MS 2b connected to the own base station device, and causes the power control unit 423 to adjust the transmission power based on the set values (step S406), and then returns to step S404. Thereafter, the control unit 424 repeatedly executes steps S404 to S406.

When setting the transmission powers in step S406, the control unit 424 determines a control value X, based on the number N of terminal devices, as shown in the following equation (401).

control value X=number N of terminal devices/time width T (401)

As shown in equation (401), the control value X is the number of terminal devices per unit time, and the control unit 424 sets the transmission power in accordance with the control value X.

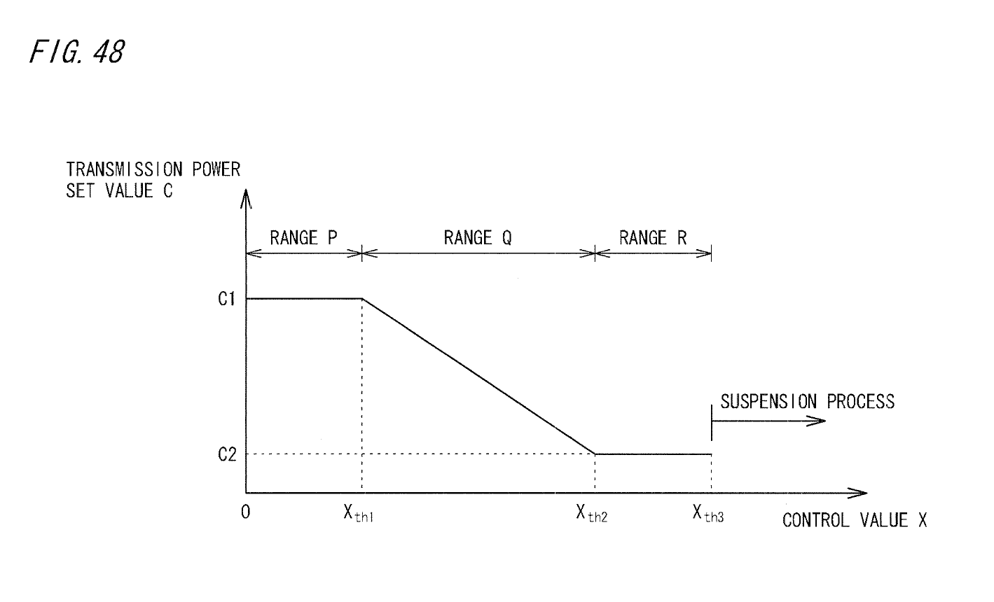

FIG. 48 is a graph showing the relationship between the control value X, and the set value C of the transmission power of the downlink signal of the femto BS 1b, which is set by the control unit 424. In FIG. 48, the horizontal axis indicates the control value X and the vertical axis indicates the set value C of the transmission power of the downlink signal.

The control unit 424 sets the transmission power of the downlink signal in accordance with the graph shown in FIG. 48.

As shown in the following equation (402), the control unit 424 sets the set value C of the transmission power to “C1” when the control value X is in a range (range P) from “0” to a threshold Xₜₕ₁.

transmission power set value C=C1(0≦X<Xₜₕ₁) (402)

Further, as shown in the following equation (403), the control unit 424 sets the set value C so as to linearly decrease with increase in the control value X, when the control value X is in a range (range Q) from the threshold Xₜₕ₁ to a threshold Xₜₕ₂.

transmission power set value C=C1−a(X−Xₜₕ₁)(Xₜₕ₁≦x≦Xₜₕ₂) (403)

As shown in following formula (404), the control unit 424 sets the set value C of the transmission power to “C2” when the control value X is in a range (range R) from the threshold Xₜₕ₂ to a threshold Xₜₕ₃.

transmission power set value C=C2(Xₜₕ₂≦x<Xₜₕ₃) (404)

The value “C1” of the set value C is an allowable maximum transmission power for the femto BS 1b, and the value “C2” is a minimum value required to maintain communication with the MS 2b connected to the femto BS 1b (own base station device).

In the range P corresponding to the case where the number of terminal devices (MSs 2) located in the neighborhood of the own base station device is relatively small, since the possibility of interference from the own base station device to a base station device or a terminal device in another cell is low, the control unit 424 sets the set value C of the transmission power to “C1” that is the maximum transmission power. The threshold Xₜₕ₁ is set to a value at which such interference does not affect communication of the base station device or the terminal device in the another cell even when the set value C of the transmission power is “C1”.

In the range R corresponding to the case where the number of terminal devices (MSs 2) located in the neighborhood of the own base station device is relatively great, since the possibility of interference to a base station device or a terminal device in another cell is high, the control unit 424 sets the set value C of the transmission power to the minimum value “C2”. By reducing the transmission power in this way, the downlink signal of the own base station device is prevented from becoming an interference signal in a neighboring cell. The thresholds Xₜₕ₂ and Xₜₕ₃ are set to a lower limit value and an upper limit value at which interference can be suppressed when the set value C of the transmission power is “C2”.

In the range Q, the control unit 424 linearly decreases the set value C of the transmission power with increase in the control value X. Thus, the set value C of the transmission power can be varied so as to effectively suppress interference in accordance with the control value X.

As shown in FIG. 48, when the control value X exceeds the threshold Xₜₕ₃, the control unit 424 causes the suspension processing unit 425 to perform a suspension process of suspending communication between the own base station device and a terminal device connected thereto. Thereby, when it is difficult to maintain communication of the own base station device while effectively suppressing interference even if the control value X exceeds the threshold Xₜₕ₃ and the set value C of the transmission power is reduced to “C2”, it is possible to suppress interference by suspending communication of the own base station device.

As described above, the control unit 424 adjusts the set value C of the transmission power in accordance with the number N of terminal devices (control value X) indicating the presence status of MSs 2 located in the neighborhood of the own base station device, and suspends communication of the own base station device according to need. Thereby, the control unit 424 can perform control to adjust the manner (effect) of suppressing interference to another base station device and another terminal device.

Therefore, according to the femto BS 1b of the present embodiment, it is possible to suppress interference more effectively in accordance with the presence status of MSs 2 located in the neighborhood of the femto BS 1b (the own base station device).

While setting of the transmission power of the downlink signal of the own base station device has been described with reference to FIG. 48, the control unit 424 sets the transmission power of an uplink signal transmitted from an MS 2b connected to the own base station device, in like manner as described above.

Further, in the present embodiment, MSs 2 that intend to access another BS 1 are recognized by RAPs sniffed by the second PRACH, and the transmission power is controlled. However, MSs 2 that intend to access the own base station device may be simultaneously recognized by RAPs received by the first PRACH, and the transmission power may be controlled after counting the number N of terminal devices including these MSs 2 and the MSs 2 that intend to access the another BS 1.

Alternatively, the transmission power may be controlled based on only the number of terminal devices (MSs 2) that intend to access the own base station device, which have been recognized by the RAPs received by the first PRACH.

The reason is as follows. Since the MSs 2 that intend to access the own base station device have not yet established communication connection with the own base station device, these MSs 2 might suffer interference from the own base station device. By counting the number N of terminal devices including these MSs 2, more accurate control of the transmission power is achieved.

Among the MSs 2 each transmitting a RAP by using the first PRACH, some are registered in a closed subscriber group (CSG) for which access to the own base station device is permitted, while others are not registered in the CSG. Therefore, when the random access preamble obtaining unit 426 recognizes an MS 2 by a RAP received by the first PRACH, the random access preamble obtaining unit 426 identifies whether the MS 2 is registered in the CSG, and counts the MS 2 only when it is not registered. Thereby, the random access preamble obtaining unit 426 can obtain only the presence information of MSs 2 that are not permitted to access the own base station device and therefore may suffer interference from the own base station device.

### 5.3 Control to Adjust the Manner of Interference Suppression Performed by the Control Unit

### Second Example

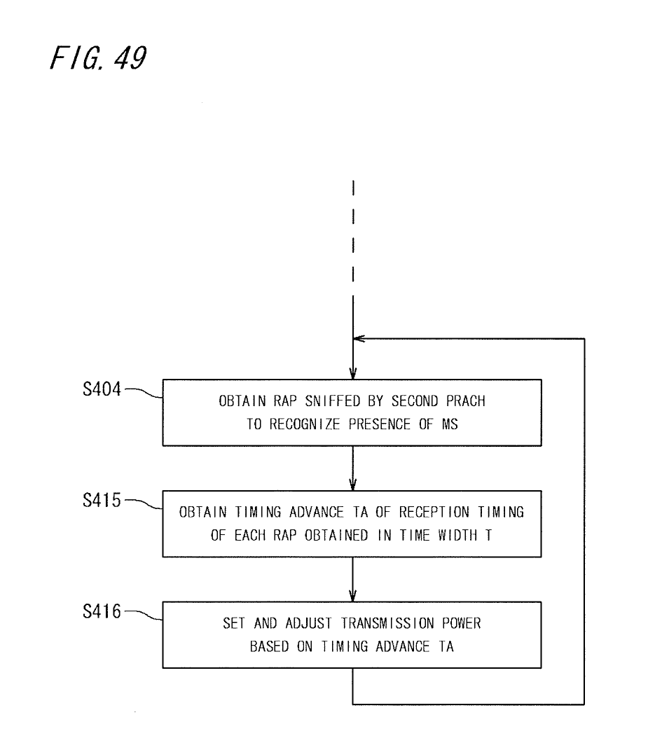

FIG. 49 is a flowchart showing a second example of process steps of interference suppression control performed by the femto BS 1b. The flowchart shown in FIG. 49, except steps S415 and S416, is identical to steps S401 to S404 in the flowchart shown in FIG. 46, and FIG. 49 shows step S404 and subsequent steps S415 and S416.

Referring to FIG. 49, when recognizing the presence of MSs 2 by RAPs sniffed by the second PRACH in step S404, the random access preamble obtaining unit 426 obtains timing offsets (Timing advances) TA of reception timings of the RAPs of the respective recognized MSs 2, in a range of time width T from the present time back to the past by time T (step S415), and outputs, to the control unit 424, the obtained Timing advances TA as presence information indicating the presence status of the MSs 2 located in the neighborhood of the own base station device.

A reception Timing advance TA indicates an offset, in the time axis direction, relative to the PRACH, of a RAP that has been transmitted from a terminal device to a base station device and has reached the base station device.

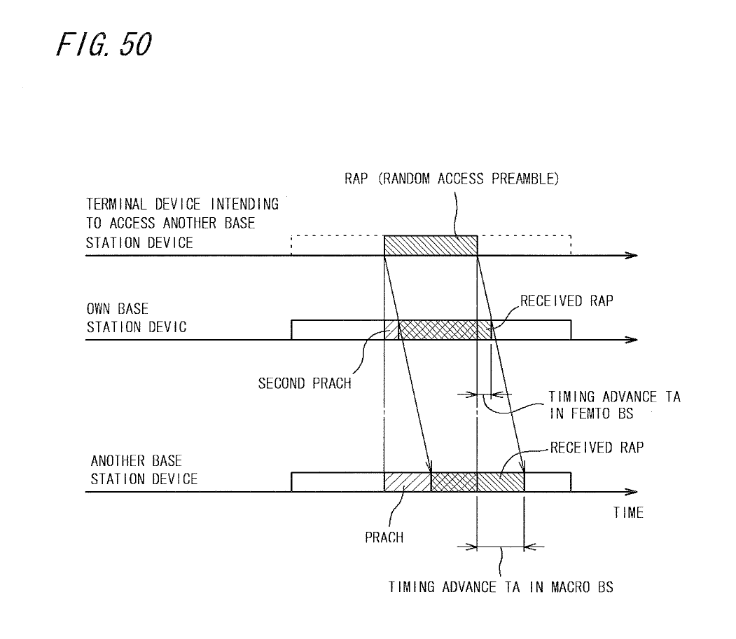

FIG. 50 is a diagram for explaining the reception Timing advance TA. In FIG. 50, the horizontal axis is the time axis, and indicates UL frames of the own base station device, another base station device, and a terminal device that intends to access the another base station device.

In FIG. 50, the terminal device obtains allocation information of a PRACH in an UL frame transmitted from the another base station device, and transmits a RAP based on the allocation information. On the other hand, when the another base station device receives the RAP from the terminal device, there occurs an offset in the time axis direction between the RAP and the PRACH set by the another base station device. This offset in the time axis direction is the reception Timing advance TA, and its value depends on the distance between the another base station device and the terminal device.

That is, although the terminal device transmits the RAP based on the allocation information provided from the another base station device, since a time according to the distance between the another base station device and the terminal device is required before the transmitted RAP reaches the base station device, a delay corresponding to the time according to the distance occurs when the base station device receives the RAP, and the delay appears as a Timing advance TA.

In this way, the reception Timing advance TA is a value relatively representing the distance between a terminal device and a base station device. The larger the value, the longer the distance.

Since the own base station device performs communication with the another base station device in the state where inter-base station synchronization, in which the timings of the DL frame and the UL frame coincide with each other, is achieved, the timing of the PRACH in the another base station device and the timing of the second PRACH in the own base station device approximately coincide with each other.

Accordingly, the reception Timing advance TA obtained when the own base station device sniffs a RAP transmitted from the terminal device to the another base station device can be used as a value relatively representing the distance between a terminal device and a base station device. Therefore, the own base station device can obtain this Timing advance TA as distance information between the own base station device and the terminal device that intends to access the another base station device.

As for an MS 2 that intends to access another BS 1, the random access preamble obtaining unit 426 obtains an offset in the time axis direction between a RAP from the MS 2 and the second PRACH, as a reception Timing advance TA that is distance information, and outputs the Timing advance TA to the control unit 424.

If presence information of an MS 2 that intends to access the own base station device is to be obtained, the random access preamble obtaining unit 426 obtains a reception Timing advance TA of a RAP transmitted from the MS 2, with respect to the first PRACH.

Referring back to FIG. 49, the control unit 424, which has been provided with the reception Timing advances TA of the respective RAPs obtained in the time width T, sets the transmission power of the downlink signal of the own base station device and the transmission power of the uplink signal of the MS 2b connected to the own base station device, in accordance with the reception Timing advances TA, and causes the power control unit 423 to adjust the transmission powers based on the set values (step S416), and then returns to step S404. Thereafter, the control unit 424 repeatedly executes steps S404, S415, and S416.

In advance of setting the transmission powers in step S416, the control unit 424 obtains a control value X based on the reception Timing advances TA, as expressed in the following equation (405).

control value X=α×(1/T)×(Δt₁⁻²+Δt₂⁻²+ . . . +Δt_{N}⁻²) (405)

In equation (405), Δt is the reception Timing advance TA, T is the time width in which the RAPs corresponding to the reception Timing advances TA are obtained, N is the number of terminal devices (MSs 2) recognized by obtaining the RAPs, and a is a predetermined fixed coefficient.

As shown in equation (405), the control value X of this example is obtained by summing up the inverses of the squares of the reception Timing advances TA, and the distances represented by the reception Timing advances TA are weighted so as to be reflected in the control value X.

That is, the smaller the reception Timing advance TA is, the closer the corresponding MS 2 is to the own-base station device. In equation (405), the inverse of the square of the reception Timing advance TA takes a larger value as the Timing advance TA is smaller, and functions in the direction in which the control value X is increased. Therefore, each reception Timing advance TA is weighted according to the relative distance represented by its value, and reflected in the control value X.

The control unit 424, as in the above-described first example, sets the power of the transmission signal in accordance with the graph shown in FIG. 48, based on the control value X obtained by equation (405). In FIG. 48, the respective thresholds and the like are set to values in accordance with the control value X obtained in this example.

In this example, since the random access preamble obtaining unit 426 obtains, as presence information, the reception Timing advance TA as distance information indicating the distance between the own base station device and the MS 2, it is possible to grasp the presence status of MSs 2 located in the neighborhood of the own base station device.

### 5.4 Control for Adjusting the Manner of Interference Suppression Performed by the Control Unit

### Third Example

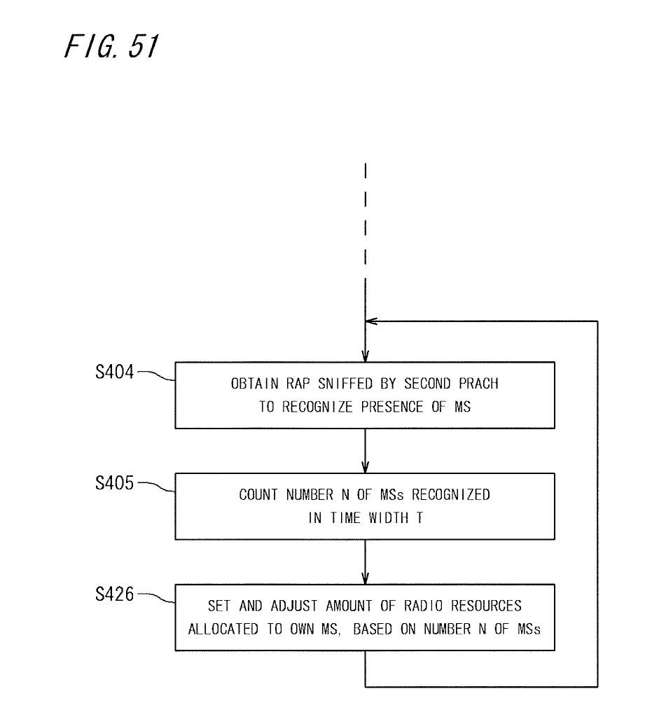

FIG. 51 is a flowchart showing a third example of process steps of interference suppression control performed by the femto BS 1b. The flowchart shown in FIG. 51, except step S426, is identical to steps S401 to S405 in the flowchart shown in FIG. 46, and FIG. 51 shows steps S404 and S405 and subsequent step S426.

In FIG. 51, in step S405, the random access preamble obtaining unit 426 counts the number N of terminal devices (MSs 2) recognized in a range of time width T from the present time back to the past by time T, and outputs, to the control unit 424, the number N of terminal devices as presence information indicating the presence status of MSs 2 located in the neighborhood of the own base station device.

The control unit 424 obtains a control value X based on the number N of terminal devices as shown in equation (401), sets an amount of radio resources to be allocated to the MS 2b connected to the own base station device, in accordance with the control value X (the number N of terminal devices), and causes the scheduling unit 422 to adjust radio resource allocation based on the allocation amount (step S426), and then returns to step S404. Thereafter, the control unit 424 repeats steps S404 to S426.

Specifically, the control unit 424 adjusts the amount per radio frame of radio resources to be allocated to the MS 2b connected to the own base station device. When it is determined from the control value X that interference suppression is not necessary, the amount per radio frame of the radio resources to be allocated to the MS 2b can be increased.

On the other hand, when it is determined from the control value X that interference suppression is necessary, the amount per radio frame of radio resources is decreased. Thereby, it is possible to lower the possibility that the radio resources allocated to the MS 2b overlaps the radio resources allocated to an MS 2 other than the MS 2b, although the throughput in the MS 2b is reduced.

As described above, the control unit 424 of this example adjusts the amount of radio resources to be allocated, in accordance with the control value X (number N terminal devices) indicating the presence status of MSs 2 located in the neighborhood of the own base station device. Thus the control unit 424 performs control to appropriately adjust the manner (effect) of interference suppression, thereby suppressing interference more effectively in accordance with the presence status of MSs 2 located in the neighborhood of the own base station device.

### 5.5 Modifications and the Like

The present invention is not limited to the above-described embodiments. In the above-described embodiments, interference suppression control is performed by using presence information indicating the presence status of MSs 2 located in the neighborhood of the own base station device, which is outputted from the random access preamble obtaining unit 426. However, interference suppression control may be performed by using presence information outputted from the positional information obtaining unit 427.

The positional information obtaining unit 427 obtains, from another BS 1 or the like, via a backbone network, positional information relating to MSs 2 other than an MS 2 connected to the own base station device, and obtains presence information based on the positional information. Based on the positional information, the positional information obtaining unit 427 may recognize the MSs 2 other than the MS 2 connected to the own base station device, which are located within a distance determined on the basis of the own base station device, and may count the number of recognized MSs 2, and output the result to the control unit 424 as presence information.

Alternatively, the positional information obtaining unit 427 may obtain distance information indicating the distances from the respective recognized MSs 2 to the own base station device, and output the distance information as presence information to the control unit 424.

In step S426 in the third example of the above-described embodiment, the control unit 424 adjusts the manner of interference suppression by adjusting the amount per radio frame of radio resources to the allocated to the MS 2b connected to the own base station device. However, the control unit 424 may be configured to perform control to appropriately adjust the manner (effect) of interference suppression by performing selective transmission/reception of data to be exchanged with the MS 2b in accordance with the application type of the data.

In this case, if it is determined from the control value X that interference suppression is necessary, for example, only high-priority data is selectively transmitted/received in accordance with the type of application to which the data belongs, thereby reducing the amount of data to be transmitted/received, and reducing the amount of radio resources to be allocated to the MS 2b. In this way, it is possible to appropriately adjust the manner of interference suppression in accordance with the situation.

Note that the embodiments disclosed are to be considered in all respects as illustrative and not restrictive. The scope of the invention is indicated by the appended claims rather than by the foregoing meaning, and all changes which come within the meaning and range of equivalency of the claims are therefore intended to be embraced therein.

1-43. (canceled)

44. A base station device comprising:
a control unit that performs control to suppress interference to another base station device and/or a terminal device communicating with the another base station device; and
an analysis unit that obtains usage status data indicating a usage status of each radio resource in the another base station device, and tallies up the usage status data for each predetermined time period to obtain a statistical value in each predetermined time period, wherein
the control unit adjusts a manner of interference suppression control, based on a statistical value in a time period corresponding to a point in time to perform interference suppression control, among the statistical values.

45. The base station device according to claim 44, wherein the adjustment of the manner of interference suppression control includes adjustment of the transmission power in each radio resource and/or adjustment of a manner of radio resource allocation.

46. The base station device according to claim 44, wherein the usage status data is a reception power when the base station device receives a signal of each radio resource or data based on the reception power.

47. The base station device according to claim 44, further including an input unit that receives, from the outside of the base station device, an input of a specific time period in which the manner of interference suppression control is to be adjusted, wherein
when the point in time to perform interference suppression control is within the specific time period, the control unit performs interference suppression control that is set for the specific time period.

48. The base station device according to claim 47, wherein
the analysis unit is configured to obtain and tally up usage status data indicating a usage status of each radio resource in another cell in the specific time period, and obtain a statistical value in the specific time period, and
when the point in time to perform interference suppression control is within the specific time period, the control unit adjusts the manner of interference suppression control, based on the statistical value in the specific time period.

49-65. (canceled)

66. A base station device wirelessly connecting and communicating with a terminal device, comprising:
an obtainment unit that obtains presence information indicating presence statuses of terminal devices located in the neighborhood of the base station device; and
a control unit that performs control to suppress interference to another base station device and/or another terminal device connected to the another base station device, wherein
the control unit performs control to adjust a manner of interference suppression, in accordance with the presence information obtained by the obtainment unit.

67. The base station device according to claim 66, wherein the obtainment unit obtains connection requests transmitted from the terminal devices, and obtains the presence information based on the connection requests.

68. The base station device according to claim 67, wherein the connection requests are transmitted by terminal devices other than the terminal device connected to the base station device.

69. The base station device according to claim 68, wherein the obtainment unit obtains, from a transmission signal transmitted by the another base station device, control information required for transmission of connection requests to the another base station device, and performs, based on the control information, reception control for obtaining connection requests that are transmitted to the another base station device from the terminal devices other than the terminal device connected to the base station device.

70. The base station device according to claim 69, wherein the control information is a radio area allocated in a radio frame by the another base station device to receive the connection requests.

71-72. (canceled)

73. The base station device according to claim 68, wherein
the obtainment unit performs reception control for obtaining connection requests transmitted from terminal devices that intend to access the base station device, based on control information required for the transmission of the connection requests to the base station device from the terminal devices that intend to access the base station device,
identifies whether the obtained connection requests have been transmitted by terminal devices that are permitted to access the base station device, and
obtains the presence information, based on only the connection requests transmitted by terminal devices that are not permitted to access the base station device.

74. The base station device according to claim 67, wherein the obtainment unit obtains, based on the connection requests, as the presence information, the number of terminal devices that are transmission sources of the connection requests obtained within a predetermined time period.

75. The base station device according to claim 67, wherein the obtainment unit determines, based on the obtained connection requests, distance information indicating distances between the base station device and the terminal devices that have transmitted the obtained connection requests, and obtains the distance information as the presence information.

76. The base station device according to claim 75, wherein the distance information is offsets (Timing advances) of reception timings of the connection requests obtained by the obtainment unit.

77. The base station device according to claim 66, wherein the obtainment unit obtains positional information relating to terminal devices other than the terminal device connected to the base station device, via a backbone network to which the another base station device and the base station device are connected, and obtains the presence information based on the positional information.

78. The base station device according to claim 66, wherein the control unit adjusts, based on the presence information, the magnitude of the transmission power of the base station device and/or the magnitude of the transmission power of the terminal device connected to the base station device, thereby adjusting the manner of interference suppression.

79. The base station device according to claim 66, wherein the control unit adjusts, based on the presence information, the amount of radio resources to be allocated to the terminal device connected to the base station device, thereby adjusting the manner of suppressing interference.

80. The base station device according to claim 79, wherein the control unit adjusts the amount per radio frame of radio resources to be allocated to the terminal device connected to the base station device.

81. The base station device according to claim 66, wherein the control unit selectively transmits and receives data between the base station device and the terminal device connected to the base station device, in accordance with the application type of the data, thereby adjusting the manner of suppressing interference.

82. The base station device according to claim 66, further including a suspension processing unit that performs a suspension process of suspending communication of the base station device, wherein
the control unit causes the suspension processing unit to perform the suspension process based on the presence information.
